(19) United States
(12) Patent Application Publication
(10) Pub. No.: US 2024/0277004 A1
(43) Pub. Date: Aug. 22, 2024

(54) STRUCTURED FOOD PRODUCTS AND METHODS OF PRODUCTION THEREOF

(71) Applicant: Air Protein, Inc., Pleasanton, CA (US)

(72) Inventors: Amelia CHEN, Pleasanton, CA (US); Louisa Cook BACHMAN, Pleasanton, CA (US); Adeseye Opeyemi LASEKAN, Pleasanton, CA (US); Allan TORNEY, Pleasanton, CA (US); Vici THAHIR, Pleasanton, CA (US); Benjamin WEISBERGER, Pleasanton, CA (US); Antony WICKE, Pleasanton, CA (US); Travis E. ZISSU, Pleasanton, CA (US)

(21) Appl. No.: 18/520,471

(22) Filed: Nov. 27, 2023

Related U.S. Application Data
(60) Provisional application No. 63/428,190, filed on Nov. 28, 2022.
(60) Provisional application No. 63/428,200, filed on Nov. 28, 2022.
(60) Provisional application No. 63/428,217, filed on Nov. 28, 2022.
(60) Provisional application No. 63/428,225, filed on Nov. 28, 2022.

(51) Int. Cl. A23J 3/20; A23J 3/14; A23J 3/22; A23P 20/20

(52) U.S. Cl. CPC A23J 3/20; A23J 3/14; A23J 3/227; A23P 20/20

(57) ABSTRACT

Structured food products, and methods of producing the structured food products, are provided. The structured food products include protein-containing compositions in layered sheets, in shredded form, in ground form, in a form of an extrudate, or combination of any two or more thereof. Structured food products, such as meat analogues that include these protein-containing compositions are also provided.

### CROSS-REFERENCE TO RELATED APPLICATIONS

This application claims the benefit of U.S. Provisional Application No. 63/428,190, filed on Nov. 28, 2022; U.S. Provisional Application No. 63/428,200, filed on Nov. 28, 2022; U.S. Provisional Application No. 63/428,217, filed on Nov. 28, 2022; U.S. Provisional Application No. 63/428,225, filed on Nov. 28, 2022, each of which is incorporated herein by reference in its entirety.

### FIELD OF THE INVENTION

The present invention relates to methods for production of structured food compositions that are suitable for human or animal consumption, such as compositions which closely mimic the properties of meat and function as meat analogue products.

### BACKGROUND

Eating meat derived from animal sources is a part of everyday life for many people. Adverse impacts of a meat-based diet on human health and on the environment have been well documented. There is a growing consumer demand for alternative protein-rich foods that are not derived from animals but that provide similar textural and flavor characteristics of animal meat, and similar functional properties of animal meat, without unhealthy components associated with meat, such as saturated fatty acids and cholesterol, and without the harmful environmental effects of animal agriculture.

The plant-based food industry is actively searching for the most feasible, scalable, and economical method of creating whole cut meat, from beef to seafood and poultry. Some of the key challenges in the development of whole cut analogue products is the replication of the shape and visual fibrousness of the real animal product.

Desired texture, resembling animal tissue and fibrosity, cohesiveness, fat structure, etc. is achieved through a combination of different pressure and temperature parameters, ingredient chemistry enhancement, mechanical energy application, and other parameters. Scalability is a point of focus when it comes to commercializing meat alternatives, since the product performance in bench and in pilot scale are significantly different. Hence, proper technology screening and validation are crucial ahead of or parallel to development of meat alternatives.

New approaches are needed to decrease the number of processing steps for production of meat alternatives, in order to achieve desired appearance and texture. Chemistry of attributes transition (from raw to cooked) may be important to understand, in order to replicate components of animal tissue in a natural and non-animal derived product.

### BRIEF SUMMARY OF THE INVENTION

Methods are provided herein for production of structured food products, such as, but not limited to, meat analogues.

In one aspect, there is provided a structured food product, comprising: two or more layers of rolled dough composition comprising protein composition; and an adhesive composition comprising protein, gluten, or combination thereof, wherein the adhesive composition is between the two or more layers of the rolled dough composition and adheres the layers together to form the structured food product, and wherein the protein in the protein composition and/or the adhesive composition is from microorganism, plant, alga, fungus, insect, or combination of any two or more thereof.

In some embodiments of the above noted aspect, the protein composition comprises protein from oxyhydrogen microorganism. In some embodiments of the above noted aspect and embodiments, the protein composition comprises microbial biomass comprising oxyhydrogen microorganism cell mass and protein from oxyhydrogen microorganism. In some embodiments of the above noted aspect and embodiments, the protein composition comprises between about 0.1-25% by weight oxyhydrogen microorganism cell mass. In some embodiments of the above noted aspect and embodiments, the protein composition comprises between about 0.5-25% by weight oxyhydrogen microorganism cell mass. In some embodiments of the above noted aspect and embodiments, the protein composition comprises microbial biomass comprising between about 0.5-25% by weight oxyhydrogen microorganism cell mass and between about 60%-99.5% by weight protein from the oxyhydrogen microorganism. In some embodiments of the above noted aspect and embodiments, the protein composition comprises microbial biomass comprising oxyhydrogen microorganism cell mass and protein from oxyhydrogen microorganism; and pea protein. In some embodiments of the above noted aspect and embodiments, the protein composition comprises between about 1-10% by weight of the microbial biomass and between about 20-60% by weight pea protein. In some embodiments of the above noted aspect and embodiments, the protein composition comprises between about 1-10% by weight of the microbial biomass comprising between about 0.5-25% by weight oxyhydrogen microorganism cell mass and between about 60%-99.5% by weight protein from oxyhydrogen microorganism; and between about 20-60% by weight pea protein. In some embodiments of the above noted aspect and embodiments, the protein from the microorganism comprises single cell protein, cell lysate, protein isolate, protein concentrate, protein hydrolysate, free amino acids, peptides, oligopeptides, or combination of any two or more thereof. In some embodiments of the above noted aspect and embodiments, the adhesive composition comprises protein from a microorganism, gluten, or combination thereof. In some embodiments of the above noted aspect and embodiments, the adhesive composition comprises protein from oxyhydrogen microorganism. In some embodiments of the above noted aspect and embodiments, the adhesive composition comprises microbial biomass comprising oxyhydrogen microorganism cell mass and protein from oxyhydrogen microorganism. In some embodiments of the above noted aspect and embodiments, the microorganism comprises Cupriavidus, Rhodococcus, Hydrogenovibrio, Rhodopseudomonas, Hydrogenobacter, Gordonia, Arthrobacter, Streptomycetes, Rhodobacter, Xanthobacter microorganism, or a consortium of two or more thereof. In some embodiments of the above noted aspect and embodiments, the microorganism is Cupriavidus sp. In some embodiments of the above noted aspect and embodiments, the microorganism is Xanthobacter sp. In some embodiments of the above noted aspect and embodiments, the structured food product is a meat analogue. In some embodiments of the above noted aspect and embodiments, the structured food product is a chicken breast analogue. In some embodiments of the above noted aspect and embodiments, each of the layers is between about 0.1 mm to about 5 mm in thickness. In some embodiments of the above noted aspect and embodiments, the structured food product comprises between about 5 to about 50 layers of rolled dough composition.

In one aspect, there is provided a method to form structured food product, comprising: deriving a protein composition from microorganism, plant, algae, fungus, insect, or combination of any two or more thereof; forming a dough composition from the protein composition; producing two or more sheets by rolling the dough composition; layering the two or more sheets on top of each other; laminating the two or more sheets using an adhesive composition comprising protein from microorganism, plant, algae, fungus, insect, or combination of any two or more thereof, and forming the structured food product.

In some embodiments of the above noted aspect, the protein composition comprises protein from oxyhydrogen microorganism. In some embodiments of the above noted aspect and embodiments, the protein composition comprises microbial biomass comprising oxyhydrogen microorganism cell mass and protein from oxyhydrogen microorganism. In some embodiments of the above noted aspect and embodiments, the protein composition comprises microbial biomass comprising between about 0.1-25% by weight oxyhydrogen microorganism cell mass and between about 60%-99.5% by weight protein from the oxyhydrogen microorganism. In some embodiments of the above noted aspect and embodiments, the protein composition comprises microbial biomass comprising between about 0.5-25% by weight oxyhydrogen microorganism cell mass and between about 60%-99.5% by weight protein from the oxyhydrogen microorganism. In some embodiments of the above noted aspect and embodiments, the protein composition comprises microbial biomass comprising oxyhydrogen microorganism cell mass and protein from oxyhydrogen microorganism; and pea protein. In some embodiments of the above noted aspect and embodiments, the protein composition comprises between about 1-10% by weight of the microbial biomass and between about 20-60% by weight pea protein. In some embodiments of the above noted aspect and embodiments, the protein from the microorganism comprises single cell protein, cell lysate, protein isolate, protein concentrate, protein hydrolysate, free amino acids, peptides, oligopeptides, or combination of any two or more thereof. In some embodiments of the above noted aspect and embodiments, the adhesive composition comprises protein from a microorganism, gluten, pea protein, or combination of any two or more thereof. In some embodiments of the above noted aspect and embodiments, the adhesive composition comprises protein from oxyhydrogen microorganism. In some embodiments of the above noted aspect and embodiments, the adhesive composition comprises between about 1-10% by weight of the microbial biomass comprising oxyhydrogen microorganism cell mass and protein from oxyhydrogen microorganism; and between about 20-60% by weight pea protein. In some embodiments of the above noted aspect and embodiments, the microorganism comprises Cupriavidus, Rhodococcus, Hydrogenovibrio, Rhodopseudomonas, Hydrogenobacter, Gordonia, Arthrobacter, Streptomycetes, Rhodobacter, Xanthobacter microorganism, or a consortium of two or more thereof. In some embodiments of the above noted aspect and embodiments, the microorganism is Cupriavidus sp. In some embodiments of the above noted aspect and embodiments, the microorganism is Xanthobacter sp. In some embodiments of the above noted aspect and embodiments, the structured food product is a meat analogue. In some embodiments of the above noted aspect and embodiments, the structured food product is a chicken breast analogue. In some embodiments of the above noted aspect and embodiments, the method comprises producing between about 5 to about 50 layers of sheets by rolling the dough composition. In some embodiments of the above noted aspect and embodiments, the method comprises producing sheets of thickness of between about 0.1 mm to about 5 mm.

In one aspect, a method for producing a structured food product is provided, which includes: (a) producing a composition that includes: (i) protein from one or more microorganism (e.g., bacterium, fungus), plant, and/or algal source; (ii) one or more lipid; and optionally, (iii) one or more flavoring and/or coloring agent; (b) producing sheets from the composition; (c) heating the sheets produced in step (b), for example, at a temperature of about 80° C. to about 115° C. for about 1 minute to about 90 minutes; and (d) layering the sheets, wherein one or more adhesive agent is added therebetween, thereby forming a structured food product.

In some embodiments, the method further includes: (e) applying thermal or radiation energy to the structured food product, thereby laminating the layered sheets. For example, thermal energy may be applied at about 90° C. to about 110° C. for about 45 minutes to about 90 minutes. In some embodiments, the structured food product is sealed in packaging prior to applying thermal or radiation energy.

In some embodiments, the structured food product is a meat analogue product, such as, but not limited to, a beef, poultry, pork, fish, or seafood analogue product.

In some embodiments, the structured food product is a flour, a gelling agent, a bakery product, or a dairy product.

In some embodiments, the composition produced in step (a) includes: (i) about 20% (w/w) to about 50% (w/w) protein from one or more microorganism and about 10% (w/w) to about 50% (w/w) protein from one or more plant source; (ii) about 2% (w/w) to about 10% (w/w) oil or fat; and (iii) about 1% (w/w) to about 15% (w/w) flavoring and/or coloring agent.

In some embodiments, the sheets produced in step (b) are about 0.1 mm to about 1 mm in thickness.

In some embodiments, the composition in step (a) further includes carbohydrates, and/or fiber. For example, the composition may include one or more gum that is derived from a plant, a microorganism, and/or an algae.

In some embodiments, the composition in step (a) includes protein from one or more microorganism, which may include one or more of single cell protein, cell lysate, protein isolate, protein concentrate, protein hydrolysate, free amino acids, peptides, oligopeptides, or combinations thereof. In some embodiments, the one or more microorganism may include, but is not limited to, a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a combination or consortium of two or more thereof. In some embodiments, the protein from one or more microorganism is subjected to a process to lighten the color of the protein prior to or in conjunction with step (a).

In some embodiments, the composition in step (a) includes protein from one or more plant source, which may include, but is not limited to, one or more of rice protein, pea protein, mung bean protein, fava protein, potato protein, wheat protein, chickpea protein, soy protein, jackfruit, oats, quinoa, sorghum, foxtail millets, tofu, edamame, red lentils, green lentils, spirulina, chia seeds, nuts, and hemp seeds.

In some embodiments, step (a) includes: mixing and hydrating (i), thereby producing hydrated protein; adding (ii) to the hydrated protein, and mixing to produce an emulsion; and optionally, adding and mixing (iii) with the emulsion, thereby producing the composition.

In some embodiments, after step (a) and prior to step (b), the composition is rested for at least about 30 minutes.

In some embodiments, the one or more lipid in step (a) is derived from a plant, a microorganism, and/or an algae. In some embodiments, the one or more lipid includes a lipid that is derived from one or more microorganism, such as, but not limited to, a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism. In some embodiments, the one or more lipid incudes a lipid that is derived from a plant, such as, but not limited to, sunflower oil, canola oil, coconut oil, palm oil, cocoa butter, and/or vegetable oil.

In some embodiments, the composition in step (a) includes components such that the structured food product is carbon neutral or carbon negative.

In some embodiments, the structured food product further includes one or more animal-derived component. For example, the one or more animal-derived component may include, but is not limited to, collagen, a lipid, and/or a flavoring agent or composition.

In some embodiments, the structured food product further includes meat or cultured meat.

In some embodiments, the structured food product is further minced, diced, sliced, or ground, and then is incorporated into another food product.

In another aspect, a structured food product is provided, which is produced by any of the methods described herein. For example, the structured food product may be carbon neutral or carbon negative. In some embodiments, the structured food product is a vegan product. In some embodiments, the structured food product includes one or more animal-derived component and/or comprises cultured animal cells.

In another aspect, a method for producing a structured food composition is provided, which includes: (a) culturing one or more microorganism in the presence of a carbon source, thereby producing microbial biomass that includes protein; (b) converting the microbial biomass into a microorganism protein product; and (c) processing the microorganism protein product into a structured food composition, wherein processing the microorganism protein product into the structured food composition includes any of the methods described herein. In some embodiments, step (a) includes chemoautotrophic culture conditions. For example, the carbon source may include a gaseous C1 molecule, such as, but not limited to, CO₂, CO, and/or CH₄.

In some embodiments, the one or more microorganism may include, but is not limited to, a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof. For example, in some embodiments, the one or more microorganism may comprise or consist of a Cupriavidus microorganism, such as a Cupriavidus necator and/or Cupriavidus metallidurans microorganism. In certain embodiments, the one or more microorganism may comprise or consist of Cupriavidus necator DSM 531 and/or DSM 541.

In some embodiments, the microorganism protein product includes one or more of single cell protein, cell lysate, protein isolate, protein concentrate, protein hydrolysate, free amino acids, peptides, oligopeptides, or combinations thereof.

### BRIEF DESCRIPTION OF THE DRAWINGS

FIG. 1 illustrates a schematic diagram of an example of a process for production of a structured food product using laminated sheets as described herein.

FIG. 2 illustrates a schematic diagram of an example of a process for production of a structured food product using laminated sheets as described herein.

FIG. 3 illustrates a schematic diagram of an example of a process for production of a structured food product using laminated sheets as described herein.

FIG. 4 illustrates a schematic diagram of an example of a cold extrusion process for production of a structured food product as described herein.

FIG. 5 illustrates a schematic diagram of an example of a high moisture extrusion process for production of a structured food product as described herein, including preconditioning prior to extrusion.

### DETAILED DESCRIPTION

Provided herein are methods for production of structured food products, such as meat analogue products. Structured food products produced by the methods described herein are also provided.

### Definitions

Unless defined otherwise herein, all technical and scientific terms used herein have the same meaning as commonly understood by one of ordinary skill in the art to which this invention belongs. Singleton, et al., Dictionary of Microbiology and Molecular Biology, second ed., John Wiley and Sons, New York (1994), and Hale & Markham, The Harper Collins Dictionary of Biology, Harper Perennial, NY (1991) provide one of skill with a general dictionary of many of the terms used in this invention. Any methods and materials similar or equivalent to those described herein can be used in the practice or testing of the methods, systems, and compositions described herein.

The practice of the present invention will employ, unless otherwise indicated, conventional techniques of molecular biology (including recombinant techniques), microbiology, cell biology, and biochemistry, which are within the skill of the art. Such techniques are explained fully in the literature, for example, Molecular Cloning: A Laboratory Manual, second edition (Sambrook et al., 1989); Oligonucleotide Synthesis (M. J. Gait, ed., 1984; Current Protocols in Molecular Biology (F. M. Ausubel et al., eds., 1994); PCR: The Polymerase Chain Reaction (Mullis et al., eds., 1994); and Gene Transfer and Expression: A Laboratory Manual (Kriegler, 1990).

Numeric ranges provided herein are inclusive of the numbers defining the range.

Unless otherwise indicated, nucleic acids are written left to right in 5′ to 3′ orientation; amino acid sequences are written left to right in amino to carboxy orientation, respectively.

“A,” “an” and “the” include plural references unless the context clearly dictates, thus the indefinite articles “a”, “an,”, and “the” as used herein in the specification and in the claims, unless clearly indicated to the contrary, should be understood to mean “at least one.”

The term “about” as used herein when referring to a measurable value such as an amount, a temporal duration, and the like, is meant to encompass variations of ±5%, ±1%, or ±0.1% from the specified value, as such variations are appropriate to perform the disclosed methods or in connection with a disclosed composition.

“Acetogen” refers to a microorganism that generates acetate and/or other short chain organic acids up to C4 chain length as a product of anaerobic respiration.

“Acidophile” refers to a type of extremophile that thrives under highly acidic conditions (usually at pH 2.0 or below).

The term “amino acid” refers to a molecule containing both an amine group and a carboxyl group that are bound to a carbon, which is designated the alpha-carbon. Suitable amino acids include, without limitation, both the ^{D}- and ^{L}-isomers of the naturally occurring amino acids, as well as non-naturally occurring amino acids prepared by organic synthesis or other metabolic routes. In some embodiments, a single “amino acid” might have multiple sidechain moieties, as available per an extended aliphatic or aromatic backbone scaffold. Unless the context specifically indicates otherwise, the term amino acid, as used herein, is intended to include amino acid analogs.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

“Biogenic CO₂” refers to carbon in organic matter, such as wood, paper, grass trimmings, or other biofuels, which was originally removed from the atmosphere by photosynthesis and which, under natural conditions, would eventually cycle back to the biosphere as CO₂ due to degradation processes.

The term “biomass” refers to a material produced by growth and/or propagation of cells, e.g., microorganism cells. Biomass may contain cells and/or intracellular contents as well as extracellular material, including, but not limited to, compounds secreted by a cell.

The term “bioreactor” or “fermenter” refers to a closed or partially closed vessel in which cells, e.g., microorganism cells, are grown and maintained. The cells may be, but are not necessarily, held in liquid suspension. In some embodiments, rather than being held in liquid suspension, cells may alternatively be grown and/or maintained in contact with, on, or within another non-liquid substrate including but not limited to a solid growth support material.

“Biosphere” refers to regions of the surface, atmosphere, and hydrosphere of the earth (or analogous parts of other planets) that are occupied by living organisms.

The term “carbon fixing” process, reaction or pathway refers to enzymatic reactions or metabolic pathways that convert forms of carbon that are gaseous under ambient conditions, including but not limited to CO₂, CO, and CH₄, into carbon-based biochemicals that are liquid or solid under ambient conditions, or which are dissolved into, or held in suspension in, aqueous solution.

“Carbon negative” refers a process that uses biogenic or non-biogenic carbon from CO₂ that has been removed from the atmosphere via air-capture of CO₂ or via photosynthesis, where the carbon is embodied in a solid, liquid, or dissolved product generated by the process.

“Carbon neutral” refers to a process that uses carbon from CO₂ that has been removed from the atmosphere via air-capture of CO₂ or via photosynthesis, where at the end of life, the carbon returns to the atmosphere via decomposition of the product. For example, with regard to carbon neutral structured food products described herein, carbon emissions are equal to carbon reduction, so that overall, net-zero carbon enters the atmosphere.

“Carbon source” refers to the types of molecules from which a microorganism derives the carbon needed for organic biosynthesis.

“Carboxydotrophic” refers to microorganisms that can tolerate or oxidize carbon monoxide. In preferred embodiments a carboxydotrophic microorganism can utilize CO as a carbon source and/or as a source of reducing electrons for biosynthesis and/or respiration.

“Chemoautotrophic” refers to organisms that obtain energy by the oxidation of chemical electron donors by chemical electron acceptors and synthesize all the organic compounds needed by the organism to live and grow from carbon dioxide.

In the claims, as well as in the specification, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively.

A “consortium” refers herein to two or more different species or strains of microorganisms and/or multi-cellular organisms, which are grown together, for example, grown in co-culture in the same growth medium.

“Cultured meat” or “cultivated meat” refers to a meat product that contains animal cells that have been cultured in vitro.

The term “culturing” refers to growing a population of cells, e.g., microbial cells, under suitable conditions for growth, in a liquid or solid medium.

The term “derived from” encompasses the terms “originated from,” “obtained from,” “obtainable from,” “isolated from,” and “created from,” and generally indicates that one specified material finds its origin in another specified material or has features that can be described with reference to another specified material.

“Dicing” refers to a process that includes cutting a material into smaller cubes or chunks.

The term “dough” as used herein refers to a blend of dry ingredients (“dry mix”; e.g., proteins, carbohydrates, and lipids including liquid oils) and liquid ingredients (“liquid mix”; e.g., water or juice, such as a liquid based extract from a non-animal source such as a plant or any part of a plant). The dough may also include one or more additional protein product with structural and/or functional properties that impart or enhance the structuring quality of the dough, e.g., in a shear process, and/or may include one or more flavoring agent and/or substance that imparts color.

“Drying” refers to removal of liquids (e.g., water, culture medium, etc.) from raw source materials, such as microbial biomass.

“Energy source” refers to either the electron donor that is oxidized by oxygen in aerobic respiration or the combination of electron donor that is oxidized and electron acceptor that is reduced in anaerobic respiration.

“Extremophile” refers to a microorganism that thrives in physically or geochemically extreme conditions (e.g., high or low temperature, pH, or high salinity) compared to conditions on the surface of the Earth or the ocean that are typically tolerated by most life forms found on or near the earth's surface.

The term “functional properties,” “functional characteristics,” or “functionality” or similar descriptors refers to how food ingredients behave during preparation and cooking, and how they affect the finished food product in terms of how it looks, tastes, feels, and handles. Functional properties can include water absorption, water solubility, oil absorption indexes, expansion index, bulk density, viscosity, binding, aeration, thickening, setting, adding color, dextrinization, caramelization, jelling, denaturation, coagulation, emulsion capacity or emulsion stability.

The term “gasification” refers to a generally high temperature process that converts carbon-based materials into a mixture of gases including hydrogen, carbon monoxide, and carbon dioxide called synthesis gas, syngas or producer gas. The process generally involves partial combustion and/or the application of externally generated heat along with the controlled addition of oxygen and/or steam such that insufficient oxygen is present for complete combustion of the carbon-based material.

“Grinding” refers to a process that includes reduction of a material to smaller pieces or particles by friction or abrasion.

“Halophile” refers to a type of extremophile that thrives in environments with very high concentrations of salt.

“Heterotrophic” refers to organisms that cannot synthesize all the organic compounds needed by the organism to live and grow from carbon dioxide, and which must utilize organic compounds for growth. Heterotrophic organisms cannot produce their own food and instead obtain food and energy by taking in and metabolizing organic substances, such as plant or animal matter, i.e., rather than fixing carbon from inorganic sources such as carbon dioxide.

“Hydrogen-oxidizer” refers to a microorganism that utilizes reduced H₂ as an electron donor for the production of intracellular reducing equivalents and/or in respiration.

“Hyperthermophile” refers to a type of extremophile that thrives in extremely hot environments for life, typically about 60° C. (140° F.) or higher.

The term “knallgas” refers to the mixture of molecular hydrogen and oxygen gas. A “knallgas microorganism” is a microbe that can use hydrogen as an electron donor and oxygen as an electron acceptor in respiration for the generation of intracellular energy carriers such as Adenosine-5′-triphosphate (ATP). The terms “oxyhydrogen” and “oxyhydrogen microorganism” can be used synonymously with “knallgas” and “knallgas microorganism,” respectively. Knallgas microorganisms generally use molecular hydrogen by means of hydrogenases, with some of the electrons donated from H₂ that is utilized for the reduction of NAD⁺ (and/or other intracellular reducing equivalents) and some of the electrons from H₂ that is used for aerobic respiration. Knallgas microorganisms generally fix CO₂ autotrophically, through pathways including but not limited to the Calvin Cycle or the reverse citric acid cycle [“Thermophilic bacteria”, Jakob Kristjansson, Chapter 5, Section III, CRC Press, (1992)].

The term “laminate” refers to a process of overlaying thin sheets on top of each other.

The term “lipid” herein refers to one or more molecules (e.g., biomolecules) that include a fatty acyl group (e.g., saturated or unsaturated acyl chains). For example, the term lipids includes oils, phospholipids, free fatty acids, monoglycerides, diglycerides, and triglycerides.

The term “lysate” refers to the liquid containing a mixture and/or a solution of cell contents that result from cell lysis, e.g., microorganism cell lysis. In some embodiments, the methods described herein comprise a purification of chemicals or mixture of chemicals in a cellular lysate. In some embodiments, the methods comprise a purification of amino acids and/or protein in a cellular lysate.

The term “lysis” refers to the rupture of the plasma membrane and if present, the cell wall of a cell, e.g., microorganism cell, such that a significant amount of intracellular material escapes to the extracellular space. Lysis can be performed using electrochemical, mechanical, osmotic, thermal, or viral means. In some embodiments, the methods described herein comprise performing a lysis of cells or microorganisms as described herein in order to separate a chemical or mixture of chemicals from the contents of a bioreactor. In some embodiments, the methods comprise performing a lysis of cells or microorganisms described herein in order to separate an amino acid or mixture of amino acids and/or proteins from the contents of a bioreactor or cellular growth medium.

The term “meat analogue” or “meat substitute” or “imitation meat” or “artificial meat” as used herein refers to a food product that is not derived from an animal, or that contains a substantial amount of non-animal protein source, but has structure, texture, aesthetic qualities, and/or other properties comparable or similar to those of animal meat. The term refers to uncooked, cooking, and cooked meat-like food product.

“Methanogen” refers to a microorganism that generates methane as a product of anaerobic respiration.

“Methylotroph” refers to a microorganism that can use reduced one-carbon compounds, such as but not limited to methanol or methane, as a carbon source and/or as an electron donor for their growth.

The terms “microorganism” and “microbe” mean microscopic single celled life forms, such as bacterial and fungal microorganisms.

The term “molecule” means any distinct or distinguishable structural unit of matter comprising one or more atoms, and includes for example hydrocarbons, lipids, polypeptides and polynucleotides.

“Non-biogenic CO₂” refers to carbon that has been trapped beneath the Earth's surface for long periods of geologic time (e.g., natural gas, oil, etc.), and which is released into the biosphere by natural or non-natural means.

“Oligopeptide” refers to a peptide that contains a relatively small number of amino-acid residues, for example, about 2 to about 20 amino acids.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

The term “organic compound” refers to any gaseous, liquid, or solid chemical compound that contains carbon atoms, with the following exceptions that are considered inorganic: carbides, carbonates, simple oxides of carbon, cyanides, and allotropes of pure carbon such as diamond and graphite.

“Peptide” refers to a compound (a polypeptide) consisting of two or more amino acids linked in a chain, the carboxyl group of each acid being joined to the amino group of the next by a bond of the type R—OC—NH—R′, for example, about 2 amino acids to about 50 amino acids, or 21 amino acids to about 50 amino acids.

As used herein, the term “polynucleotide” refers to a polymeric form of nucleotides of any length and any three-dimensional structure and single- or multi-stranded (e.g., single-stranded, double-stranded, triple-helical, etc.), which contain deoxyribonucleotides, ribonucleotides, and/or analogs or modified forms of deoxyribonucleotides or ribonucleotides, including modified nucleotides or bases or their analogs. Because the genetic code is degenerate, more than one codon may be used to encode a particular amino acid, and the present invention encompasses polynucleotides which encode a particular amino acid sequence. Any type of modified nucleotide or nucleotide analog may be used, so long as the polynucleotide retains the desired functionality under conditions of use, including modifications that increase nuclease resistance (e.g., deoxy, 2′-O-Me, phosphorothioates, etc.). Labels may also be incorporated for purposes of detection or capture, for example, radioactive or nonradioactive labels or anchors, e.g., biotin. The term polynucleotide also includes peptide nucleic acids (PNA). Polynucleotides may be naturally occurring or non-naturally occurring. The terms “polynucleotide,” “nucleic acid,” and “oligonucleotide” are used herein interchangeably. Polynucleotides may contain RNA, DNA, or both, and/or modified forms and/or analogs thereof. A sequence of nucleotides may be interrupted by non-nucleotide components. One or more phosphodiester linkages may be replaced by alternative linking groups. These alternative linking groups include, but are not limited to, embodiments wherein phosphate is replaced by P(O)S (“thioate”), P(S)S (“dithioate”), (O)NR₂ (“amidate”), P(O)R, P(O)OR′, CO or CH2 (“formacetal”), in which each R or R′ is independently H or substituted or unsubstituted alkyl (1-20 C) optionally containing an ether (—O—) linkage, aryl, alkenyl, cycloalkyl, cycloalkenyl or araldyl. Not all linkages in a polynucleotide need be identical. Polynucleotides may be linear or circular or comprise a combination of linear and circular portions.

As used herein, “polypeptide” refers to a composition comprised of amino acids and recognized as a protein by those of skill in the art. The conventional one-letter or three-letter code for amino acid residues is used herein. The terms “polypeptide” and “protein” are used interchangeably herein to refer to polymers of amino acids of any length. The polymer may be linear or branched, it may comprise modified amino acids, and it may be interrupted by non-amino acids. The terms also encompass an amino acid polymer that has been modified naturally or by intervention; for example, disulfide bond formation, glycosylation, lipidation, acetylation, phosphorylation, or any other manipulation or modification, such as conjugation with a labeling component. Also, included within the definition are, for example, polypeptides containing one or more analogs of an amino acid (including, for example, unnatural amino acids, etc.), as well as other modifications known in the art.

The term “precursor to” or “precursor of” is an intermediate towards the production of one or more of the components of a finished product.

“Producer gas” refers to a gas mixture containing various proportions of H₂, CO, and CO₂, and having heat value typically ranging between one half and one tenth that of natural gas per unit volume under standard conditions. Producer gas can be generated various ways from a variety of feedstocks, including gasification, steam reforming, or autoreforming of carbon-based feedstocks. In addition to H₂, CO, and CO₂, producer gases can contain other constituents including but not limited to methane, hydrogen sulfide, condensable gases, tars, and ash depending upon the generation process and feedstock. The proportion of N₂ in the mixture can be high or low depending whether air is used as an oxidant in the reactor or not and if the heat for the reaction is provided by direct combustion or through indirect heat exchange.

The term “producing” includes both the production of compounds intracellularly and extracellularly, including the secretion of compounds from the cell.

“Protein concentrate” refers to a protein-rich ingredient, e.g., derived from a microorganism as described herein. The purity of a protein concentrate may range from about 50% to about 99% protein by weight. A protein concentrate may be produced from cells, e.g., microbial cells, in a method that involves denaturation of protein, such as, but not limited to, a heat treatment, followed by removal of liquid. The proteins in a protein concentrate are denatured.

“Protein hydrolysate” refers to a mixture of peptides and/or amino acids created from hydrolyzing the amide bonds in a polypeptide chain of a single protein or a mixture of proteins. Hydrolysates may be produced by chemical, thermal, or enzymatic means, or combinations thereof, and may be produced from proteins derived from microorganisms as described herein. In some embodiments, the degree of hydrolysis may be about 10% to about 99%. In some embodiments, the average molecular weight of peptides in hydrolysate products are about 1 kDa to about 10 kDa.

“Protein isolate” refers to a protein-rich ingredient, e.g., derived from a microorganism as described herein. The purity of a protein isolate may range from about 85% to about 99% protein by weight. A protein isolate may be produced from cells, e.g., microbial cells, in a method that involves lysis of the cells, followed by purification of protein. The proteins in a protein isolate may be non-denatured (e.g., in their native conformations) or may be denatured, or some proteins may be non-denatured and others denatured.

“Protein powder” or “protein-containing powder,” used interchangeably herein, refers herein to a concentrated source of protein (e.g., derived from microbes (e.g., bacteria), plants, algae, fungi, insects, etc.), in dried or dehydrated form. In some embodiments, the protein powder contains substantially no carbohydrates, fats, and/or other biomolecules. In some embodiments, the protein powder contains vitamins (e.g., one or more B vitamins, such as vitamin B12, and/or minerals (e.g., calcium, iron), which may be from the source material from which the protein powder was obtained or may be added.

“Protein slurry” refers to a composition that includes a protein-containing solid phase and a liquid phase. In some embodiments, the protein slurry solid phase consists essentially of proteins. In some embodiments, in addition to proteins, the protein slurry solid phase may include other nutrients, structural, coloring, and/or flavoring components, such as, but not limited to, carbohydrates, fats, dietary fiber, and flavoring agents.

“Psychrophile” refers to a type of extremophile capable of growth and reproduction in cold temperatures, typically about 10° C. and lower.

The terms “recovered,” “isolated,” “purified,” and “separated” as used herein refer to a material (e.g., a protein, nucleic acid, or cell) that is removed from at least one component with which it is naturally associated. For example, these terms may refer to a material that is substantially or essentially free from components which normally accompany it as found in its native state, such as, for example, an intact biological system.

“Shaving” refers to a process that includes removal of thin pieces or strips of a material which have been cut from a larger piece of the material.

“Sheets” or “sheeting” as used herein refers to a protein-containing composition, such as a dough, that has been stretched and flattened to form wide and thin layers of the composition, for example, about 0.2 mm-about 1 mm in thickness.

“Shredding” refers to a process that includes cutting or tearing a material into smaller pieces, such as, but not limited to, small strips.

“Slicing” refers to cutting a material with a blade, such as a circular blade or knife, to a desired thickness.

The term “structured food product” or “structured food composition” as used herein refers to a product or composition that includes structural elements or components that provide a desired structure, texture, and/or configuration for a food product or an analogue of a food product, such as protein fiber networks and/or aligned protein fibers and/or laminated sheets that produce textures, such as meat-like textures (“structured meat product” or “structured meat analogue product” or “meat structured protein product”), with optional post-processing after the fibrous and/or aligned and/or sheeted structure is generated and fixed (e.g., hydrating, marinating, drying, coloring, mixing, heating, injecting, laminating, cooling). Methods for determining the degree of protein fiber network formation and/or protein fiber alignment include visual determination based upon photographs and micrographic images.

The term “structured meat product” or “structured meat analogue product” or “meat structured protein product” as used herein refers to a product that includes protein fiber networks and/or aligned protein fibers that produce meat-like textures, with optional post-processing after the fibrous and/or aligned structure is generated and fixed (e.g., hydrating, marinating, drying, coloring). Methods for determining the degree of protein fiber network formation and/or protein fiber alignment include visual determination based upon photographs and micrographic images.

The phrase “substantially free” or “essentially free” as to any given component means that such component is only present, if at all, in an amount that is a functionally insignificant amount, i.e., it does not significantly negatively impact the intended performance or function of any process or product. Typically, substantially free means less than about 1%, including less than about 0.5%, including less than about 0.1%, and also including zero percent, by weight of such component. The terms “substantially free” or “essentially free” shall mean less than 1% of a component.

“Sulfur-oxidizer” refers to microorganisms that utilize reduced sulfur containing compounds including but not limited to H₂S as electron donors for the production of intracellular reducing equivalents and/or in respiration.

“Syngas” or “Synthesis gas” refers to a type of gas mixture, which like producer gas contains H₂ and CO, but which has been more specifically tailored in terms of H₂ and CO content and ratio and levels of impurities for the synthesis of a particular type of chemical product, such as but not limited to methanol or fischer-tropsch diesel. Syngas generally contains H₂, CO, and CO₂ as major components, and it can be generated through established methods including: steam reforming of methane; or through gasification of any organic, flammable, carbon-based material, including but not limited to biomass, organic matter, or peat. The hydrogen component of syngas can be increased through the reaction of CO with steam in the water gas shift reaction, with a concomitant increase in CO₂ in the syngas mixture.

“Thermophile” refers to a type of extremophile that thrives at relatively high temperatures for life, typically about 45° C. to about 122° C.

“Wild-type” refers to a microorganism as it occurs in nature.

“Yield” refers to amount of a product produced from a feed material relative to the total amount of the substance that would be produced if all of the feed substance were converted to product. For example, yield of the product may be expressed as % of the product produced relative to a theoretical yield if 100% of the feed substance were converted to the product.

### Structured Food Products and Methods to Form Structured Food Products

Structured food products are provided herein. The structured food product includes protein derived from one or more of microorganism, plant, algae, fungi (e.g., mycoprotein), and/or insect. Structured food products encompass unique food structures that are formed when food ingredients are uniquely assembled or mixed together and processed, e.g., sheeted, shredded, and/or extruded to make a food product, i.e., an edible product for human or animal consumption.

In one aspect, structured food product as described herein includes a protein-containing composition or a protein composition, such as a dough composition (e.g., comprising protein from one or more microorganism, plant, algae, fungus, and/or insect) that is formed into two or more sheets that are layered and laminated or bound together to provide the structured food product.

In one aspect, the structured food product as described herein includes a protein-containing composition, such as a dough composition (e.g., containing protein from the one or more microorganism, plant, algae, fungus, and/or insect) that is shredded and/or ground to produce the structured food product, or shredded and/or ground and then converted into or incorporated into a structured food product. In some embodiments of the aforementioned aspects, the structured product formed through the methods provided herein, such as, e.g., layered sheets or the shredded and/or the ground protein composition optionally mixed in the dough composition, possess meat like properties, such as, e.g., texture of the meat or taste of the meat (the meat analogue product). Examples are provided herein such as, for example only, chicken breast analogue product, scallop analogue product, etc.

In one aspect, the structured food product as described herein includes a protein-containing composition, such as a dough composition (e.g., containing protein from the one or more microorganism, plant, algae, fungus, and/or insect) that is extruded in a process, such as, but not limited to, high moisture extrusion process and/or cold extrusion process.

In some embodiments, the structured food product is in the form of an extruded slab, which is cut, sliced, diced, shredded, shaved, or otherwise converted into smaller pieces. In certain embodiments, the extrudate is sliced, e.g., sliced into pieces that resemble or are of a similar configuration or appearance as deli slices. In certain embodiments, the extrudate is cut or diced into chunks, which may be colored and/or flavored to resemble a meat product. In certain embodiments, pieces of extrudate are bound together (e.g., with a binder composition) and formed or molded to resemble a food product, such as a meat product.

In some embodiments, the structured food product is in the form of extruded strands or bundles of extruded strands or cut bundles of extruded strands. For example, the extruded strands may be cut or sliced, e.g., in a direction that is perpendicular or substantially perpendicular to the lengths of the strands in a bundle of extruded strands or the length of a log shaped structured formed by bundled and adhered extruded strands, and may, in some embodiments, resemble shellfish, such as scallops, or other sliced or disc shaped meat, fish, or seafood analogues.

In some embodiments, the structured food product is incorporated into another food product or composition. For example, the structured food product may be incorporated into soups, stews, chili, sauces, etc. that typically include meat, fish, or seafood.

In some embodiments, the structured food product is incorporated into another food product or composition. For example, the structured food product may be incorporated into: soups or stews that typically include chicken, beef, etc., such as chicken korma, curries, pho, etc.; sandwiches, such as in the form of deli slices, shreds, or crumbles, such as cold cut sandwich, Philly cheesesteak, burger, tuna melt, poboy, smoked meat, fried chicken, fried fish, wraps; or casseroles. For example, the structured food product may be shredded and sauces, such as barbecue, hot sauce, salsa verde, buffalo sauce, teriyaki, marinade, such as resembling shredded beef, chicken, or pork, or assembled into tacos or burritos, empanadas, dumplings, etc. For example, the structured food product may be in the form of chunks, such as resembling tuna (e.g., tuna steak, tuna chunks e.g., cooked and canned, or raw (poke bowl), tuna slices (e.g., sashimi), or seared tuna. For example, the structured food product may be configured to resemble crab meat (e.g., crab cakes, lump crab chunks). For example, the structured food product may be incorporated into a sauce that typically contains meat, or chili (e.g., resembling ground beef or pork). For example, the structured food product may be incorporated into a noodle dish that typically contains meat (e.g., pad thai).

Nonlimiting examples of structured food products in accordance with the description herein include dairy products, dairy replacement products, meat and cultured meat products (including livestock, game, poultry, fish, or seafood products), meat analogue products (including imitation livestock, game, poultry, fish, or seafood products), bakery products, confections, health and protein bars, protein powders, and flours.

A structured food product as described herein may be an analogue of a natural food product and may include rheological and structural (geometric and surface) attributes of a food product, such as attributes perceptible by means of mechanical, tactual and/or visual receptors. Food structure attributes include, for example: adhesive, bouncy, brittle, bubbly, chewy, clingy, coating, cohesive, creamy, crisp, crumbly, crusty, dense, doughy, dry, elastic, fatty, firm, flaky, fleshy, fluffy, foamy, fragile, full-bodied, gooey, grainy, gritty, gummy, hard, heavy, heterogeneous, juicy, lean, light, limp, lumpy, moist, mouth-coating, mushy, oily, pasty, plastic, porous, powdery, puffy, pulpy, rich, rough, rubbery, runny, sandy, scratchy, etc.

In some embodiments of the structured food products and the methods to produce the structured food products described herein, the protein fibers are substantially aligned. Protein fiber networks and/or protein fiber alignments may impart cohesion and firmness, whereas open spaces in the protein fiber networks and/or protein fiber alignments may tenderize the meat structured protein products, such as, e.g., chicken breast analogue or scallop analogue, etc. and provide pockets for capturing water, carbohydrates, salts, lipids, flavorings, and other materials that are slowly released during chewing to lubricate the shearing process and to impart other meat-like sensory characteristics.

In some embodiments, the structured food product includes the protein composition, or the protein-containing composition, or protein derived from one or more microorganisms, i.e., a microbially-derived protein product. The microbially-derived protein product may be derived from a bacterial or fungal microorganism. In some embodiments, the microorganism is a chemoautotrophically grown microorganism, such as a microorganism grown on a gaseous C1 carbon source, such as CO₂, CO, or CH₄, or is a microorganism that is grown in a medium that includes a protein product derived from a chemoautotrophically grown microorganism. The chemoautotrophic microorganism may be any chemoautotrophic microorganism described herein, infra. In certain non-limiting embodiments, the chemoautotrophic microorganism is a Cupriavidus microorganism, such as Cupriavidus necator or Cupriavidus metallidurans.

In some embodiments, the microorganism is a GRAS microorganism, such as any of the GRAS microorganisms described herein, infra, such as a lactic acid bacterium (LAB). In certain embodiments, the GRAS microorganism is grown in a medium that includes protein product derived from a non-GRAS microorganism. The non-GRAS microorganism may be, for example, a chemoautotrophically grown microorganism, such as, for example, a Cupriavidus microorganism, such as Cupriavidus necator or Cupriavidus metallidurans.

In some embodiments, the microorganism from which the protein product is incorporated into the structured food composition, e.g., structured meat analogue composition, is non-GMO.

The microbially-derived protein product (or microbial protein product, or “protein product” or microbial protein product or microorganism protein product, used interchangeably herein) in the structured food product may include one or more of single cell protein, cell lysate, protein isolate, protein concentrate, protein hydrolysate, free amino acids, peptides, and oligopeptides. In some embodiments, the microbially-derived protein product in the structured food product may include microbial biomass comprising microorganism cell mass, such as, e.g., oxyhydrogen microorganism cell mass and microorganism protein product comprising one or more of single cell protein, cell lysate, protein isolate, protein concentrate, protein hydrolysate, free amino acids, peptides, and oligopeptides. The microbial protein product, e.g., any of the protein products described herein, may be included in the structured food composition in an amount any of at least about 2% (w/w), 5% (w/w), 10% (w/w), 15% (w/w), 20% (w/w), 25% (w/w), 30% (w/w), 35% (w/w), 40% (w/w), 45% (w/w), 50% (w/w), 55% (w/w), 60% (w/w), 65% (w/w), or 70% (w/w). In some embodiments, the content of the microbially-derived protein product of the structured food product is any of about 2% (w/w) to about 100% (w/w), about 2% (w/w) to about 90% (w/w), about 2% (w/w) to about 80% (w/w), about 2% (w/w) to about 70% (w/w), about 2% (w/w) to about 10% (w/w), about 5%(w/w) to about 50% (w/w), about 5% (w/w) to about 10% (w/w), about 10% (w/w) to about 15% (w/w), about 15% (w/w) to about 20% (w/w), about 20% (w/w) to about 25% (w/w), about 25% (w/w) to about 30% (w/w), about 30% (w/w) to about 35% (w/w), about 35% (w/w) to about 40% (w/w), about 40% (w/w) to about 45% (w/w), about 45% (w/w) to about 50% (w/w), about 5% (w/w) to about 15%(w/w), about 10% (w/w) to about 20% (w/w), 15% (w/w) to about 25% (w/w), about 20% (w/w) to about 30% (w/w), about 25% (w/w) to about 35% (w/w), about 30% (w/w) to about 40% (w/w), about 35% (w/w) to about 40% (w/w), about 40% (w/w) to about 50% (w/w), about 5% (w/w) to about 25% (w/w), about 20% (w/w) to about 40% (w/w), or about 25% to about 50% (w/w). The protein product may comprise at least about 5% (w/w) to about 50% (w/w) single cell protein, at least about 5% (w/w) to about 50% (w/w) cell lysate, at least about 5% (w/w) to about 50% (w/w) protein isolate, at least about 5% (w/w) to about 50% (w/w) protein hydrolysate, at least about 5% (w/w) to about 50% (w/w) free amino acids, at least about 5% (w/w) to about 50% (w/w) peptides, at least about 5% (w/w) to about 50% (w/w) oligopeptides, at least about 25% (w/w) to about 80% (w/w) single cell protein, at least about 25% (w/w) to about 80% (w/w) cell lysate, at least about 25% (w/w) to about 80% (w/w) protein isolate or protein concentrate, at least about 25% (w/w) to about 80% (w/w) protein hydrolysate, at least about 25% (w/w) to about 80% (w/w) free amino acids, at least about 25% (w/w) to about 80% (w/w) peptides, at least about 25% (w/w) to about 80% (w/w) oligopeptides, at least about 75% (w/w) to about 100% (w/w) single cell protein, at least about 75% (w/w) to about 100% (w/w) protein isolate or protein concentrate, at least about 75% (w/w) to about 100% (w/w) protein hydrolysate, at least about 75% (w/w) to about 100% (w/w) free amino acids, at least about 75% (w/w) to about 100% (w/w) peptides, and/or at least about 75% (w/w) to about 100% (w/w) oligopeptides.

In some embodiments, the structured food product includes one or more plant protein source such as, but not limited to, pea, rice, glutinous rice, wheat, gluten, soy, hemp, canola, and/or buckwheat, rice protein, pea protein, mung bean protein, fava protein, potato protein, wheat protein, chickpea protein, soy protein, jackfruit, oats, quinoa, sorghum, foxtail millets, tofu, edamame, red lentils, green lentils, spirulina, chia seeds, nuts, and/or hemp seeds. In some embodiments, the plant protein source includes one or more of rice protein, pea protein, mung bean protein, fava protein, potato protein, wheat protein, chickpea protein, soy protein, jackfruit, oats, quinoa, sorghum, foxtail millets, tofu, edamame, lentils (e.g., red lentils, green lentils), spirulina, chia seeds, nuts, and hemp seeds.

In some embodiments, the structured food product does not include soy or an ingredient derived from soy. In some embodiments, the structured food product does not include wheat or an ingredient derived from wheat. In some embodiments, the structured food product does not include gluten (e.g., is gluten free). In some embodiments, the structured food product does not include soy or wheat, or ingredients derived therefrom, and does not include gluten. In some embodiments, the structured food product is wheat free, soy free, or wheat and soy free, or does not include ingredients derived from wheat, or from soy, or from wheat and soy. In some embodiments, the structured food product includes plant protein source, such as, e.g., pea protein and/or fiber, and/or one or more carbohydrate, such as a fructooligosaccharide (e.g., short-chain fructooligosaccharide).

In some embodiments, the plant protein source as described herein, such as, e.g., pea protein, may be included in combination with the microorganism protein product as described herein (e.g., one or more of single cell protein, cell lysate, protein isolate, protein concentrate, protein hydrolysate, free amino acids, peptides, oligopeptides, or combination of any two or more thereof), in a structured food product. In some embodiments, the microorganism and/or plant protein imparts a desired flavor to the structured food composition, such as, for example, a meat-like flavor. For example, microorganism protein product and plant protein source may be included in the structured food product at ratios of any of about 55:45, 50:50, 60:40, 65:35, 2:1, 70:30, 75:25, 80:20, 5:1, 85:15, 90:10, 20:1, 95:5, or 99:1 microorganism protein product:plant protein or plant protein:microorganism protein product.

In some embodiments, the structured food product is a meat analogue product, e.g., structured to resemble in texture or appearance, a natural meat product derived from an animal. For example, the meat analogue product may be any of a beef, poultry (e.g., chicken, turkey, duck), pork, fish, or seafood analogue product. The meat analogue product may be in the form of a natural meat product, such as a burger, a nugget, etc., and may reproduce a texture and/or organoleptic (i.e., involving one or more sense organ) characteristic of a natural meat product.

The structured food product, e.g., structured meat analogue product, may include one or more flavorant. In some embodiments, the structured food product, e.g., structured meat analogue product, may include a flavohemoprotein flavorant. In some embodiments, the flavohemoprotein is produced by the microorganism from which the microbial protein product, that is incorporated into the structured food product, is derived. In some embodiments, the flavohemoprotein and the microorganism protein product are produced by a Cupriavidus microorganism, such as Cupriavidus necator or Cupriavidus metallidurans. In another embodiment, the flavohemoprotein is produced by a different microorganism than the microorganism from which a microbial protein product that is incorporated into the structured food product is derived. In one embodiment, the flavohemoprotein is produced by a Cupriavidus microorganism, such as Cupriavidus necator or Cupriavidus metallidurans, and the microorganism protein product is produced by a different microorganism.

In some embodiments, the structured food product, e.g., structured meat analogue product, includes one or more supplemental vitamins, nutrients, or functional substance i.e., supplemented into the formulation (e.g., dough) for production of the structured food product or into the growth medium for the microorganism from which a microbial protein product is derived, or may be produced by the microorganism from which the protein product is derived. Nonlimiting examples of such supplements include amino acids (e.g., essential amino acids), lipids, oils, fatty acids, vitamins (e.g., vitamin B₁₂, biotin, other essential vitamins), antioxidants, minerals, surfactants, and emulsifiers.

In some embodiments, the structured food composition, e.g., the structured meat analogue composition, does not include animal derived material or substances, such as animal-derived biomolecules or biochemicals. In some embodiments, for example, in the meat analogue product, a hydrogel, lipogel, and/or emulsion is included in the composition, for example, as an agent release system (e.g., for release of a coloring agent, a flavor agent, a fatty acid, a leavening agent, a gelling agent (e.g., bicarbonate (e.g., potassium bicarbonate), calcium hydroxide, and/or alginate (e.g., sodium or potassium alginate)) wherein the agent(s) may be released during cooking of the food product to simulate animal meat. In other embodiments, the structured food product includes one or more animal-derived substance(s), such as, but not limited to, collagen, flavoring agents or compositions, and/or lipids (e.g., fat). In further embodiments, the structured food composition includes animal meat and/or cultured meat.

In some embodiments, at least a portion or all of the protein product in the structured food product described herein, including but not limited to, a meat analogue product, includes protein product (e.g., one or more of single cell protein, cell lysate, protein isolate, protein concentrate, protein hydrolysate, free amino acids, peptides, oligopeptides, or combinations thereof) derived from a Cupriavidus microorganism, such as, but not limited to, Cupriavidus necator, e.g., DSM 531 or DSM 541.

In some embodiments, at least a portion or all of the protein product in a food product described herein, including but not limited to, a meat analogue product, includes protein product (e.g., one or more of single cell protein, cell lysate, protein isolate, protein concentrate, protein hydrolysate, free amino acids, peptides, oligopeptides, or combinations thereof) derived from a lactic acid bacterium, such as, but not limited to a Lactococcus, Lactobacillus, Enterococcus, Streptococcus, or Pediococcus bacterium. In some embodiments, the lactic acid bacterium is a GRAS bacterium.

In some embodiments, at least a portion or all of the protein product in a food product described herein, including but not limited to, a meat analogue product, includes protein product (e.g., one or more of single cell protein, cell lysate, protein isolate, protein concentrate, protein hydrolysate, free amino acids, peptides, oligopeptides, or combinations thereof) derived from a Fusarium or Rhizopus fungal microorganism, such as but not limited to, Fusarium venenatum, Rhizopus oligosporus, or Rhizopus oryzae. In some embodiments, the fungal microorganism is a GRAS microorganism.

Use of chemoautotrophic microorganisms for production of protein and other biomolecules is described in PCT Application Nos. WO2017/165244 and WO2018/144965, both of which are incorporated herein by reference in their entireties.

Use of chemoautotrophic microorganisms for production of proteins and other components of food products is described in PCT Application Nos. PCT/US20/67555, filed Dec. 30, 2020, PCT/US21/14795, filed Jan. 22, 2021, PCT/US21/23949, filed Mar. 24, 2021, PCT Application No. PCT/US22/35086, filed Jun. 27, 2022, PCT/US22/35092, filed Jun. 27, 2022, and PCT/US22/35110, filed Jun. 27, 2022, all of which are incorporated herein by reference in their entireties.

Various unique structured food products and the methods to form the structured food products are provided herein. Various methods include unique techniques of sheeting, shredding, grinding, and extruding, alone or in combination, to produce various structured food products, such as, but not limited to, meat analogue products, e.g., chicken breast, pasta noodles, scallop, etc.

### Sheeting

In one aspect, the structured food products as described herein are produced in a method that includes production of sheets of a protein composition or a protein-containing composition, which are then layered and adhered together. Sheets as described herein contain a cohesive dough matrix and are sheeted by mechanical means to a desired thickness, such as between about 0.1 mm to about 5 mm, or about 0.1 mm to about 4 mm, or about 0.1 mm to about 3 mm, or about 0.1 mm to about 2 mm, or any of about 0.1 mm to about 0.5 mm, about 0.1 mm to about 1 mm, 0.25 mm to about 0.75 mm, about 0.5 mm to about 1 mm, about 0.75 mm to about 1.25 mm, about 1 mm to about 1.5 mm, about 1.25, mm to about 1.75 mm, about 1.5 mm to about 2 mm, about 0.1 mm to about 1 mm, about 0.5 mm to about 1.5 mm, or about 1 mm to about 2 mm.

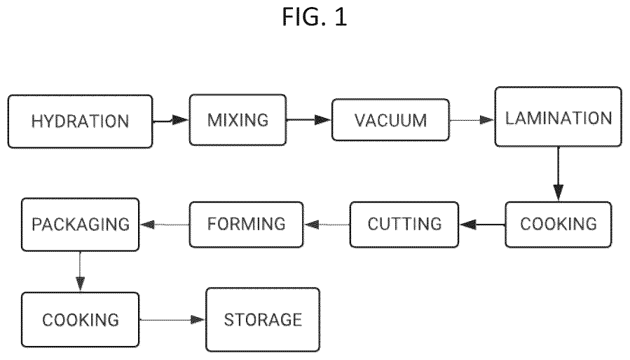

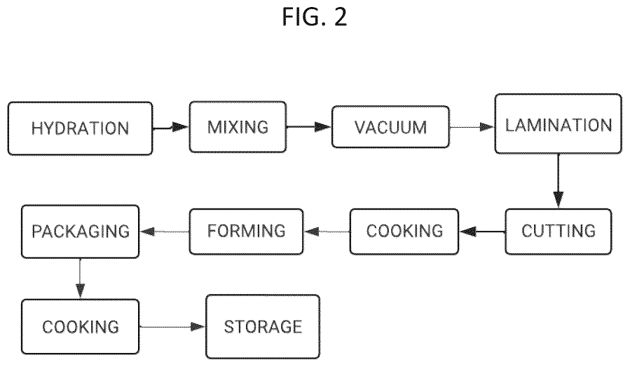

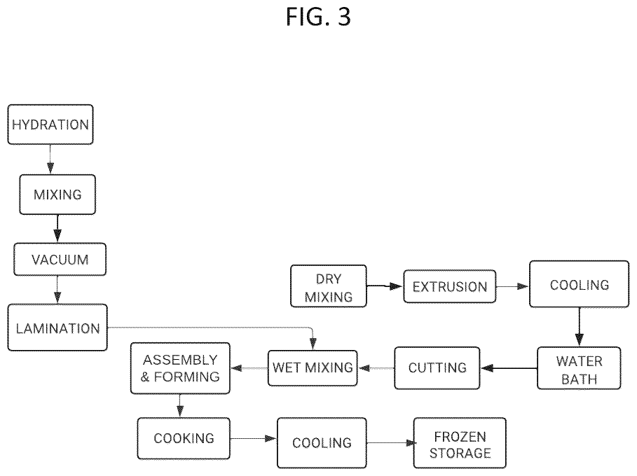

In one aspect, the structured food products as described herein include a protein composition or a protein-containing composition, such as a dough composition (e.g., comprising protein from one or more microorganisms, one or more plants, one or more algae, one or more fungi, and/or one or more insects) that is formed into two or more sheets, or between 2-5 sheets or more than 5 sheets that are layered and laminated or bound together or adhered to provide the structured food product. In some embodiments, the two or more sheets are bound together by an adhesive composition wherein the adhesive composition comprises protein from one or more microorganisms, one or more plants, one or more algae, one or more fungi, and/or one or more insects. In some embodiments, the structured food products described herein comprise two or more sheets of the dough composition comprising protein from the one or more microorganism or microbially-derived protein product, and the adhesive composition comprising protein from the one or more microorganism or microbially-derived protein product. FIG. 1, FIG. 2, and FIG. 3 illustrate various embodiments of the sheeting method and the structured food products made therefrom.

In one aspect, there is provided a method to form the structured food product, comprising producing two or more sheets from a dough composition comprising protein derived from one or more microorganism, plant, algae, fungus, and/or insect; layering the two or more sheets on top of each other; laminating the two or more sheets using an adhesive composition comprising protein from one or more microorganism, plant, algae, fungus, and/or insect, and forming the structured food product.

In one aspect, there is provided a method to form the structured food product, comprising producing two or more sheets from a dough composition comprising protein derived from one or more microorganism, plant, algae, fungus, and/or insect; layering the two or more sheets on top of each other; laminating the two or more sheets using an adhesive composition comprising protein from one or more microorganism, plant, algae, fungus, and/or insect; creating individual strands from the dough composition and layering the individual strands (to mimic meat fibers) on top of the laminated sheets, and forming the structured food product.

In some embodiments of the aspects provided herein, the microbially-derived protein product or the protein derived from one or more microorganism is microbial biomass wherein the microbial biomass comprises oxyhydrogen microorganism cell mass and protein from the microorganism. In one aspect, there is provided a method to form the structured food product, such as the meat analogue product, e.g., chicken breast analogue product, comprising producing two or more sheets from a protein-containing composition comprising microbial biomass wherein the microbial biomass comprises oxyhydrogen microorganism cell mass and protein from the microorganism; heating the sheets, e.g., to set the structure of the sheets, and/or to decolorize the protein-containing composition; and layering the sheets, optionally wherein one or more adhesive agent (such as, but not limited to, gluten) is added between layered sheets; and forming the structured food product, such as a meat analogue product, e.g., chicken breast analogue product.

In some embodiments of the aforementioned aspect, the composition or the protein-containing composition comprising protein from the microorganism further comprises pea protein. In some embodiments, the protein-containing composition comprises microbial biomass comprising oxyhydrogen microorganism cell mass and protein from the microorganism. In some embodiments, the protein-containing composition comprises microbial biomass comprising oxyhydrogen microorganism cell mass and protein from the microorganism; and pea protein. In some embodiments, the protein from the microorganism (or the microorganism protein product herein) comprises single cell protein, cell lysate, protein isolate, protein concentrate, protein hydrolysate, free amino acids, peptides, oligopeptides, or combination of any two or more thereof. In some embodiments, the microbial biomass comprising oxyhydrogen microorganism cell mass and protein from the microorganism comprises between about 0.5-25% by weight oxyhydrogen microorganism cell mass and between about 60%-99.5% or 75-99.5% by weight protein from the microorganism or the microorganism protein product. In some embodiments, the protein-containing composition comprises between about 1-10% by weight; or between about 1-8% by weight; or between about 1-6% by weight; or between about 1-4% by weight; or between about 1-2% by weight of the microbial biomass comprising oxyhydrogen microorganism cell mass and protein from the microorganism; and between about 20-60%; or between about 20-50%; or between about 20-40%; or between about 20-30%, by weight pea protein. In some embodiments, the composition comprises between about 1-10% by weight of the microbial biomass comprising between about 0.5-25% by weight oxyhydrogen microorganism cell mass and between about 60%-99.5% or 75%-99.5% by weight protein from the microorganism; and between about 20-60% by weight pea protein.

In some embodiments of the aforementioned aspect and embodiments to form the meat analogue product, e.g., chicken breast analogue product, the composition comprises between about 1-10% by weight of the microbial biomass comprising between about 0.5-25% by weight oxyhydrogen microorganism cell mass and between about 75%-99.5% by weight protein from the microorganism; and between about 20-60% by weight mycoprotein.

In some embodiments of the aforementioned aspect and embodiments, the protein from the microorganism or the microorganism protein product (e.g., one or more of single cell protein, cell lysate, protein isolate, protein concentrate, protein hydrolysate, free amino acids, peptides, oligopeptides, or combination of any two or more thereof) is from one or more microorganisms, such as, but not limited to a chemoautotrophic microorganism, such as a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof.

In some embodiments, the remaining ingredients in the composition include, but not limited to, lipid, oil, fiber, carbohydrate, or combination of any two or more thereof.

The method for production of a structured food product may include: (a) producing the protein-containing composition; (b) producing two or more of the sheets from the protein-containing composition; (c) heating the sheets, e.g., to set the structure of the sheets, and/or to decolorize the protein-containing composition; and (d) layering the sheets, optionally wherein one or more adhesive agent (such as, but not limited to, gluten) is added between layered sheets. In some embodiments, the layered sheets may be sealed in packaging, and then thermal and/or radiation energy (e.g., microwave) may then be applied to the sealed composition, e.g., a high moisture cooking process, to laminate or bind the sheets together. The structured food product may be formed (e.g., molded) or cut into a desired shape or structure, either prior or after application of thermal and/or radiation energy to bind the layers together. In one embodiment, the structured food product is formed (e.g., molded) or cut into a desired shape or structure, sealed in packaging, and then subjected to thermal and/or radiation energy, e.g., high moisture or steam cooked in the packaging.

In some embodiments, after forming the structured food product into a desired shape or structure, the formed structured food product may be sprayed with or dipped into a composition, such as a composition that includes protein, colors, flavors, flavor precursors, and/or sugars. For example, the formed structured food product may be a meat analogue product that is sprayed or dipped into the composition to form an outer layer that simulates skin, e.g., poultry skin, such as a chicken analogue with an outer chicken skin analogue.

In one aspect, there is provided a structured food product, such as, e.g., meat analogue product, such as, e.g., chicken breast analogue, comprising 2 or more, or 5 or more, or 10 or more layers of rolled dough composition comprising protein composition comprising microbial biomass; and an adhesive composition comprising the protein composition comprising microbial biomass, wherein the layers of the rolled dough are adhered together by the adhesive composition to form the meat analogue product, such as, e.g., chicken breast shaped structured food product. In some embodiments of the aforementioned aspect, a cross-section of the meat analogue product, such as, e.g., chicken breast shaped structured food product imitates fibrous texture of real meat. In some embodiments of the aforementioned aspect and embodiments, the cross-section of the meat analogue product, such as, e.g., chicken breast shaped structured food product imitates fibrous taste of the real meat.

In some embodiments of the aforementioned aspect and embodiments, the microbial biomass comprises oxyhydrogen microorganism cell mass and microorganism protein product. In some embodiments of the aforementioned aspect and embodiments, the protein composition comprises the microbial biomass comprising oxyhydrogen microorganism cell mass and microorganism protein product; and pea protein. In some embodiments of the aforementioned aspect and embodiments, the microorganism protein product comprises single cell protein, cell lysate, protein isolate, protein concentrate, protein hydrolysate, free amino acids, peptides, oligopeptides, or combination of any two or more thereof. In some embodiments of the aforementioned aspect and embodiments, the microbial biomass comprising oxyhydrogen microorganism cell mass and microorganism protein product comprises between about 0.5-25% by weight oxyhydrogen microorganism cell mass and between about 75%-99.5% by weight microorganism protein product. In some embodiments of the aforementioned aspect and embodiments, the protein composition comprises between about 1-10% by weight; or between about 1-8% by weight; or between about 1-6% by weight; or between about 1-4% by weight; or between about 1-2% by weight of the microbial biomass comprising oxyhydrogen microorganism cell mass and microorganism protein product; and between about 20-60%; or between about 20-50%; or between about 20-40%; or between about 20-30%, by weight pea protein. In some embodiments of the aforementioned aspect and embodiments, the composition comprises between about 1-10% by weight; or between about 1-8% by weight; or between about 1-6% by weight; or between about 1-4% by weight; or between about 1-2% by weight of the microbial biomass comprising oxyhydrogen microorganism cell mass and microorganism protein product; and between about 20-60%; or between about 20-50%; or between about 20-40%; or between about 20-30%, by weight mycoprotein.

In some embodiments of the aforementioned aspect and embodiments related to the meat analogue product, the protein composition comprises between about 1-10% by weight of the microbial biomass comprising between about 0.5-25% by weight oxyhydrogen microorganism cell mass and between about 60%-99.5% or between about 75%-99.5% by weight microorganism protein product; and between about 20-60% by weight pea protein. In some embodiments of the aforementioned aspect and embodiments, the composition comprises between about 1-10% by weight of the microbial biomass comprising between about 0.5-25% by weight oxyhydrogen microorganism cell mass and between about 75%-99.5% by weight microorganism protein product; and between about 20-60% by weight mycoprotein.

Accordingly, in some embodiments, there is provided a structured food product, such as, e.g., meat analogue product, such as, e.g., chicken breast analogue, comprising 2 or more, or 5 or more, or 10 or more layers of rolled dough composition comprising protein composition comprising microbial biomass and pea protein; and an adhesive composition comprising the protein composition comprising microbial biomass, wherein the microbial biomass comprises oxyhydrogen microorganism cell mass and microorganism protein product, and wherein the layers of the rolled dough are adhered together by the adhesive composition to form the meat analogue product, such as, e.g., chicken breast shaped structured food product. In some embodiments of the aforementioned embodiment, the protein composition comprises between about 1-10% by weight of the microbial biomass comprising between about 0.5-25% by weight oxyhydrogen microorganism cell mass and between about 60%-99.5% or between about 75%-99.5% by weight microorganism protein product; and between about 20-60% by weight pea protein. In some embodiments of the aforementioned embodiment, the composition comprises between about 1-10% by weight of the microbial biomass comprising between about 0.5-25% by weight oxyhydrogen microorganism cell mass and between about 75%-99.5% by weight microorganism protein product; and between about 20-60% by weight mycoprotein. In some embodiments, the protein-containing composition contains the microorganism protein product (e.g., one or more of single cell protein, cell lysate, protein isolate, protein concentrate, protein hydrolysate, free amino acids, peptides, oligopeptides, or combination of any two or more thereof) from one or more microorganisms, such as, but not limited to a chemoautotrophic microorganism, such as a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof.

In some embodiments, the remaining ingredients in the composition include, but not limited to, lipid, oil, fiber, carbohydrate, or combination of any two or more thereof.

The protein-containing composition in step (a) may be in the form of a protein slurry, which contains, in addition to protein, carbohydrates, fats, dietary fiber, and other nutrients or structural components. In some embodiments, the protein slurry contains at least about 90% water by weight (e.g., about 90% to about 95% water by weight), and about 1% to about 10% protein (e.g., protein powder) by weight.

In some embodiments, the structured food product, e.g., prior to or after binding of the layers by application of thermal and/or radiation energy, may be chopped, minced, diced, sliced, ground, etc. and incorporated into another food product. For example, a sheeted and laminated composition (optionally extruded, then laminated), produced as described herein, may be cut, for example, about 1 mm to about 50 mm thickness or diameter or largest dimension, and incorporated into a dough composition, and then assembled and pressed into a mold. The molded product may be heated (e.g., about 180° F. to about 230° F., about 20 minutes to about 60 minutes), and optionally cooled and frozen.

In some embodiments, a protein-containing composition as described herein, e.g., dough composition, is rested, laminated, and cut into strands, e.g., using noodle process technology. The strands may be treated (e.g., contacted, optionally submerged) with an alkaline solution (e.g., about 0.5%-about 3% sodium or potassium carbonate) to enhance texture. The strands (e.g., noodles) may be assembled into a bundle with flavoring agents, color, oil, and/or water, and then formed (e.g., molded) and heated (e.g., about 180° F. to about 230° F., about 20 minutes to about 60 minutes).

In certain non-limiting embodiments, the structured food product produced in the methods described herein is a meat or meat analogue product, a flour, a gelling agent, a bakery product, or a dairy or dairy analogue product.

In certain embodiments of the methods, the ingredients/components of the composition and/or processing conditions result in a carbon neutral or carbon negative structured food product. The protein-containing composition in step (a) may contain protein from one or more microorganisms, one or more plants, one or more algae, one or more fungi (e.g., mycoprotein), and/or one or more insects. In some embodiments, the protein-containing composition contains the microorganism protein product (e.g., one or more of single cell protein, cell lysate, protein isolate, protein concentrate, protein hydrolysate, free amino acids, peptides, oligopeptides, or combination of any two or more thereof) from one or more microorganisms, such as, but not limited to a chemoautotrophic microorganism, such as a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof. The microorganism protein product may be included in combination with any of one or more plant, algae, fungus, and/or insect protein. For example, the microorganism protein product may be included at any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the composition of step (a), with the remainder of the protein supplied by one or more plant, algae, fungus, and/or insect protein, or 100% of the protein in the composition of step (a) may be microorganism protein product. In other embodiments, any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the composition of step (a) is plant, algae, fungus, or insect derived protein, or a combination thereof, or 100% of the protein in the composition of step (a) may be plant, algae, fungus, or insect derived protein, or a combination thereof. In other embodiments, any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the composition of step (a) is plant derived protein, or 100% of the protein in the composition of step (a) may be plant derived protein. Nonlimiting examples of plant protein sources include rice, pea, mung bean, fava, potato, wheat, chickpea, soy, jackfruit, oats, quinoa, sorghum, foxtail millets, tofu, edamame, lentils (e.g., red lentils, green lentils), spirulina, chia seeds, nuts, and hemp seeds.

Optionally, the protein-containing composition in step (a) contains one or more salt(s), such as, but not limited to, NaCl, KCl, and/or monosodium glutamate (MSG).

In some embodiments, the protein (such as the microorganism protein product) may be subjected to a process to lighten the color of the protein prior to step (a).

The protein-containing composition in step (a) may further contain one or more lipid (e.g., oil and/or fat), one or more flavoring and/or coloring agent or composition, one or more carbohydrate, and/or one or more fiber source (e.g., edible soluble or insoluble fiber). In certain embodiments, carbohydrates and/or fiber are in the form of a gum, e.g., xanthan gum, that is derived from a plant, a microorganism, and/or an alga. In certain embodiments, lipid may be derived from a plant, a microorganism, and/or an algae. For example, the lipid may be derived from the microorganism, such as but not limited to, Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism. In some embodiments, the lipid may be derived from a plant source, such as, but not limited to sunflower, canola, coconut, palm, cocoa butter, and/or vegetable oil.

In certain embodiments, the protein-containing composition of step (a) contains: (i) about 20% (w/w) to about 50% (w/w) protein product from one or more microorganism and about 10% (w/w) to about 50% (w/w) protein from one or more plant source; (ii) about 2% (w/w) to about 10% (w/w) lipid (e.g., oil and/or fat); and (iii) about 1% (w/w) to about 15% (w/w) flavoring and/or coloring agent or composition.

In some embodiments, step (a) includes: hydrating, and optionally mixing, the protein ingredient(s) (e.g., microorganism, plant, algae, fungus, and/or insect protein), or alternatively, protein may be used that is hydrated prior to the method or that does not require hydration; homogenizing with lipid(s) to form an emulsion; and adding and mixing flavorings, seasonings, and/or one or more texturizing agent (such as, but not limited to, gluten). For example, the hydrated composition may include about 5% to about 15% water and about 20% to about 60% total dry protein. Optionally, other ingredients may be included as described herein, such as, but not limited to, carbohydrates and/or fiber, and may be mixed with the protein prior to formation of an emulsion or may be added with the lipid(s) or after emulsion formation. The composition formed in step (a) may be a dough composition. Mixing may be accomplished, for example, in a device such as a flour mixer, such as a kitchen-type device used for kneading dough.

In some embodiments, the step (b) includes producing sheets that are about 0.1 mm to about 5 mm, or about 0.1 mm to about 4 mm, or about 0.1 mm to about 3 mm, or about 0.1 mm to about 2 mm, or any of about 0.1 mm to about 0.5 mm, about 0.1 mm to about 1 mm, 0.25 mm to about 0.75 mm, about 0.5 mm to about 1 mm, about 0.75 mm to about 1.25 mm, about 1 mm to about 1.5 mm, about 1.25, mm to about 1.75 mm, about 1.5 mm to about 2 mm, about 0.1 mm to about 1 mm, about 0.5 mm to about 1.5 mm, or about 1 mm to about 2 mm, or up to about 3 mm in thickness. Sheets may be produced by using equipment and/or processes such as, but not limited to, a dough sheeter, a pasta extruder, high moisture extrusion, heated rollers, or spray application.

In some embodiments, the protein-containing composition, e.g., dough, is passed through a series of nonstick, heated, and/or cooled rollers, thereby continuously reducing the thickness. In one embodiment, the composition becomes sequentially thinner and moves faster as it proceeds along the series of rollers.

In some embodiments, the protein-containing composition, e.g., dough, is about 10% to about 90% diluted with water, and rolled, sheeted, or sprayed onto hot rollers to a thickness of about 0.1 mm to about 3 mm.

In some embodiments, the protein-containing composition, e.g., dough, is placed into a mold, for example, filled mechanically (e.g., depositor) or manually into a molding machine, such as a die cutter used in the baking industry.

In some embodiments, the protein-containing composition, e.g., dough, is diluted with water and painted onto a silicone mat, and then heated, such as in a steam combination oven.

In some embodiments, between steps (a) and (b), the protein-containing composition is allowed to rest (e.g., for at least about 30 minutes, or about 30 minutes to about 120 minutes, or any of about or at least about 30 minutes, 35 minutes, 40 minutes, 45 minutes, 50 minutes, 55 minutes, 60 minutes, 65 minutes, 70 minutes, 75 minutes, 80 minutes, 90 minutes, 95 minutes, 100 minutes, 105 minutes, 110 minutes, 115 minutes, or 120 minutes). This allows the structure of the composition to settle and to become more workable and extendible for the subsequent sheeting step.

Optionally after step (a) and prior to step (b), the composition (e.g., dough composition) may be vacuum sealed, e.g., for at least about 60 minutes, to aid with hydration of the composition, e.g., hydration of dry components, such as, but not limited to, protein.

In some embodiments, heating the protein-containing sheets in step (c) may be at a temperature of about 80° C. to about 115° C., or any of about or at least about 80° C., 85° C., 90° C., 95° C., 100° C., 105° C., 110° C., or 115° C., for about 1 minute to about 90 minutes, or any of about or at least about 1 minute, 5 minutes, 10 minutes, 15 minutes, 20 minutes, 25 minutes, 30 minutes, 35 minutes, 40 minutes, 50 minutes, 55 minutes, 60 minutes, 65 minutes, 70 minutes, 75 minutes, 80 minutes, 85 minutes, or 90 minutes.

Heating may be, for example, in a water bath, high humidity steam environment, infrared oven, gas oven convection oven, or steam oven.

In some embodiments, sheets may be heated, e.g., about 105-125° C., in order to facilitate Maillard reactions and/or flavor development. The chemical reactions that occur during heating may result in meaty flavors, such as cooked chicken, fish, or beef, depending on the amino acid profile and reducing sugars in the composition.

In some embodiments, the layered sheets are sealed in packaging and heated, for example, steam or high moisture heated, at about 90° C. to about 110° C., or any of about or at least about 90° C., 95° C., 100° C., 105° C., or 110° C., for about 45 minutes to about 90 minutes, or any of about or at least about 45 minutes, 50 minutes, 55 minutes, 60 minutes, 65 minutes, 70 minutes, 75 minutes, 80 minutes, or 90 minutes. Alternatively, the layered sheets may be sealed in packaging and exposed to radiation energy, such as microwave radiation, for example, subjected to high moisture cooking. The thermal or radiation energy exposure of the layered sheets serves to bind or laminate the layers together. For example, a gelling or adhesive agent may be included, for example, added or sprinkled on the surfaces of layers (i.e., between adjacent layers), and during the thermal or radiation energy exposure, the gelling or adhesive agent binds or laminates the layers together upon such exposure. For example, the gelling or adhesive agent may include one or more plant protein isolate and/or concentrate, plant starch, transglutaminase, and gluten. In one embodiment, the gelling or adhesive agent is or includes gluten.

In some embodiments, a cooked sheet is passed through counter rotating rollers. For example, one of the rollers may contain serrated grooves suitable to separate the sheet into strands. The grooves may be adjustable or selected to result in a desired strand width, e.g., depending on the animal tissue which is being replicated. The protein-containing composition, e.g., dough, may be passed through a v-shaped roller, either with a serrated roller or a flexible roller at top allowing for width adjustment.

In some embodiments, the ingredients/components that are incorporated into the structured food product do not include animal derived products, i.e., the structured food product is vegan. In other embodiments, one or more animal derived ingredient or component is included. For example, animal-derived collagen may be included, for example, as a structuring agent, or animal-derived lipids (e.g., fat) or broth may be included, for example, as a flavoring agent. In some embodiments, the structured food product produced as described herein is incorporated into a meat or a cultured meat product.

### Shredded and/or Grounded

Structured food products as described herein are produced in a method that includes production of a protein-containing composition, subjected to the shredding, grinding, or combination thereof, to form unique structured food products. In some embodiments, the use of the shredded composition, the ground composition, or combination thereof, optionally combined with a dough composition results in unique structured food products that provide fibrous texture and/or appearance of meat analogue products.

In one aspect, a method for producing a structured food product is provided including: (a) producing a protein-containing composition; (b) heating the composition, e.g., to set the structure and/or to decolorize the protein-containing composition; and (c) shredding and/or grinding the composition, thereby forming a structured food product. In some embodiments of the aforementioned aspect, producing the protein-containing composition comprises producing a composition comprising protein from one or more microorganism, plant, fungal, and/or algal source. In some embodiments, the protein-containing composition further comprises one or more lipid; and optionally, one or more flavoring and/or coloring agent. In some embodiments of the aforementioned aspect, heating the composition produced in step (a) comprises, for example only, heating at a temperature of about 200° F. to about 400° F. for about 10 minutes to about 100 minutes. In some embodiments of the aforementioned aspect and embodiments, forming the structured food product comprises shredding and/or grinding the composition to form the structured food product directly or shredding and/or grinding the composition and incorporate it into the structured food product. In some embodiments of the aforementioned aspect and embodiments, the structured food product is further formed into a shape or configuration that resembles or imitates a meat product or other food products. In some embodiments, the structured food product is formed (e.g., molded) or cut into a desired shape or structure, such as a shape or configuration that resembles a meat product or other food products.

In some embodiments of the aforementioned aspect and embodiments, the composition is sealed in packaging, and then thermal and/or radiation energy (e.g., microwave) is applied to the sealed composition, e.g., a high moisture cooking process. In some embodiments, the structured food product is formed (e.g., molded) or cut into a desired shape or structure, sealed in packaging, and then subjected to thermal and/or radiation energy, e.g., high moisture or steam cooked in the packaging.

In some embodiments, the shredded and/or the ground protein-containing composition may be incorporated into another food product, such as, but not limited to a meat product or cultured meat product. In some embodiments, the shredded and/or the ground composition may be incorporated into a dough composition, and then assembled and pressed into a mold. The molded product may be heated (e.g., about 180° F. to about 230° F., about 20 minutes to about 60 minutes), and optionally cooled and frozen.

In one aspect, a method for producing a structured food product is provided including: (a) producing a protein-containing composition; (b) heating the composition, e.g., to set the structure and/or to decolorize the protein-containing composition; (c) shredding and/or grinding the composition, and (d) incorporating the shredded and/or the ground composition into a dough composition, thereby forming a structured food product. In some embodiments of the aforementioned aspect, the shredded and/or the ground composition provides texture to the dough composition to form the structured food product, e.g., meat analogue. In some embodiments of the aforementioned aspect and embodiments, the dough composition is same as the protein-containing composition except that the dough composition is not heated, shredded or grounded before step (d).

In some embodiments, step (c) includes shredding the composition produced in step (b), thereby producing a shredded composition, and using the shredded composition as is or converting to the structured food product or incorporating into another composition or product to produce the structured food product. In some embodiments, step (c) includes grinding the composition produced in step (b), thereby producing the ground composition, and using the ground composition as is or converting to the structured food product or incorporating into another composition or product to produce the structured food product. In some embodiments, step (c) includes shredding a portion of the composition produced in step (b), thereby producing the shredded composition, and grinding a portion of the composition produced in step (b), thereby producing the ground composition, and (d) mixing the shredded composition and the ground composition together and using as is or converting to the structured food product or incorporating into another composition or product to produce the structured food product.

In some embodiments, the mixture of the shredded composition and the ground composition may contain the shredded composition and the ground composition in any ratios. For example, any of at least about 5%, 10%, 15%, 20%, 25%, 30%, 35%, 40%, 45%, 50%, 55%, 60%, 65%, 70%, 75%, 80%, 85%, 90%, 95% by volume or weight shredded composition may be included, with the remainder of the protein-containing composition to a total of 100% in ground form, or any of at least about 5%, 10%, 15%, 20%, 25%, 30%, 35%, 40%, 45%, 50%, 55%, 60%, 65%, 70%, 75%, 80%, 85%, 90%, 95% by volume or weight ground composition may be included, with the remainder of the protein-containing composition to a total of 100% in shredded form.

In certain non-limiting embodiments, the structured food product produced in the methods described herein is a meat or meat analogue product, a flour, a gelling agent, a bakery product, or a dairy or dairy analogue product.

In certain embodiments of the methods, the ingredients/components of the composition and/or processing conditions result in a carbon neutral or carbon negative structured food product.

The protein-containing composition in step (a) and/or the dough composition may contain protein from one or more microorganisms, one or more plants, one or more fungi, one or more algae, and/or one or more insects. In some embodiments, the protein-containing composition contains a protein product (e.g., one or more of single cell protein, cell lysate, protein isolate, protein concentrate, protein hydrolysate, free amino acids, peptides, oligopeptides, or combination of any two or more thereof) from one or more microorganisms, such as, but not limited to a chemoautotrophic microorganism, such as a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof. In some embodiments, the protein product from one or more microorganisms is subjected to a process to lighten the color of the protein prior to or in conjunction with step (a).

The protein product or the microorganism protein product may be used alone or included in combination with the protein from any of one or more plant, fungus, algae, and/or insect. For example, the microorganism protein product may be included at any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the protein-containing composition of step (a), with the remainder of the protein supplied by one or more plant, fungus, algae, and/or insect protein, or 100% of the protein in the protein-containing composition of step (a) is microorganism protein product. Therefore, in some embodiments of the aspects provided herein the protein-containing composition is 80-100%, 85-100%, 90-100%, 95-100% or 99% by weight of the microorganism protein product.

In some embodiments, any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the protein-containing composition of step (a) is plant, fungus, algae, or insect derived protein, or a combination thereof, or 100% of the protein in the protein-containing composition of step (a) may be plant, fungus, algae, or insect derived protein, or a combination thereof. In other embodiments, any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the protein-containing composition of step (a) is plant derived protein, or 100% of the protein in the protein-containing composition of step (a) may be plant derived protein.

Nonlimiting examples of plant protein sources include rice, pea, mung bean, fava, potato, wheat, chickpea, soy, jackfruit, oats, quinoa, sorghum, foxtail millets, tofu, edamame, lentils (e.g., red lentils, green lentils), spirulina, chia seeds, nuts, and hemp seeds.

In some embodiments, protein (such as microorganism protein product) may be subjected to a process to lighten the color of the protein prior to step (a).

The protein-containing composition in step (a) may further contain one or more lipid (e.g., oil and/or fat), one or more flavoring and/or coloring agent or composition, one or more carbohydrate, and/or one or more fiber source (e.g., edible soluble or insoluble fiber). In certain embodiments, carbohydrates and/or fiber are in the form of a gum, e.g., xanthan gum, that is derived from a plant, a microorganism, and/or an alga. In certain embodiments, the lipid may be derived from the plant, the microorganism, and/or the algae. For example, the lipid may be derived from a microorganism, such as but not limited to, a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism. In some embodiments, the lipid may be derived from a plant source, such as, but not limited to sunflower oil, canola oil, coconut oil, palm oil, cocoa butter, and/or vegetable oil.

In certain embodiments, the protein-containing composition of step (a) contains: (i) about 20% (w/w) to about 50% (w/w) protein product from one or more microorganism and about 10% (w/w) to about 50% (w/w) protein from one or more plant source; (ii) about 2% (w/w) to about 10% (w/w) lipid (e.g., oil and/or fat); and optionally (iii) about 1% (w/w) to about 15% (w/w) flavoring and/or coloring agent or composition.

In some embodiments, the structured food product, such as a meat analogue product, is produced without wheat or an ingredient derived therefrom, without soy or an ingredient derived therefrom, or without wheat or soy or ingredients derived therefrom. In some embodiments, the structured food product is soy, wheat, and gluten free.

In some embodiments, the step (a) of producing the protein-containing composition includes: hydrating, and optionally mixing, the protein ingredient(s) (e.g., microorganism protein product or protein derived from one or more of plant, fungus, algae, and/or insect), or alternatively, protein may be used that is hydrated prior to the method or that does not require hydration; homogenizing with lipid(s) to form an emulsion; and adding and mixing flavorings, seasonings, and/or one or more texturizing agents (such as, but not limited to, gluten). Optionally, other ingredients may be included as described herein, such as, but not limited to, carbohydrates and/or fiber, and may be mixed with the protein prior to formation of an emulsion or may be added with the lipid(s) or after the emulsion formation. The composition formed in step (a) may be the dough composition as described herein.

Accordingly, in one aspect, there is provided a method for producing the structured food product comprising: (a) producing a protein-containing composition comprising microorganism protein product; (b) producing a dough composition comprising microorganism protein product; (c) hydrating and optionally heating the protein-containing composition, the dough composition, or combination thereof, e.g., to set the structure and/or to decolorize; (d) shredding and/or grinding the protein-containing composition; and (e) incorporating the shredded and/or the ground composition into the dough composition, thereby forming a structured food product. In some embodiments of the aforementioned aspect, the incorporating of the shredded and/or the ground composition into the dough composition results in texturization of the dough composition. In some embodiments of the aforementioned aspect and embodiments, the incorporating of the shredded and/or the ground composition into the dough composition results in texturization of the dough composition and provides an appearance and texture of meat. In some embodiments of the aforementioned aspect and embodiments, the structured food product is a meat analogue.

In some embodiments of the aspects related to the shredding and/or grinding the composition, as provided herein, the protein composition comprises microbial biomass; and/or the dough composition comprises microbial biomass, wherein the microbial biomass comprises oxyhydrogen microorganism cell mass and microorganism protein product, to form the structured food product. In some embodiments of the aspects related to the shredding and/or grinding the composition, as provided herein, the protein composition comprises microbial biomass and pea protein; and/or the dough composition comprises microbial biomass and pea protein, wherein the microbial biomass comprises oxyhydrogen microorganism cell mass and microorganism protein product, to form the structured food product.

In some embodiments of the aforementioned embodiments, the protein composition and/or the dough composition comprises between about 1-100% by weight of the microbial biomass comprising between about 0.5-25% by weight oxyhydrogen microorganism cell mass and between about 60%-99.5% or between about 75%-99.5% by weight microorganism protein product. In some embodiments of the aforementioned embodiments, the protein composition and/or the dough composition comprises between about 1-10% by weight of the microbial biomass comprising between about 0.5-25% by weight oxyhydrogen microorganism cell mass and between about 60%-99.5% or between about 75%-99.5% by weight microorganism protein product. In some embodiments of the aforementioned embodiment, the protein composition and/or the dough composition comprises between about 1-10% by weight of the microbial biomass comprising between about 0.5-25% by weight oxyhydrogen microorganism cell mass and between about 60%-99.5% or between about 75%-99.5% by weight microorganism protein product; and between about 20-60% by weight pea protein. In some embodiments of the aforementioned embodiment, the protein composition and/or the dough composition comprises between about 1-10% by weight of the microbial biomass comprising between about 0.5-25% by weight oxyhydrogen microorganism cell mass and between about 75%-99.5% by weight microorganism protein product; and between about 20-60% by weight mycoprotein. In some embodiments, the protein-containing composition contains the microorganism protein product (e.g., one or more of single cell protein, cell lysate, protein isolate, protein concentrate, protein hydrolysate, free amino acids, peptides, oligopeptides, or combination of any two or more thereof) from one or more microorganisms, such as, but not limited to a chemoautotrophic microorganism, such as oxyhydrogen microorganism, such as Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof.

In some embodiments, the structured food product is placed into a mold, for example, filled mechanically (e.g., depositor) or manually into a molding machine, such as a die cutter used in the baking industry.

In some embodiments, the step of the heating of the protein-containing composition, the dough composition, or combination thereof, is for example, in a water bath, high humidity steam environment, infrared oven, gas oven convection oven, or steam oven.

In some embodiments, the protein-containing composition the dough composition, and/or the shredded or grounded composition may be heated, e.g., about 105-125° C., in order to facilitate Maillard reactions and/or flavor development. The chemical reactions that occur during heating may result in meaty flavors, such as cooked chicken, fish, or beef, depending on the amino acid profile and reducing sugars in the composition.

In some embodiments, the shredded and/or ground material produced methods provided herein or a composition or structured food product that the shredded or ground material is converted to or incorporated into, may be sealed in packaging and heated, for example, steam or high moisture heated, at about 90° C. to about 110° C., or any of about or at least about 90° C., 95° C., 100° C., 105° C., or 110° C., for about 45 minutes to about 90 minutes, or any of about or at least about 45 minutes, 50 minutes, 55 minutes, 60 minutes, 65 minutes, 70 minutes, 75 minutes, 80 minutes, or 90 minutes. Alternatively, the shredded and/or ground material that is produced or the composition or the product that the shredded or ground material is converted to or incorporated into may be sealed in packaging and exposed to radiation energy, such as microwave radiation, for example, subjected to high moisture cooking.

In some embodiments, the ingredients/components that are incorporated into the structured food product do not include animal derived products, i.e., the structured food product is vegan. In some embodiments, one or more animal derived ingredient or component is included. For example, animal-derived collagen may be included, for example, as a structuring agent, or animal-derived lipids (e.g., fat) or broth may be included, for example, as a flavoring agent. In some embodiments, the structured food product produced as described herein is incorporated into a meat or a cultured meat product.

In some embodiments, the shredded and/or ground composition includes pieces with dimensions about 0.05 mm-about 100 mm in length, about 0.05 mm-about 100 mm in height, and about 0.05 mm-about 100 mm in thickness.

In some embodiments, the structured food product is a meat analogue product, such as, but not limited to, a beef, poultry, pork, fish, or seafood analogue product. In some embodiments, the structured food product is a flour, a gelling agent, a bakery product, or a dairy product.

In some embodiments, the protein-containing composition produced in step (a) includes: (i) about 20% (w/w) to about 50% (w/w) protein product from one or more microorganism and about 10% (w/w) to about 50% (w/w) protein from one or more plant source; (ii) about 2% (w/w) to about 10% (w/w) oil or fat; and (iii) about 1% (w/w) to about 15% (w/w) flavoring and/or coloring agent.

In some embodiments, the composition in step (a) further includes carbohydrates, and/or fiber. For example, the composition may include one or more gum that is derived from a plant, a microorganism, and/or an alga.

In some embodiments, the composition in step (a) includes protein from one or more plant source, which may include, but is not limited to, one or more of rice protein, pea protein, mung bean protein, fava protein, potato protein, wheat protein, chickpea protein, soy protein, jackfruit, oats, quinoa, sorghum, foxtail millets, tofu, edamame, red lentils, green lentils, spirulina, chia seeds, nuts, and hemp seeds.

In some embodiments, the composition in step (a) includes components such that the structured food product is carbon neutral or carbon negative.

In some embodiments, the structured food product further includes one or more animal-derived component. For example, the one or more animal-derived component may include, but is not limited to, collagen, a lipid, and/or a flavoring agent or composition.

In some embodiments, the structured food product further includes meat or cultured meat.

In some embodiments, the structured food product is incorporated into another food product.

In another aspect, a structured food product is provided, which is produced by any of the methods described herein. For example, the structured food product may be carbon neutral or carbon negative. In some embodiments, the structured food product is a vegan product. In some embodiments, the structured food product includes one or more animal-derived components and/or comprises cultured animal cells.

In one aspect, a method for producing a structured food composition is provided, comprising: culturing one or more microorganisms in the presence of a carbon source, thereby producing microbial biomass or microbial cell mass comprising protein; converting the microbial biomass into a microorganism protein product comprising single cell protein, cell lysate, protein isolate, protein concentrate, protein hydrolysate, free amino acids, peptides, oligopeptides, or combination of any two or more thereof; and processing the microorganism protein product into the structured food product, wherein processing the microorganism protein product into the structured food products includes any of the methods to form the structured food products as described herein. In some embodiments, the culturing includes chemoautotrophic culture conditions. For example, the carbon source may include a gaseous C1 molecule, such as, but not limited to, CO₂, CO, and/or CH₄.

In some embodiments of the aforementioned aspect and embodiments, the one or more microorganisms may include, but is not limited to, a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof. For example, in some embodiments, the one or more microorganisms may comprise or consist of a Cupriavidus microorganism, such as a Cupriavidus necator and/or Cupriavidus metallidurans microorganism. In certain embodiments, the one or more microorganisms may comprise or consist of Cupriavidus necator DSM 531 and/or DSM 541.

In some embodiments, the microorganism protein product includes one or more of single cell protein, cell lysate, protein isolate, protein concentrate, protein hydrolysate, free amino acids, peptides, oligopeptides, or combination of any two or more thereof.

### High Moisture extrusion

In some embodiments, the structured food products as described herein are produced in a method that includes extruding a protein composition in a high moisture extrusion process to form an extrudate composition and cutting, slicing, dicing, shredding, and/or shaving the extrudate composition, thereby forming unique structured food products.

In one aspect, there is provided a method for production of the structured food products comprising: (a) producing a protein-containing composition or a composition comprising protein from any of the sources provided herein; (b) extruding the protein-containing composition through an extruder in a high moisture extrusion process; and (c) cutting, slicing, shredding, shaving, dicing, grinding, mincing, and/or grating the resulting extrudate, thereby producing a structured food product.

In one aspect, a method for producing the structured food product is provided, comprising: (a) extruding a composition comprising (i) protein from one or more microorganism, plant, fungal, and/or algal source; (ii) one or more lipids; and optionally, (iii) one or more flavoring and/or coloring agent in a high moisture extrusion (HME) process, thereby producing an extrudate composition; (b) cutting, slicing, dicing, shredding, mincing, grating, and/or shaving the extrudate composition, thereby producing the structured food product. In some embodiments of the aforementioned aspect, the method further comprises treating the extrudate composition with an acidic or basic solution before the step (b), thereby stabilizing, texturizing, and/or decolorizing the extrudate composition. In some embodiments, the basic solution includes, but not limited to, potassium phosphate solution. In some embodiments, the acidic solution includes, but not limited to, an acetic acid solution. In some embodiments, the extrudate composition is in the form of a slab.

In some embodiments, extruding step (a) includes feeding a dry ingredient flour (e.g., protein and optionally other ingredients such as carbohydrates, lipid, fiber, etc.) into the extruder simultaneously with water and oil, and applying mechanical and thermal energy to the composition to produce a hydrated and thermoplastic fibrous protein composition and subjecting the hydrated and thermoplastic fibrous protein composition to the cutting, slicing, dicing, shredding, and/or shaving, thereby producing the structured food product.

In some embodiments, the high moisture extrusion involves about 3 to about 9 zones. For example, the temperature in 1-3 first zones (e.g., zones 1-3) may be about 25° C. to about 160° C., the temperature in 1-3 second zones (e.g., zones 4-6) may be about 140° C. to about 175° C., and the temperate in 1-3 third zones (e.g., zones 7-9) may be about 150° C. to about 175° C. The moisture content in the extrusion process may be, for example, about 50% to about 70%. The pressure in the high moisture extrusion process may be about 2 bar to about 20 bar.

In some embodiments, the extrudate is treated with an acidic (e.g., pH about 2 to about 5) or basic (e.g., pH about 7.5 to about 9) solution. The acid or base treatment may serve to stabilize, texturize, and/or decolorize the extrudate. In some embodiments, the acid or the base treatment of the extrudate is conducted for about 5 minutes to about 30 minutes, at a temperature of about 4° C. to about 30° C. The acidic solution used for acidic treatment may be, but is not limited to, vinegar (acetic acid), lemon juice, pickle juice, or an acidic flavoring agent. The basic solution used for basic treatment may be, but is not limited to, potassium phosphate, sodium carbonate, potassium carbonate, potassium hydroxide, calcium hydroxide, or sodium hydroxide. For example, treatment with sodium carbonate may produce a slippery exterior texture and bouncy bite, while treatment with potassium carbonate may produce a firmer texture and a harder bite.

In some embodiments of the aforementioned aspect and embodiments, the composition comprising protein from one or more microorganism, plant, fungal, and/or algal source, further includes one or more gelling agent, such as, but not limited to, curdlan, gellan gum, pectin, konjac, and/or agar.

In some embodiments, the extrudate composition is reduced in size to pieces with dimensions about 0.05 mm-about 100 mm in length, about 0.05 mm-about 100 mm in height, and about 0.05 mm-about 100 mm in thickness. In some embodiments, the extrudate composition is sliced into pieces resembling or approximating the dimensions of deli slices.

In some embodiments of the aforementioned aspect and embodiments, the method further comprising binding together pieces of the cut, sliced, diced, shredded, and/or shaved extrudate composition to produce the structured food product, such as, but not limited to, the meat analogue product. In some embodiments, the method further comprises incorporating the structured food product into other food products, such as, but not limited to, a soup, a stew, a casserole, a sauce, etc.

In some embodiments of the aforementioned aspect and embodiments, the method further comprises forming the structured food product into a shape or configuration that resembles or imitates a meat or other food product, thereby producing a formed structured food product. In certain embodiments, one or more binder(s) may be used to bind pieces of the structured food product together in the production of the formed structured food product. For example, binders may include, but are not limited to, gellan, carrageenan (kappa, iota, lambda), agar, konjac, gums, polysaccharides, and/or hydrocolloids, such as at about 0.1% (w/w) to about 5% (w/w).

In some embodiments, the structured food product may be sealed in packaging, and then thermal and/or radiation energy (e.g., microwave) may then be applied to the sealed composition.

In some embodiments of the aforementioned aspect and embodiments, the method further comprises applying thermal or radiation energy to the structured food product. For example, thermal energy may be applied at about 90° C. to about 110° C. for about 45 minutes to about 90 minutes. In some embodiments, the structured food product is sealed in packaging prior to applying thermal or radiation energy.

In some embodiments, the structured food product is a meat analogue product, such as, but not limited to, a beef, poultry, pork, fish, or seafood analogue product. In some embodiments, the meat analogue product is a wheat and soy free meat analogue product. In some embodiments, the meat analogue product includes pea protein and/or fiber and one or more oligosaccharide, such as short-chain fructooligosaccharides. In some embodiments, the structured food product is flour, gelling agent, bakery product, or dairy product.

In some embodiments, the step (b) includes slicing the extruded material, such as production of a material that resembles deli slices. In some embodiments, step (b) includes cutting or dicing the material to produce chunks of the extruded material. In some embodiments, the structured food product produced in step (b) may be flavored, seasoned, marinated, or covered with a sauce (e.g., barbecue sauce, sweet and sour sauce, tomato sauce, alfredo sauce, salsa, etc.) to produce a finished food product or a food ingredient to be incorporated into another food product.

In some embodiments, the structured food product may be formed (e.g., molded) into a desired shape or structure, either prior or after application of thermal and/or radiation energy, for example, with inclusion of a binder composition. In one embodiment, the structured food product is formed (e.g., molded) or cut into a desired shape or structure, optionally sealed in packaging, and optionally then subjected to thermal and/or radiation energy, e.g., high moisture or steam cooked in the packaging. In some embodiments, formed structured food product is sealed in packaging and heated, for example, steam or high moisture heated, at about 90° C. to about 110° C., or any of about or at least about 90° C., 95° C., 100° C., 105° C., or 110° C., for about 45 minutes to about 90 minutes, or any of about or at least about 45 minutes, 50 minutes, 55 minutes, 60 minutes, 65 minutes, 70 minutes, 75 minutes, 80 minutes, or 90 minutes. Alternatively, the formed structured food product may be sealed in packaging and exposed to radiation energy, such as microwave radiation, for example, subjected to high moisture cooking.

In some embodiments of the aforementioned aspect and embodiments, the method further comprises producing the composition that is used in the extruding step. In some embodiments, the composition comprises about 10% (w/w) to about 70% (w/w) protein from one or more microorganisms and about 10% (w/w) to about 60% (w/w) protein from one or more plant sources. In some embodiments, the composition further comprises about 2% (w/w) to about 10% (w/w) oil or fat; and optionally about 1% (w/w) to about 15% (w/w) flavoring and/or coloring agent. In some embodiments, the composition further includes carbohydrate, starch, edible fiber, and/or gelling agent. For example, the composition may include one or more gum that is derived from a plant, a microorganism, and/or an algae.

The composition comprising protein from one or more microorganisms may be used alone or included in combination with the protein from any of one or more plant, fungus, algae, and/or insect. For example, the microorganism protein may be included at any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the composition of step (a), with the remainder of the protein supplied by one or more plant, fungus, algae, and/or insect protein, or 100% of the protein in the composition of step (a) is the protein from one or more microorganisms or the microorganism protein product. Therefore, in some embodiments of the aspects provided herein the composition is 80-100%, 85-100%, 90-100%, 95-100% or 99% by weight of the protein from one or more microorganisms.

In some embodiments, any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the composition of step (a) is plant, algae, fungus, or insect derived protein, or a combination thereof, or 100% of the protein in the composition of step (a) may be plant, algae, fungus, or insect derived protein, or a combination thereof. In other embodiments, any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the composition of step (a) is plant derived protein, or 100% of the protein in the composition of step (a) may be plant derived protein. Nonlimiting examples of plant protein sources include rice, pea, mung bean, fava, potato, wheat, chickpea, soy, jackfruit, oats, quinoa, sorghum, foxtail millets, tofu, edamame, lentils (e.g., red lentils, green lentils), spirulina, chia seeds, nuts, and hemp seeds.

In some embodiments, the composition in step (a) comprises protein from one or more microorganisms, wherein the protein comprises single cell protein, cell lysate, protein isolate, protein concentrate, protein hydrolysate, free amino acids, peptides, oligopeptides, or combination of any two or more thereof (may also be called microorganism protein product). In some embodiments, the one or more microorganisms may include, but is not limited to, Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a combination or consortium of two or more thereof.

In some embodiments of the high moisture extrusion process, the protein composition comprises between about 1-100% by weight of the microbial biomass comprising between about 0.5-25% by weight oxyhydrogen microorganism cell mass and between about 60%-99.5% or between about 75%-99.5% by weight microorganism protein product. In some embodiments of the aforementioned embodiments, the protein composition comprises between about 1-10% by weight of the microbial biomass comprising between about 0.5-25% by weight oxyhydrogen microorganism cell mass and between about 60%-99.5% or between about 75%-99.5% by weight microorganism protein product. In some embodiments of the aforementioned embodiment, the protein composition comprises between about 1-10% by weight of the microbial biomass comprising between about 0.5-25% by weight oxyhydrogen microorganism cell mass and between about 60%-99.5% or between about 75%-99.5% by weight microorganism protein product; and between about 20-60% by weight pea protein. In some embodiments of the aforementioned embodiment, the protein composition comprises between about 1-10% by weight of the microbial biomass comprising between about 0.5-25% by weight oxyhydrogen microorganism cell mass and between about 75%-99.5% by weight microorganism protein product; and between about 20-60% by weight mycoprotein. In some embodiments, the protein-containing composition contains the microorganism protein product (e.g., one or more of single cell protein, cell lysate, protein isolate, protein concentrate, protein hydrolysate, free amino acids, peptides, oligopeptides, or combination of any two or more thereof) from one or more microorganisms, such as, but not limited to a chemoautotrophic microorganism, such as oxyhydrogen microorganism, such as Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof.

In some embodiments, the protein from one or more microorganisms, plant, fungal, and/or algal source is subjected to a process to lighten the color of the protein prior to or in conjunction with step (a).

In some embodiments, the composition in step (a) includes protein from one or more plant source, which may include, but is not limited to, one or more of rice protein, pea protein, mung bean protein, fava protein, potato protein, wheat protein, chickpea protein, soy protein, jackfruit, oat, quinoa, sorghum, foxtail millets, tofu, edamame, red lentil, green lentil, spirulina, chia seed, nut, and hemp seed.

Optionally, the protein-containing composition in step (a) contains one or more salt(s), such as, but not limited to, NaCl, KCl, and/or monosodium glutamate (MSG).

The composition in step (a) may further contain one or more lipids (e.g., oil and/or fat), one or more flavoring and/or coloring agent or composition, one or more carbohydrate, and/or one or more fiber source (e.g., edible soluble or insoluble fiber). In certain embodiments, carbohydrates and/or fiber are in the form of a gum, e.g., xanthan gum, that is derived from a plant, a microorganism, and/or an algae. In some embodiments, the one or more lipids in step (a) is derived from a plant, a microorganism, and/or an algae. In some embodiments, the lipid includes a lipid that is derived from one or more microorganism, such as, but not limited to, a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism. In some embodiments, the one or more lipids include a lipid that is derived from a plant, such as, but not limited to, sunflower oil, canola oil, coconut oil, palm oil, cocoa butter, and/or vegetable oil.

In some embodiments, the composition in step (a) includes components such that the structured food product is carbon neutral or carbon negative.

In some embodiments, the structured food product further includes one or more animal-derived components. For example, the one or more animal-derived components may include, but is not limited to, collagen, lipid, and/or flavoring agent or composition.

In some embodiments, the structured food product further includes meat or cultured meat.

In some embodiments, the structured food product is incorporated into another food product. In some embodiments, the structured food product is produced without wheat, or an ingredient derived therefrom, without soy or an ingredient derived therefrom, or without wheat or soy or ingredients derived therefrom. In some embodiments, the structured food product is produced with a protein source that includes pea protein or with a protein source that consists of pea protein. In some embodiments, the structured food product includes pea protein and/or fiber, and includes an oligosaccharide, such as fructooligosaccharide (e.g., short-chain fructooligosaccharide).

In another aspect, a structured food product is provided, which is produced by any of the methods described herein. For example, the structured food product may be carbon neutral or carbon negative. In some embodiments, the structured food product is a vegan product. In some embodiments, the structured food product includes one or more animal-derived components and/or comprises cultured animal cells. In some embodiments, the structured food product is a meat analogue product that does not include wheat or soy, or ingredients derived therefrom. In certain embodiments, the meat analogue product includes pea protein and/or fiber, and one or more oligosaccharides, such as, but not limited to, a fructooligosaccharide (e.g., a short-chain fructooligosaccharide).

In one aspect, a method for producing a structured food composition or the composition used in step (a) is provided, which includes: (a) culturing one or more microorganisms in the presence of a carbon source, thereby producing microbial biomass or the microbial cell mass that includes protein; (b) converting the microbial biomass into a microorganism protein product (e.g., single cell protein, cell lysate, protein isolate, protein concentrate, protein hydrolysate, free amino acids, peptides, oligopeptides, or combination of any two or more thereof); and (c) processing the microorganism protein product into a structured food composition or the composition of step (a), wherein processing the microorganism protein product into the structured food composition or the composition of step (a) includes any of the methods described herein. In some embodiments, step (a) includes chemoautotrophic culture conditions. For example, the carbon source may include a gaseous C1 molecule, such as, but not limited to, CO₂, CO, and/or CH₄.

In some embodiments, the one or more microorganisms may include, but is not limited to, a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof. For example, in some embodiments, the one or more microorganisms may comprise or consist of a Cupriavidus microorganism, such as a Cupriavidus necator and/or Cupriavidus metallidurans microorganism. In certain embodiments, the one or more microorganisms may comprise or consist of Cupriavidus necator DSM 531 and/or DSM 541.

In some embodiments, the microorganism protein product includes one or more of single cell protein, cell lysate, protein isolate, protein concentrate, protein hydrolysate, free amino acids, peptides, oligopeptides, or combination of any two or more thereof.

The structured food products as described herein are produced in the method that includes high moisture extrusion of the protein composition or the protein-containing composition, followed by reduction of the resulting extrudate into smaller pieces, such as by cutting, slicing, dicing, shredding, shaving, etc. Dimensions of the smaller pieces of extrudate may be, but are not limited to, about 0.05 mm to about 100 mm in length, about 0.05 mm to about 100 mm in width, and about 0.05 mm to about 100 mm in width. The extrudate may be produced as a slab of material, which is then cut, sliced, diced, shredded, shaved, etc. to achieve pieces of desired dimensions, texture, and/or appearance. Extrusion may be performed, for example, in a single or twin-screw extruder, optionally in combination with a cooling die.

Thermochemical processing, e.g., extrusion, may be deployed as a method to structure the protein in the composition of step (a) or the protein-containing composition (e.g., dough composition) as described herein. For example, extrusion may include: (i) optionally, preconditioning of the material outside the extruder (e.g., adding moisture and heat to the protein (such as a protein flour), and optionally other dry ingredients, prior to extrusion; (ii) mixing/cooking inside the extruder barrel; and (iii) optionally, cooling in a cooling die. Physical factors affecting structure formation by extrusion include, for example, temperature, screw speed, and extruder design. Factors imparting structure and food functionality include water absorption, water solubility, oil absorption index, expansion index, bulk density and viscosity of the dough. In some embodiments, extrusion of the composition of step (a) or the dough composition as described herein produces aligned fibers, i.e., protein fiber networks and/or aligned protein fibers that produce a structured food product such as a product with a meat-like texture. For example, the composition of step (a) or the dough composition is processed in a temperature-controlled extruder designed to place mechanical shear in a cone-in-cone geometry on the isotropically mixed dough composition to form a macroscopic, anisotropic mixture with substantially aligned fibrous structure. Nonlimiting examples of this are described, for example, in U.S. Pat. No. 9,526,267, which is incorporated by reference herein in its entirety.

In some embodiments, the high moisture extrusion results in denaturation of proteins and the formation of cross-links, which reduces the solubility of extruded material or the extrudate. In some embodiments, the conditions of extrusion may cause a rupturing of previously denatured protein molecules into subunits. The subunits may subsequently reaggregate into a product exhibiting the characteristic texture and microstructure of texturized protein. This reaggregation may be produced by intermolecular peptide bonds, hydrophobic interactions, and/or hydrogen and disulfide bonds.

In some embodiments, the high moisture extrusion to produce the structured food product as described herein includes moisture content of about 40% to about 80% (e.g., about 50% to about 70%) in the extruder. The extrudate may be cooled via a cooling die. The extrudate may be pumped from the extruder into the die, for example, but not limited to, via a gear pump which is located between the extruder and the die. The extrudate may include a fiber matrix which is produced by extrusion. The fibers may be proteinaceous fibers, such as fibers having greater than about 50% (e.g., greater than about 80%, or greater than about 90% by weight) protein content. For example, extrusion may result in shear-alignment of protein fibrils during extrusion of a protein-containing composition (e.g., dough composition) as described herein. The protein fibrils may include bundles of extended peptide chains, for example, linked by disulfide bonds.

In some embodiments, after forming the structured food product into a desired shape or structure, the formed structured food product may be sprayed with or dipped into a composition, such as a composition that includes protein, colors, flavors, flavor precursors, and/or sugars. For example, the formed structured food product may be a meat analogue product that is sprayed or dipped into the composition to form an outer layer that simulates skin, e.g., poultry skin, such as a chicken analogue with an outer chicken skin analogue.

The protein-containing composition or the composition comprising protein in step (a) may contain about 10% to about 60% microorganism (e.g., bacterial) protein and/or about 10% to about 70% plant protein. The extrudate may contain about 20% to about 40% protein.

In some embodiments, a dry ingredient flour (e.g., protein and other dry ingredients, such as, but not limited to, carbohydrates, fiber, and/or seasoning, coloring, and/or flavoring agents) is fed into the inlet of the extruder (e.g., single or twin-screw extruder) with water and oil simultaneously. In other embodiments, the dry ingredients and mixed with water and lipids and then fed into the extruder. Mechanical and thermal energy are applied via extrusion to produce hydrated and thermoplastic protein with fibrous structure.

In certain embodiments, the composition of step (a) contains: (i) about 10% (w/w) to about 70% (w/w) protein product from one or more microorganism and about 10% (w/w) to about 60% (w/w) protein from one or more plant source; (ii) about 2% (w/w) to about 10% (w/w) lipid (e.g., oil and/or fat); and (iii) about 1% (w/w) to about 15% (w/w) flavoring and/or coloring agent or composition. Optionally, other ingredients may be included as described herein, such as, but not limited to, carbohydrates and/or fiber, and may be mixed with the protein prior to extrusion. Mixing may be accomplished, for example, in a device such as a flour mixer, such as a kitchen-type device used for kneading dough. The composition in step (a) may be a dough composition.

In some embodiments, the ingredients/components that are incorporated into the structured food product do not include animal derived products, i.e., the structured food product is vegan. In other embodiments, one or more animal derived ingredient or component is included. For example, animal-derived collagen may be included, for example, as a structuring agent, or animal-derived lipids (e.g., fat) or broth may be included, for example, as a flavoring agent. In some embodiments, the structured food product produced as described herein is incorporated into a meat or a cultured meat product.

### Cold Extrusion Process

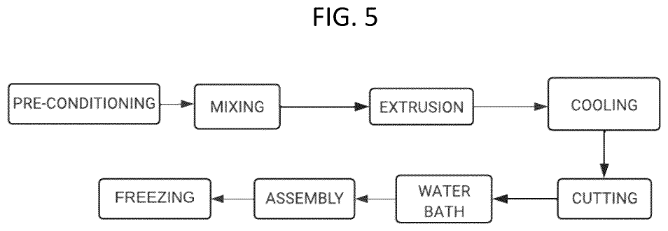

In some embodiments, the structured food products as described herein are produced in a method that includes extruding a protein composition in a cold extrusion process to form an extrudate composition and cutting, slicing, dicing, shredding, and/or shaving the extrudate composition, thereby forming unique structured food products. Structured food products as described herein are produced in a method that includes cold extrusion of a protein-containing composition, into long thin strands of extrudate material, which may be bundled, adhered, and then cut into desired dimensions for production of a food product, such as, but not limited to a meat analogue. In certain embodiments, the bundled extrudate strands are cut into disc-like structures, which may resemble a shellfish, such as a scallop. Extrusion may be performed, for example, in a device for production of pasta or noodles. The strands of extrudate may include a diameter or width of about 0.5 mm to about 5 mm, or 0.5 mm to about 4 mm, or 0.5 mm to about 3 mm, or 0.5 mm to about 2 mm, or 0.5 mm to about 1 mm. FIG. 5 illustrates a schematic diagram of some embodiments of the cold extrusion process for production of the structured food product as described herein.

In one aspect, a method for producing a structured food product is provided, which includes: (a) extruding a composition that includes: (i) protein from one or more microorganism, one or more plant, one or more fungus (e.g., mycoprotein), one or more insect, and/or one or more algal source; optionally (ii) one or more lipids; and optionally, (iii) one or more flavoring and/or coloring agent, in a cold extrusion process, thereby producing an extrudate composition, e.g., in the form of thin strands; and (b) optionally, treating the composition, prior to or after step (a), with an acidic or basic solution (e.g., a buffer solution), thereby texturizing and/or decolorizing the composition, and forming the structured food product. For example, the extrudate strands may include a diameter or width of about 0.5 mm to about 2 mm. In some embodiments of the aforementioned aspect, the composition comprises protein from one or more microorganisms and pea protein. In some embodiments, the composition comprises microbial biomass comprising oxyhydrogen microorganism cell mass and protein from the microorganism or the microorganism protein product. In some embodiments, the composition comprises microbial biomass comprising oxyhydrogen microorganism cell mass and protein from the microorganism; and pea protein. In some embodiments, the protein from the microorganism (or the microorganism protein product herein) comprises single cell protein, cell lysate, protein isolate, protein concentrate, protein hydrolysate, free amino acids, peptides, oligopeptides, or combination of any two or more thereof. In some embodiments, the microbial biomass comprising oxyhydrogen microorganism cell mass and protein from the microorganism comprises between about 0.5-25% by weight oxyhydrogen microorganism cell mass and between about 75%-99.5% by weight protein from the microorganism or the microorganism protein product. In some embodiments, the composition comprises between about 1-100% by weight; or between about 1-90% by weight; or between about 1-80% by weight; or between about 1-70% by weight; or between about 1-50% by weight of the microbial biomass comprising oxyhydrogen microorganism cell mass and protein from the microorganism. In some embodiments, the composition comprises between about 1-10% by weight; or between about 1-8% by weight; or between about 1-6% by weight; or between about 1-4% by weight; or between about 1-2% by weight of the microbial biomass comprising oxyhydrogen microorganism cell mass and protein from the microorganism; and between about 20-60%; or between about 20-50%; or between about 20-40%; or between about 20-30%, by weight pea protein. In some embodiments, the composition comprises between about 1-10% by weight of the microbial biomass comprising between about 0.5-25% by weight oxyhydrogen microorganism cell mass and between about 75%-99.5% by weight protein from the microorganism; and between about 20-60% by weight pea protein. In some embodiments, the remaining ingredients in the composition include, but not limited to, lipid, oil, fiber, carbohydrate, or combination of any two or more thereof.

In some embodiments, extrusion of a protein-containing composition or the composition of step (a) in the methods, as described herein produces aligned fibers, i.e., protein fiber networks and/or aligned protein fibers that produce a structured food product such as a product with a meat-like (e.g., seafood-like) texture. The extrudate may include a fiber matrix which is produced by extrusion. The fibers may be proteinaceous fibers, such as fibers having greater than about 50% (e.g., greater than about 60%, 70%, 80%, or 90% by weight) protein content. For example, extrusion may result in shear-alignment of protein fibrils during extrusion of a protein-containing composition (e.g., dough composition) as described herein. The protein fibrils may include bundles of extended peptide chains, for example, linked by disulfide bonds.

The protein from the microorganism or the microorganism protein product may be included in combination with any of one or more plant, algae, fungus, and/or insect protein. For example, the microorganism protein product may be included at any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the protein-containing composition or the composition to form the structured food product, with the remainder of the protein supplied by one or more plant, algae, fungus, and/or insect protein, or 100% of the protein in the composition may be microorganism protein product. In other embodiments, any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the protein-containing composition is plant, algae, fungus, or insect derived protein, or a combination thereof, or 100% of the protein in the composition may be plant, algae, fungus, or insect derived protein, or a combination thereof. In other embodiments, any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the protein-containing composition is plant derived protein, or 100% of the protein in the composition may be plant derived protein. Nonlimiting examples of plant protein sources include rice, pea, mung bean, fava, potato, wheat, chickpea, soy, jackfruit, oats, quinoa, sorghum, foxtail millets, tofu, edamame, lentils (e.g., red lentils, green lentils), spirulina, chia seeds, nuts, and hemp seeds.

In some embodiments, the cold extrusion process includes extrusion at a temperature of about 10° C. to about 85° C.; or about 10° C. to about 75° C.; about 10° C. to about 65° C.; about 10° C. to about 55° C.; about 10° C. to about 45° C.; about 10° C. to about 35° C., at atmospheric pressure, in an extruder with a die opening diameter of about 0.5 mm to about 2 mm.

In some embodiments, the composition in step (a) further includes one or more gelling agent and/or hydrocolloid, such as, but not limited to, curdlan, konjac, alginate, agar, carrageenan, gellan gum, pectin, xanthan gum, sodium alginate, and/or pea starch.

In some embodiments, the extrudate is treated with an acidic (e.g., pH about 2 to about 5) or basic (e.g., pH about 7.5 to about 9) solution, after addition of food ingredients to the mechanical elongation process, after mechanical elongation, or prior to or after extrusion. The acid or base treatment may serve to stabilize, texturize, and/or decolorize the protein-containing composition, e.g., extrudate. In some embodiments, the acid or the base treatment of the composition is conducted for about 5 minutes to about 30 minutes, at a temperature of about 4° C. to about 30° C. The acidic solution used for acidic treatment may be, but is not limited to, vinegar (acetic acid), lemon juice, pickle juice, or an acidic flavoring agent. The basic solution used for basic treatment may be, but is not limited to, calcium hydroxide, potassium phosphate, sodium carbonate, potassium carbonate, potassium hydroxide, or sodium hydroxide. For example, treatment with sodium carbonate may produce a slippery exterior texture and bouncy bite, while treatment with potassium carbonate may produce a firmer texture and a harder bite.

In some embodiments, step (b) includes treating the extrudate composition with a basic solution, such as, but not limited to, a potassium phosphate or calcium hydroxide solution. In some embodiments, dicationic solutions such as calcium chloride or a basic solution such as baking soda (i.e., sodium bicarbonate) is used.

In some embodiments, step (b) includes treating the extrudate composition with an acidic solution, such as, but not limited to, an acetic acid solution.

In some embodiments, the composition produced in step (a) is rested for at least about 30 minutes, for example, prior to step (b) or prior to additional processing steps, for example, to allow interactions between proteins and hydrocolloids.

In some embodiments, the structured food product produced in the aforementioned aspect, further comprising shaping the structured food product into a shape or configuration that resembles a meat or other food product, thereby producing a formed structured food product. In certain embodiments, one or more binder(s) may be used to bind pieces of the structured food product together in the production of the formed structured food product.

In some embodiments, the method further includes: (c) bundling the extrudate strands together, for example, along the lengths of the strands, vacuum sealing, and refrigerating (e.g., about 2° C. to about 4° C.), thereby adhering the strands together, for example, along the lengths of the strands, and producing a log shaped extrudate bundle. The method may further include: (d) cutting the extrudate bundle produced in (c) (for example, orthogonally to the lengths of the extrudate strands or the log shaped extrudate bundle) to produce slices or discs of structured food product.

In some embodiments, the structured food product is a meat or a meat analogue product, such as, but not limited to, a beef, poultry, pork, fish, or seafood analogue product. For example, the meat analogue product may be a shellfish analogue, such as a scallop analogue.

In one aspect, there is provided a method to form a seafood analogue product, comprising: (a) extruding a composition comprising protein from one or more microorganism, plant, fungus, algal source, or combination of any two or more thereof, in a cold extrusion process to produce an extrudate composition in form of thin strands; (b) bundling the extrudate strands together along lengths of the strands to produce a log shaped extrudate bundle; and (c) cutting the log shaped extrudate bundle to produce slice or disc to form the seafood analogue product. In some embodiments of the aforementioned aspect, the seafood analogue product is shellfish analogue. In some embodiments of the aforementioned aspect and embodiments, the seafood analogue product is scallop analogue. In some embodiments of the aforementioned aspect and embodiments, the bundling step comprises vacuum sealing, and refrigerating (e.g., about 2° C. to about 4° C.), thereby adhering the strands together, for example, along the lengths of the strands. In some embodiments of the aforementioned aspect and embodiments, the method further comprises treating the composition, prior to or after step (a), with an acidic or basic solution (e.g., a buffer solution), thereby texturizing and/or decolorizing the composition. Examples of basis include, but not limited to, potassium phosphate, calcium hydroxide, dicationic solutions such as calcium chloride or a basic solution such as baking soda (i.e., sodium bicarbonate). Examples of acid include, but not limited to, acetic acid. In some embodiments of the aforementioned aspect and embodiments, the composition further comprises one or more lipids, one or more flavoring and/or coloring agent, or combination thereof.

In some embodiments of the aforementioned aspect and embodiments to form the seafood analogue product, the composition comprises protein from one or more microorganisms and pea protein. In some embodiments of the aforementioned aspect and embodiments to form the seafood analogue product, the composition comprises protein from one or more microorganisms and mycoprotein. In some embodiments of the aforementioned aspect and embodiments to form the seafood analogue product, the composition comprises microbial biomass comprising oxyhydrogen microorganism cell mass and protein from the microorganism. In some embodiments of the aforementioned aspect and embodiments to form the seafood analogue product, the composition comprises microbial biomass comprising oxyhydrogen microorganism cell mass and protein from the microorganism; and pea protein. In some embodiments of the aforementioned aspect and embodiments to form the seafood analogue product, the protein from the microorganism (or the microorganism protein product herein) comprises single cell protein, cell lysate, protein isolate, protein concentrate, protein hydrolysate, free amino acids, peptides, oligopeptides, or combination of any two or more thereof. In some embodiments of the aforementioned aspect and embodiments to form the seafood analogue product, the microbial biomass comprising oxyhydrogen microorganism cell mass and protein from the microorganism comprises between about 0.5-25% by weight oxyhydrogen microorganism cell mass and between about 75%-99.5% by weight protein from the microorganism or the microorganism protein product.

In some embodiments of the aforementioned aspect and embodiments to form the seafood analogue product, the composition comprises between about 1-10% by weight; or between about 1-8% by weight; or between about 1-6% by weight; or between about 1-4% by weight; or between about 1-2% by weight of the microbial biomass comprising oxyhydrogen microorganism cell mass and protein from the microorganism; and between about 20-60%; or between about 20-50%; or between about 20-40%; or between about 20-30%, by weight pea protein. In some embodiments of the aforementioned aspect and embodiments to form the seafood analogue product, the composition comprises between about 1-10% by weight; or between about 1-8% by weight; or between about 1-6% by weight; or between about 1-4% by weight; or between about 1-2% by weight of the microbial biomass comprising oxyhydrogen microorganism cell mass and protein from the microorganism; and between about 20-60%; or between about 20-50%; or between about 20-40%; or between about 20-30%, by weight mycoprotein.

In some embodiments of the aforementioned aspect and embodiments to form the seafood analogue product, the composition comprises between about 1-10% by weight of the microbial biomass comprising between about 0.5-25% by weight oxyhydrogen microorganism cell mass and between about 75%-99.5% by weight protein from the microorganism; and between about 20-60% by weight pea protein.

In some embodiments of the aforementioned aspect and embodiments to form the seafood analogue product, the composition comprises between about 1-10% by weight of the microbial biomass comprising between about 0.5-25% by weight oxyhydrogen microorganism cell mass and between about 75%-99.5% by weight protein from the microorganism; and between about 20-60% by weight mycoprotein.

In some embodiments, the remaining ingredients in the composition include, but not limited to, lipid, oil, fiber, carbohydrate, or combination of any two or more thereof.

In one aspect, there is provided a seafood analogue product, such as, e.g., scallop, comprising: a disc shaped structured food product, comprising a bundle of vertical strands of protein composition comprising microbial biomass, and an adhesive composition comprising protein, gluten, or combination thereof, wherein the vertical strands are adhered together by the adhesive composition to form the disc shape of the seafood analogue product, such as, e.g., scallop. In one aspect, there is provided a seafood analogue product, such as, e.g., scallop, comprising: a disc shaped structured food product, comprising a bundle of vertical strands of protein composition comprising microbial biomass, and an adhesive composition comprising the protein composition comprising microbial biomass, wherein the vertical strands are adhered together by the adhesive composition to form the disc shape of the seafood analogue product, such as, e.g., scallop. In some embodiments of the aforementioned aspects, the microbial biomass comprises oxyhydrogen microorganism cell mass and microorganism protein product. In some embodiments of the aforementioned aspects and embodiments, the protein composition comprises microbial biomass comprising oxyhydrogen microorganism cell mass and microorganism protein product; and pea protein. In some embodiments of the aforementioned aspects and embodiments, microorganism protein product comprises single cell protein, cell lysate, protein isolate, protein concentrate, protein hydrolysate, free amino acids, peptides, oligopeptides, or combination of any two or more thereof. In some embodiments of the aforementioned aspect and embodiments, the microbial biomass comprising oxyhydrogen microorganism cell mass and microorganism protein product comprises between about 0.5-25% by weight oxyhydrogen microorganism cell mass and between about 75%-99.5% by weight microorganism protein product. In some embodiments of the aforementioned aspects and embodiments, the protein composition comprises between about 1-10% by weight; or between about 1-8% by weight; or between about 1-6% by weight; or between about 1-4% by weight; or between about 1-2% by weight of the microbial biomass comprising oxyhydrogen microorganism cell mass and microorganism protein product; and between about 20-60%; or between about 20-50%; or between about 20-40%; or between about 20-30%, by weight pea protein. In some embodiments of the aforementioned aspect and embodiments, the composition comprises between about 1-10% by weight; or between about 1-8% by weight; or between about 1-6% by weight; or between about 1-4% by weight; or between about 1-2% by weight of the microbial biomass comprising oxyhydrogen microorganism cell mass and microorganism protein product; and between about 20-60%; or between about 20-50%; or between about 20-40%; or between about 20-30%, by weight mycoprotein.

In some embodiments of the aforementioned aspect and embodiments related to the seafood analogue product, the composition comprises between about 1-10% by weight of the microbial biomass comprising between about 0.5-25% by weight oxyhydrogen microorganism cell mass and between about 75%-99.5% by weight microorganism protein product; and between about 20-60% by weight pea protein. In some embodiments of the aforementioned aspect and embodiments, the composition comprises between about 1-10% by weight of the microbial biomass comprising between about 0.5-25% by weight oxyhydrogen microorganism cell mass and between about 75%-99.5% by weight microorganism protein product; and between about 20-60% by weight mycoprotein.

In some embodiments of the aspects described herein, the one or more microorganisms (that form the microbial biomass comprising oxyhydrogen microorganism cell mass and microorganism protein product) may include, but is not limited to, a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof. For example, in some embodiments, the one or more microorganisms may comprise or consist of a Cupriavidus microorganism, such as a Cupriavidus necator and/or Cupriavidus metallidurans microorganism. In certain embodiments, the one or more microorganisms may comprise or consist of Cupriavidus necator DSM 531 and/or DSM 541.

In some embodiments, the remaining ingredients in the composition include, but not limited to, lipid, oil, fiber, carbohydrate, or combination of any two or more thereof.

In some embodiments, the structured food product (e.g., meat analogue product, such as seafood analogue product, e.g., scallop) is wheat and/or soy free, or free of ingredients derived from wheat and/or soy. In some embodiments, the structured food product (e.g., meat analogue product, such as seafood analogue product, e.g., scallop) is wheat, soy, and gluten free. In some embodiments, the structured food product is produced without gluten. In some embodiments, the structured food product is produced with a protein source that includes pea protein or with a protein source that consists of pea protein. In some embodiments, the structured food product includes pea protein and/or fiber. In some embodiments, the structured food product is produced with a protein source that comprises protein from the microorganism and mycoprotein.

In some embodiments, the structured food product is a flour, a gelling agent, a bakery product, or a dairy product.

In some embodiments of the aforementioned aspects, the composition in step (a) includes: about 10% (w/w) to about 90% (w/w) protein from one or more microorganism. In some embodiments of the aforementioned aspects, the composition in step (a) further includes about 10% (w/w) to about 60% (w/w) protein from one or more plant source; about 2% (w/w) to about 10% (w/w) oil or fat; about 1% (w/w) to about 15% (w/w) flavoring and/or coloring agent; or combination of any two or more thereof.

In some embodiments of the aforementioned aspects, the composition in step (a) further includes carbohydrates, starch, edible fiber, and/or gelling agent. For example, the composition may include one or more gum that is derived from a plant, a microorganism, and/or an algae.

In some embodiments of the aforementioned aspects, the composition in step (a) includes protein from one or more microorganism, which may include one or more of single cell protein, cell lysate, protein isolate, protein concentrate, protein hydrolysate, free amino acids, peptides, oligopeptides, or combination of any two or more thereof. In some embodiments, the one or more microorganism may include, but is not limited to, Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a combination or consortium of two or more thereof.

In some embodiments, the protein from one or more microorganism, plant, and/or algal source is subjected to a process to lighten the color of the protein prior to or in conjunction with step (a).

In some embodiments of the aforementioned aspects, the composition in step (a) includes protein from one or more plant source, which may include, but is not limited to, one or more of rice protein, pea protein, mung bean protein, fava protein, potato protein, wheat protein, chickpea protein, soy protein, jackfruit, oats, quinoa, sorghum, foxtail millets, tofu, edamame, red lentils, green lentils, spirulina, chia seeds, nuts, and hemp seeds.

In some embodiments of the aforementioned aspects, prior to step (a), the composition comprising protein from one or more microorganism, plant, fungus, and/or algal source is hydrated in a high-shear mixing process with heating. In some embodiments, other ingredients such as lipids, fiber, carbohydrate, and/or flavoring agents may be added, while maintaining the high-shear mixing and heating conditions.

The aforementioned methods may further include, prior to step (a), adding one or more gelling agent and/or hydrocolloid and mixing, while maintaining the high-shear mixing and heating conditions. In some embodiments of the aforementioned aspects, the method may further include, prior to step (a), adding an acidic or basic solution (e.g., a buffer solution), such as, but not limited to, a calcium hydroxide solution, after the one or more gelling agent and/or hydrocolloid, and mixing, while maintaining the high-shear mixing and heating conditions. In some embodiments, the method may further include, after step (a), treating the extrudate composition with an acidic or basic solution (e.g., a buffer solution), such as, but not limited to, a calcium hydroxide solution.

In some embodiments, the one or more lipids in the composition is derived from a plant, a microorganism, and/or an algae. In some embodiments, the one or more lipids include a lipid that is derived from one or more microorganism, such as, but not limited to, Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism. In some embodiments, the one or more lipids include a lipid that is derived from a plant, such as, but not limited to, sunflower oil, canola oil, coconut oil, palm oil, cocoa butter, and/or vegetable oil.

In some embodiments, the composition in step (a) includes components such that the structured food product is carbon neutral or carbon negative.

In some embodiments, the structured food product further includes one or more animal-derived components. For example, the one or more animal-derived components may include, but not limited to, collagen, a lipid, and/or a flavoring agent or composition.

In some embodiments, the structured food product further includes meat or cultured meat.

In some embodiments, the structured food product is incorporated into another food product.

In another aspect, a structured food product is provided, which is produced by any of the methods described herein. For example, the structured food product may be carbon neutral or carbon negative. In some embodiments, the structured food product is a vegan product. In some embodiments, the structured food product includes one or more animal-derived components and/or comprises cultured animal cells. In some embodiments, the structured food product is a meat analogue product that does not include wheat or soy, or ingredients derived therefrom (e.g., wheat, soy, and/or gluten free). In some embodiments, the structured food product is a meat analogue product, such as, but not limited to, a seafood analogue that imitates a scallop or other shellfish.

In another aspect, a method for producing the composition of the aforementioned method aspects (e.g., the composition that is extruded or structured food composition herein) is provided, comprising: (a) culturing one or more microorganisms in the presence of a carbon source, thereby producing microbial biomass comprising protein; (b) converting the microbial biomass into a microorganism protein product which is used as the protein in the structured food composition; and (c) processing the microorganism protein product into a structured food composition, wherein processing the microorganism protein product into the structured food composition includes any of the methods described herein. In some embodiments of the aforementioned aspect, step (a) includes chemoautotrophic culture conditions. For example, the carbon source may include a gaseous C1 molecule, such as, but not limited to, CO₂, CO, and/or CH₄.

In some embodiments, the one or more microorganisms may include, but is not limited to, a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof. For example, in some embodiments, the one or more microorganisms may comprise or consist of a Cupriavidus microorganism, such as a Cupriavidus necator and/or Cupriavidus metallidurans microorganism. In certain embodiments, the one or more microorganisms may comprise or consist of Cupriavidus necator DSM 531 and/or DSM 541.

In some embodiments, the microorganism protein product includes one or more single cell protein, cell lysate, protein isolate, protein concentrate, protein hydrolysate, free amino acids, peptides, oligopeptides, or combination of any two or more thereof.

In some embodiments, protein, such as texturized vegetable protein (e.g., texturized pea protein) and/or microbial protein, is hydrated, e.g., with water, and thoroughly mixed. This mixture is then transferred into a device that mixes and cooks at an elevated temperature simultaneously, e.g., 50-90° C. at 1-1,500 rpm, and mechanically elongates the dough. In some embodiments, the device may deploy a “reverse blade” operation for stirring and shearing, without chopping. For example, a high-speed blade mixer capable of heating, such as a Thermomix® device, may be used for this purpose.

Oil (e.g., sunflower oil (e.g., high-oleic sunflower oil), coconut oil) and optionally flavoring substance(s) are added to the water/texturized protein mixture, then dry ingredients (e.g., flour (e.g., konjac flour), starch (e.g., pea starch), gelling agent(s) (e.g., xanthan powder, algin powder, carrageenan, gellan gum), gluten (e.g., wheat gluten), and/or spices/seasoning, are combined and added. The dough is thoroughly mixed, for example, for about 30-60 minutes at 50-90° C. An alkali salt (e.g., calcium hydroxide, sodium hydroxide) and water are then added, and mixing is continued without heat. The alkali salt may promote formation of a thermos-irreversible gel structure.

While the mixture is still at an elevated temperature (e.g., above 70° C.), it may be set into a desired shape, either through molding or via low shear extrusion (e.g., cold extrusion), e.g., in a device such as a pasta maker with die diameter about 0.5 mm to about 2 mm. The mixture may be then vacuum sealed. After cooling (e.g., 2-4 hours at 2-6° C.), the mixture may be cut or punched into desired shapes. For example, a circular cutter may be used to punch out disc (e.g., scallop) shaped pieces of the mechanically elongated composition, or bundled extrudate strands may be cut, such as in a direction that is perpendicular or substantially perpendicular to the longest dimension of the extrudate strands or bundle of extrudate strands, e.g., to produce substantially disc shaped structures, which may resemble, but are not limited to, a shellfish, such as a scallop.

In some embodiments, extrusion of a protein-containing composition or the composition of step (a) in the methods, as described herein produces aligned fibers, i.e., protein fiber networks and/or aligned protein fibers that produce a structured food product such as a product with a meat-like (e.g., seafood-like) texture. The extrudate may include a fiber matrix which is produced by extrusion. The fibers may be proteinaceous fibers, such as fibers having greater than about 50% (e.g., greater than about 80%) protein content. For example, extrusion may result in shear-alignment of protein fibrils during extrusion of a protein-containing composition (e.g., dough composition) as described herein. The protein fibrils may include bundles of extended peptide chains, for example, linked by disulfide bonds.

In some embodiments, after forming the structured food product into a desired shape or structure, the formed structured food product may be sprayed with or dipped into a composition, such as a composition that includes protein, colors, flavors, flavor precursors, and/or sugars. For example, the formed structured food product may be a meat analogue product that is sprayed or dipped into the composition to form an outer layer that simulates skin.

The protein-containing composition in step (a) may contain about 10% to about 60% microorganism (e.g., bacterial) protein and/or about 10% to about 70% plant protein. In some embodiments, the extrudate contains about 10% to about 40% total protein.

Optionally, the protein-containing composition contains one or more salt(s), such as, but not limited to, NaCl, KCl, and/or monosodium glutamate (MSG).

In some embodiments, protein (such as microorganism protein product) may be subjected to a process to lighten to color of the protein prior to thermomechanical elongation and/or prior to cold extrusion.

In certain embodiments, the structured food product contains: (i) about 10% (w/w) to about 70% (w/w) protein product from one or more microorganism and about 10% (w/w) to about 60% (w/w) protein from one or more plant source; (ii) about 2% (w/w) to about 10% (w/w) lipid (e.g., oil and/or fat); and (iii) about 1% (w/w) to about 15% (w/w) flavoring and/or coloring agent or composition. The structured food product may also contain one or more gelling agent and/or hydrocolloid, such as, but not limited to, curdlan, konjac, alginate, gar, carrageenan, gellan gum, pectin, xanthan gum, sodium alginate, and/or pea starch.

In some embodiments, the ingredients/components that are incorporated into the structured food product do not include animal derived products, i.e., the structured food product is vegan. In other embodiments, one or more animal derived ingredient or component is included. For example, animal-derived collagen may be included, for example, as a structuring agent, or animal-derived lipids (e.g., fat) or broth may be included, for example, as a flavoring agent. In some embodiments, the structured food product produced as described herein is incorporated into a meat or a cultured meat product.

### Meat Analogue Products

In some embodiments, a structured food product, produced as described herein (e.g., including layered sheets, or shredded and/or grounded, or high moisture extrusion, or cold extrusion of a protein-containing composition, such as a protein-containing dough composition), and containing ingredients/components as described herein, is formulated as a meat analogue product, such as, but not limited to, a seafood analogue, for example a shellfish analogue, e.g., a scallop analogue or chicken breast analogue. Alternatively, the structured food product may be incorporated into a meat product, e.g., as a filler, or may be incorporated into a cultured meat product, or into another product such as a soup, stew, casserole, etc.

Meat analogue products are provided that resemble and/or have the flavor of animal meat (e.g., livestock, game, poultry, fish, or seafood meat). For example, the meat analogue may resemble, and/or contain flavor and/or other characteristics, chicken breast or seafood, such as, but not limited to, a shellfish, such as a scallop. The meat analogue product simulates texture and/or physical characteristics of animal meat, such as, for example, flavor, aroma, texture, appearance, etc. The meat analogue products described herein include protein from one or more microorganism, plant, algae, fungus, and/or insect source.

In some embodiments, the meat analogue product includes the microorganism protein product or the microorganism-derived protein product or the protein product (e.g., one or more of single cell protein, cell lysate, protein isolate, protein concentrate, protein hydrolysate, free amino acids, peptides, oligopeptides, or combinations thereof) from one or more microorganism, such as, but not limited to a chemoautotrophic microorganism, such as a Cupriavidus, Rhodococcus, Hydrogenovibrio, Rhodopseudomonas, Hydrogenobacter, Gordonia, Arthrobacter, Streptomycetes, Rhodobacter, and/or Xanthobacter microorganism, or a consortium of two or more thereof. In some embodiments, the protein product that is incorporated into the artificial meat product is produced by a GRAS microorganism.

Microorganism protein product may be included in combination with any of one or more plant, algae, fungus, and/or insect protein. For example, the microorganism protein product may be included at any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the composition, with the remainder of the protein supplied by one or more plant, algae, fungus, and/or insect protein, or 100% of the protein in the meat analogue product may be microorganism protein product. In other embodiments, any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the composition is plant, algae, fungus, or insect derived protein, or a combination thereof, or 100% of the protein in the composition of step meat analogue product may be plant, algae, fungus, or insect derived protein, or a combination thereof. In other embodiments, any of about or at least about 2%, 5%, 10%, 15%, 20%, 25%, 30%, 35%, 40%, 45%, 50%, 55%, 60%, 65%, 70%, 75%, 80%, 85%, 90%, or 95% of the total protein in the composition is plant derived protein, or 100% of the protein in the meat analogue product may be plant derived protein. Nonlimiting examples of plant protein sources include rice, pea, mung bean, fava, potato, wheat, chickpea, soy, jackfruit, oats, quinoa, sorghum, foxtail millets, tofu, edamame, lentils (e.g., red lentils, green lentils), spirulina, chia seeds, nuts, and hemp seeds.

In some embodiments, a meat analogue product includes at least about 10%, at least about 15%, at least about 20%, or at least about 25% by weight of microbial protein product as described herein, optionally bound together by one or more binding agents, to produce a food product that has one or more similar textural and/or functional characteristics in comparison to animal meat. In some embodiments, the meat analogue product resembles animal meat, for example, ground animal meat (e.g., ground beef, ground pork, ground turkey). In some embodiments, the meat analogue product is principally or entirely composed of ingredients derived from non-animal sources. In alternative embodiments, the meat analogue product is composed of ingredients partially derived from animal sources but supplemented with ingredients derived from non-animal sources. In some embodiments, the meat analogue product further includes one or more agent release systems and/or other ingredients. In various embodiments, the meat analogue products herein may be sliced, cut, ground, shaved, shredded, grated, extruded, or otherwise processed, or left unprocessed. Examples of sliced forms include but are not limited to dried meats, cured meats, and sliced lunch or deli meats. In some embodiments, the meat analogue food products provided herein are shredded and then bound together, chunked and formed, ground and formed, or chopped and formed, for example, to produce a product similar in appearance and/or texture to animal jerky or any other meat product as described herein.

In some embodiments, the meat analogue products are vegan. In some embodiments, the meat analogue products comprise no GMO ingredients. In some embodiments, the meat analogue products comprise no ingredients derived from nuts. In some embodiments, the meat analogue products comprise less than about 0.6% or less than about 0.5% by weight of sodium. In some embodiments, the meat analogue products comprise less than about 850 mg, 500 mg, 400 mg, or 140 mg per 85 mg serving, or less or comprise no or substantially no sodium. In some embodiments, the meat analogue products comprise less than about 10 g, less than about 5 g, less than about 3.5 g, or less than about 2.5 g fat per 85 g serving, e.g., less than about 6%, less than about 4% or less than about 3% by weight. In some embodiments, the meat analogue food products comprise no gluten or substantially no gluten. In some embodiments, the meat analogue products comprise no soy or substantially no soy. In other embodiments, the meat analogue food products comprise soy. In some embodiments, the meat analogue products comprise no pea or substantially no pea. In some embodiments, the meat analogue products comprise no artificial ingredients, such as, but not limited to, xanthan or methylcellulose.

In some embodiments, the meat analogue product may contain any of at least about 2%, at least about 5%, at least about 10%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90%, or any of about 2% to about 5%, about 2% to about 10%, about 5% to about 10%, about 5% to about 20%, about 10% to about 40%, about 20% to about 50% about 40% to about 80%, or about 50% to about 90% microbial protein product, as described herein, by weight of the meat analogue product.

In some embodiments, the meat analogue products provided herein comprise about 3% to about 6%, about 3% to about 30%, or about 5% to about 30% by weight of lipid, e.g., about 3% to about 10%, about 5% to about 10%, about 10% to about 15%, about 15% to about 20%, about 20% to about 30%, about 5% to about 15%, about 10% to about 20%, about 20% to about 30%, about 3% to about 15%, about 5% to about 15%, about 15% to about 30%, about 3% to about 25%, about 5% to about 25%, or about 10% to about 30% by weight of lipid.

In some embodiments, the lipid (including, but not limited to, fatty acids and/or oil) is produced by a microorganism, which may be the same as or different from the microorganism from which the protein product is derived. The microorganism may be grown in autotrophic culture conditions, heterotrophic culture conditions, or a combination of autotrophic and heterotrophic culture conditions, as described infra. In some embodiments, the lipid is produced by the microorganism from which the protein product is derived and is incorporated into the meat analogue product as a component of the microbial protein product. In other embodiments, the lipid is produced by the microorganism from which the protein product is derived, and is isolated or extracted from the microorganism or from the protein product produced by the microorganism, and is then incorporated into the meat analogue product. In further embodiments, the lipid is produced by a different microorganism than the microorganism from which the protein product is derived (for example, produced by any of the microorganisms disclosed herein), and is isolated or extracted from this microorganism or a protein product thereof as described herein, and is then incorporated into the meat analogue product. Nonlimiting examples of lipid-producing microorganisms, such as chemoautotrophic microorganisms that produce lipids, and growth, production, and extraction of lipids thereof, are described in U.S. Pat. Nos. 9,085,785, 9,556,462, 9,879,290, and 9,957,534, and in U.S. Publication No. 2013/0078690, all of which are incorporated by reference herein in their entireties. In certain nonlimiting embodiments, the microorganism source of lipids is a Rhodococcus species (such as, but not limited to Rhodococcus opacus), e.g., DSM 44193, DSM 43205, DSM 43206, DSM 3346, or a Cupriavidus species (such as, but not limited to, Cupriavidus necator or Cupriavidus metallidurans), e.g., DSM 531, DSM 541, DSM 2839). Growth of chemoautotrophic microorganisms on gaseous carbon and/or energy sources is described in U.S. Pat. Nos. 9,085,785, 9,157,058, 9,556,462, 9,879,290, and 9,957,534, and 10,696,941, all of which are incorporated by reference herein in their entireties, and in U.S. Publication No. 2013/0078690, and in the disclosure herein, infra.

In some embodiments, the meat analogue products comprise about 0.5% to about 10% by weight of total carbohydrate, e.g., about 0.5% to about 1%, about 1% to about 5%, about 5% to about 10%, about 2% to about 8%, or about 3% to about 6% by weight of total carbohydrate.

In some embodiments, the meat analogue products comprise about 0.5% to about 5% by weight of edible fiber, e.g., about 0.5% to about 1%, about 1% to about 5%, about 5% to about 10%, about 2% to about 8%, or about 3% to about 6% by weight of edible fiber.

The meat analogue products provided herein may comprise a moisture content (MC) of at least about 30%, at least about 40%, at least about 50%, at least about 60%, at least about 70%, at least about 80%, or at least about 90% by weight. In some embodiments, the meat analogue products comprise a similar MC as animal meat (e.g., livestock (e.g., beef, pork), game, poultry (e.g., chicken, turkey, duck), fish, or seafood (e.g., shrimp, crab, lobster, scallop).

In some embodiments, the meat analogue products comprise one or more coloring agents. In some embodiments, the meat analogue products comprise one or more color enhancers. In some embodiments, the meat-like food products comprise mixtures of two or more coloring agents, color stabilizers, and/or color enhancers. Non-limiting examples of such mixtures include beet extract and annatto, beet extract and turmeric, beet extract and saffron, beet extract and purple carrot, beet extract and grape seed extract, beet extract and tomato extract, beet extract and lycopene, beet extract and beta carotene, beet extract and anthocyanin, beet extract and anthocyanin and annatto, beet extract and annatto and lycopene, beet extract and ascorbic acid, anthocyanin and annatto, beet extract and annatto and ascorbic acid, beet extract and annatto and beta carotene, beet extract and turmeric and ascorbic acid, and anthocyanin and lycopene and annatto. In some such embodiments, the coloring agents, color stabilizers, and/or color enhancers are present at equal weight ratios. In other such embodiments, the coloring agents, color stabilizers, and/or color enhancers are present at unequal weight ratios (e.g., 55:45, 60:40, 65:35, 2:1, 70:30, 75:25, 80:20, 5:1, 85:15, 90:10, 20:1, 95:5, or 99:1). In some embodiments, the meat analogue products comprise browning agents, such as, but not limited to, pentose (e.g., ribose, arabinose, xylose), hexose (e.g., glucose, fructose, mannose, galactose), dextrins, and commercial browning agents (e.g., red arrow dextrose, wood-derived agents).

In some embodiments, a meat analogue product herein includes one or more plant protein source such as, but not limited to, pea, rice, glutinous rice, wheat, gluten, soy, hemp, canola, and/or buckwheat, in combination with a protein product produced by microorganisms as described herein, wherein the microorganism protein product and/or the plant protein imparts a meat-like flavor to the composition.

In some embodiments, meat analogue product herein includes a heme compound, such as a heme-containing polypeptide. For example, the heme compound (e.g., heme-containing polypeptide) may be from the microorganism from which the protein product is derived. In certain such embodiments the heme compound is derived from a Cupriavidus microorganism, for example, Cupriavidus necator. In certain such embodiments the heme compound is a hemoglobin or flavohemoglobin.

A meat analogue product as described herein may include: one or more protein source (e.g. microbial protein product as described herein, and optionally, plant-based protein; one or more fats (e.g. plant-based oil, such as, but not limited to, sunflower, canola, coconut, palm, and/or vegetable oil); and/or microbially produced fat, lipid, and/or oil; one or more binding agents (e.g., carrageenan, gum cellulose, gum arabica, acacia gum, egg or milk protein, and/or starch); plant based or other sources of dietary fibers such as, but not limited to inulin, psyllium husk, citrus fibers, pea fiber, and/or hemp fiber, and one or more other ingredients, such as, but not limited to, spices and/or flavors (e.g., salt, spice(s), and/or aroma-producing compound(s)), vitamins (e.g., vitamin B12), and coloring agents. In some embodiments, the meat analogue product includes microbial protein product as described herein and one or more plant-based protein source, such as, but not limited to, protein from peas (e.g., pea protein isolate), mung beans, and/or fava beans, and/or protein from one or more of whey, soy, adzuki, chickpea, lupin, lentil seed, cashew nut, almond seed, walnut, peanut, wheat gluten, rice bran, oat, and seaweed (e.g., brown seaweed). In some embodiments, the meat analogue product includes microbial protein product as described herein and one or more plant-based protein source that is similar to the microbial protein product in one or more functional properties, such as oil holding capacity (OHC) (g/g), water holding capacity (WHC) (g/g), emulsion stability (min), foaming stability (%), foaming capacity (%), and gelation temperature (° C.), such as, but not limited to, protein from peas (e.g., pea protein isolate), mung beans, and/or fava beans.

In some embodiments, a meat analogue product includes microbial protein product as described herein in combination with cultured meat (meat produced by in vitro culturing of animal cells). For example, a cultured meat product may include any of at least about 1%, 2%, 5%, 10%, 15%, 20%, 25%, 30%, 35%, 40%, 45%, 50%, 55%, 60%, 65%, 70%, 75%, 80%, 85%, or 90% microbial protein product as described herein by weight (e.g., one or more of single cell protein, cell lysate, protein concentrate, protein isolate, protein hydrolysate, free amino acids, peptides, oligopeptides, or combinations thereof), with the remainder cultured meat cells and other ingredients suitable for production of a meat analogue product, as described herein. In some embodiments, the microbial protein product, such as, but not limited to, a microbial protein hydrolysate, or one or more of single cell protein, cell lysate, protein concentrate, protein isolate, protein hydrolysate, free amino acids, peptides, oligopeptides, or combinations thereof, includes components that improve the flavor of the cultured meat product. In certain embodiments, the protein product, e.g., microbial protein hydrolysate, or one or more of single cell protein, cell lysate, protein concentrate, protein isolate, protein hydrolysate, free amino acids, peptides, oligopeptides, or combinations thereof, stimulates the development of flavor-enhancing elements in the cultured meat product. “Enhancing the flavor” of a food product, e.g., a meat analogue product, such as a cultured meat product, includes rendering the product more palatable, or imparting one or more flavor components that are found in the naturally-produced counterpart of the cultured product (i.e., in a meat product from the animal from which the cultured cells are derived). In some embodiments, the cultured meat product includes lipid (including, but not limited to, fatty acids and/or oil) from the protein product as described herein, from the same or different microorganism as described supra, from animal cells, or from a plant-based source.

In some embodiments, a structured food product, such as a meat analogue, includes, but is not limited to, protein (e.g., vegetable protein, microbial (e.g., bacterial) protein), carbohydrate (e.g., vegetable starch), gelling agent (e.g., gum, hydrocolloid), lipid (e.g., vegetable fat), fiber (e.g., insoluble fiber, soluble fiber), water, enzymes (e.g., transglutaminase), and simple sugars such as glucose, corn syrup solids, agave syrup, and maltodextrins (e.g., used for binding and/or as a component in a Maillard reaction), or subsets thereof.

In some embodiments, a meat analogue product as described herein, is wheat free, soy free, or wheat and soy free, or does not include ingredients derived from wheat, from soy, or from wheat and soy. In some embodiments, the meat analogue product is gluten free.

In some embodiments, a meat analogue product as described herein includes pea protein and/or fiber, and carbohydrates. For example, the carbohydrates may include oligosaccharides (e.g., fructooligosaccharides, such as short-chain fructooligosaccharides). In some embodiments, a meat analogue product as described herein includes pea protein and/or fiber, and hydrocolloid and/or gelling agent (e.g., pea starch, konjac powder, xanthan gum, alginate).

In some embodiments, a structured food product as described herein, for example, a meat analogue product, includes a heme compound, such as a heme-containing polypeptide. In one embodiment, the food product includes heme (e.g., heme-containing polypeptide) from the microorganism from which the protein product is derived or from a different microorganism.

In some embodiments, an enhanced meat product which contains animal protein (e.g., a beef, poultry, pork, fish, seafood, or egg product), in which a portion of the product is a protein product ingredient produced by microorganisms as described herein (e.g., one or more of single cell protein, cell lysate, protein isolate, protein concentrate, protein hydrolysate, free amino acids, peptides, oligopeptides, or combinations thereof), is provided. For example, the protein product may be included as an extender in an enhanced meat product or in a meat analogue product, e.g., the protein product replaces at least about 5%, 10%, 20%, 30%, 40%, 50%, 60%, 70%, 80%, or 90% of the meat ingredient or an artificial or imitation meat ingredient (for example, a plant-based artificial or imitation meat analogue ingredient) to produce the enhanced meat product or meat analogue/imitation meat product, respectively. In some embodiments, the microorganisms are chemoautotrophically grown, e.g., CO₂-grown or air-grown microorganisms, e.g., oxyhydrogen microorganisms.

### Ingredients

### Protein

The structured food products, e.g., meat analogues, described herein include one or more protein(s) (e.g., non-animal protein(s)). In some embodiments, the meat analogues include protein from one or more microbial, plant, fungal, algal, and/or insect source. Nonlimiting examples of plant protein(s), which may be included in the meat analogue either without or in combination with microbial, fungal, and/or algal protein(s), include rice protein (e.g., rice bran protein), pea protein (e.g., pea protein isolate), fermented rice and/or pea protein, mung bean protein, fava protein, potato protein, and/or soy protein. In some embodiments, the plant protein includes rice protein, legume, zein, canola protein, corn gluten, pea protein, mung bean protein, fava protein, potato protein, wheat protein, chickpea protein, soy protein, jackfruit, oats, quinoa, sorghum, foxtail millets, tofu, edamame, lentils (e.g., red lentils, green lentils), spirulina, chia seeds, nuts, and/or hemp seeds. Nonlimiting examples of microbial protein include bacterial protein and/or fungal protein, such as single cell protein, cell lysate, protein isolate, protein concentrate, and/or protein hydrolysate from a microbial source.

In some embodiments, the structured food products, e.g., meat analogues, include microbial protein(s), either without or in combination with plant, fungal, algal, and/or insect protein(s). In some embodiments, the microbial protein source is a chemoautotrophic microorganism, such as a chemoautotrophic bacterial microorganism, i.e., any of the chemoautotrophic microorganisms described herein. In certain nonlimiting embodiments, the chemoautotrophic bacterial microorganism includes one or more of the following genera: Cupriavidus, Rhodococcus, Hydrogenovibrio, Rhodopseudomonas, Hydrogenobacter, Gordonia, Arthrobacter, Streptomycetes, Rhodobacter, and/or Xanthobacter, or a consortium of two of more of these genera and/or two or more species or strains within one of these genera. For example, the microorganism(s) may include a Cupriavidus species, such as Cupriavidus necator (e.g., Cupriavidus necator DSM 531 and/or DSM 541) and/or Cupriavidus metallidurans.

For example, total protein in a structured food product, e.g., meat analogue, as described herein, may be about 10% to about 99% by weight, such as any of about 10% to about 20%, about 15% to about 25%, about 20% to about 30%, about 25% to about 35%, about 30% to about 40%, about 35% to about 45%, about 40% to about 50%, about 45% to about 55%, about 50% to about 60%, about 55% to about 65%, about 60% to about 70%, about 65% to about 75%, about 70% to about 80%, about 75% to about 85%, about 80% to about 90%, about 85% to about 95%, about 90% to about 99%, about 10% to about 30%, about 20% about 40%, about 30% to about 50%, about 40% to about 60%, about 50% to about 70%, about 60% to about 80%, about 70% to about 90%, about 80% to about 99%, about 10% to about 40%, about 20% to about 50%, about 30% to about 60%, about 40% to about 70%, about 50% to about 80%, about 60% to about 90%, about 70% to about 99%, about 10% to about 50%, about 20% to about 60%, about 30% to about 70%, about 40% to about 80%, about 50% to about 90%, about 60% to about 99%, about 10% to about 60%, about 20% to about 70%, about 30% to about 80%, about 40% to about 99%, about 10% to about 70%, about 20% to about 80%, about 30% to about 90%, about 40% to about 99%, or about 50% to about 99% by weight.

In some embodiments, a structured food product as described herein includes microbial (e.g., bacterial) protein, which is obtained in a process that includes culturing microbial (e.g., bacterial) cells (e.g., culturing chemoautotrophically) to obtain microbial (e.g., bacterial) biomass, separating a liquid phase (e.g., culture medium) from a solid phase (e.g., microbial biomass), concentrating the solid phase, and drying the solid phase. In some embodiments, the dried solid phase (microbial protein concentrate) is in the form of a protein-containing powder or is processed to obtain a protein-containing powder. This protein concentrate may be incorporated into a structured food product as described herein.

### Carbohydrates

In some embodiments, the structured food products, e.g., meat analogues, described herein include one or more carbohydrate, such as starch(es). For example, one or more of corn, cassava (tapioca), pea, rice, wheat, legume, and/or potato starch may be included as a carbohydrate component.

In some embodiments, inclusion of starch increases firmness, cohesiveness, and/or chewiness of the meat analogue product. Although not wishing to be bound by theory, this may be due to the ability of starches to trap water and retrogradation during cooling, i.e., the starch does not promote moisture release during cooking. In some embodiments, starch (e.g., pre-gelled tapioca) reduces cohesiveness and chewiness.

For example, total carbohydrate in a structured food product, e.g., meat analogue, as described herein, may be about 1% to about 20% by weight, such as any of about 1% to about 5%, about 1% to about 10%, about 5% to about 10%, about 5% to about 15%, about 10% to about 20% by weight.

In some embodiments, the carbohydrate includes an oligosaccharide, such as a fructooligosaccharde, e.g., short-chain fructooligosaccharides.

### Thickening/Gelling Agent

In some embodiments, the structured food products, e.g., meat analogues, described herein include one or more thickening and/or gelling agent, such as a hydrocolloid. For example, one or more of gum arabic, agar, konjac powder, xanthan gum, gellan gum, xanthan-konjac powder, locust bean gum, carrageenan, curdlan gum, acacia tree gum, and sodium alginate may be included. In one embodiment, the meat analogue includes a combination of agar and gum Arabic. In another embodiment, the meat analogue includes a combination of konjac and glucomannan.

In some embodiments, inclusion of a thickening and/or gelling agent, such as a hydrocolloid, may promote elastic properties in the dough, which may support the formation of elongated fiber, such as elongated gluten fiber. Inclusion of a thickening and/or gelling agent, such as a hydrocolloid, may result in a desired meat-like texture and may also aid in development of striated fiber in association with gluten.

For example, total thickening and/or gelling agent in a structured food product, e.g., meat analogue, as described herein, may be about 1% to about 50% by weight, such as any of about 1% to about 5%, about 1% to about 10%, about 5% to about 10%, about 5% to about 15%, about 10% to about 20%, about 15% to about 25%, about 20% to about 30%, about 25% to about 35%, about 30% to about 40%, about 35% to about 45%, about 40% to about 50%, about 1% to about 20%, about 10% to about 30%, about 20% to about 40%, about 30% to about 50%, about 1% to about 30%, about 10% to about 40%, about 20% to about 50%, about 1% to about 40%, about 10% to about 50%, about 1% to about 25%, or about 25% to about 50% by weight.

### Fiber

In some embodiments, the structured food products, e.g., meat analogues, described herein include one or more sources of fiber. For example, one or more soluble fiber and/or insoluble fiber or fiber source may be included. For example, one or more of citrus fiber, β-fructan (e.g., inulin), b-glucan, oligofructose, chicory root fiber, seaweed, algae, konjac, and, psyllium may be included. Fibers may interact with water and/or oil and form soft or extensible gels, thus improving elasticity of the dough, and may promote other health benefits in the finished food product, such as improved digestive health.

For example, total fiber in a structured food product, e.g., meat analogue, as described herein, may be about 1% to about 75% by weight, such as any of about 1% to about 5%, about 1% to about 10%, about 5% to about 10%, about 5% to about 15%, about 10% to about 20%, about 15% to about 25%, about 20% to about 30%, about 25% to about 35%, about 30% to about 40%, about 35% to about 45%, about 40% to about 50%, about 45% to about 55%, about 50% to about 60%, about 55% to about 65%, about 60% to about 70%, about 65% to about 75%, about 1% to about 20%, about 10% to about 30%, about 20% to about 40%, about 30% to about 50%, about 40% to about 60%, about 50% to about 70%, about 60% to about 75%, about 1% to about 30%, about 10% to about 40%, about 20% to about 50%, about 30% to about 60%, about 40% to about 70%, about 50% to about 75%, about 1% to about 40%, about 10% to about 50%, about 20% to about 60%, about 30% to about 75%, about 1% to about 25%, or about 25% to about 50%, or about 50/% to about 75% by weight.

### Lipids

In some embodiments, the structured food products, e.g., meat analogues, described herein include one or more lipids (e.g., oils and/or fats). For example, the lipid(s) may include, but are not limited to, plant-derived lipids, such as sunflower, canola, coconut, palm, soy, cocoa butter, and/or vegetable oil. In some embodiments, lipid(s) may be provided by one or more microorganisms, which may be the same or different microorganism(s) from which protein product that is incorporated into the meat analogue product is derived.

For example, total lipid in a structured food product, e.g., meat analogue, as described herein, may be about 0.1% to about 15%, such as any of about 0.1% to about 0.5%, about 0.1% to about 1%, about 0.5% to about 1%, about 1% to about 5%, about 1% to about 10%, about 0.25% to about 15%, about 0.25% to about 5%, about 0.25% to about 10%, about 5% to about 10%, about 0.75% to about 15%, or about 10% to about 15% by weight.

### Gluten

In some embodiments, the structured food products, e.g., meat analogues, described herein include gluten (e.g., wheat gluten), in between layers as an adhesive agent (in sheeted products), or in the protein-containing composition as an agent to facilitate a desired texture, such as a meat-like texture.

For example, gluten in the protein-containing composition (e.g., dough composition), e.g., which is used for production of sheets, shreds, etc. as described herein, may be about 5% to about 30%, such as any of about 5% to about 10%, about 10% to about 15%, about 15% to about 20%, about 20% to about 25%, about 25% to about 30%, about 5% to about 15%, about 10% to about 20%, about 15% to about 25%, about 20% to about 30%, about 5% to about 20%, about 10% to about 30%, about 5% to about 25%, or 15% to about 30% by weight.

For example, gluten in the structured food product produced by the process of sheeting or layering, e.g., protein-containing composition plus a glue or an adhesive agent, may be about 10% to about 40%, such as any of about 10% to about 15%, about 15% to about 20%, about 20% to about 25%, about 25% to about 30%, about 30% to about 35%, about 35% to about 40%, about 10% to about 20%, about 20% to about 30%, about 30% to about 40%, about 10% to about 35%, about 15% to about 40%, about 15% to about 25%, or about 25% to about 40% by weight.

### Flavoring Agents

One or more flavoring agents may be included in a structured food product, e.g., meat analogue product, as described herein. For example, a flavoring agent or a combination of two or more flavoring agents may be included that are designed to mimic the natural flavor of a meat product, such as a beef, chicken, pork, fish, or seafood (e.g., shrimp, crab, lobster) product. Flavoring agents herein may be natural, artificial, or a combination thereof.

Precursors of meat flavor may include water soluble components (e.g., amino acids, peptides, carbohydrates, nucleotides, thiamine) and/or lipid or water insoluble components. In some embodiments, meat flavor precursors include free sugars, sugar phosphates, nucleotides, free amino acids, peptides, and/or thiamine. In some examples, hydrolysates produced from microbial protein products described herein may contain meat flavor precursors. In some embodiments, glutamic acids naturally produced during hydrolysis of microbial proteins may be favored for imparting a sweet umami flavor. In some embodiments, such amino acids may form part of a savory meaty flavor base. In some embodiments, enzymes such as glutaminase, exo/endo peptidases, proteases may be used to generate flavor precursors. In some embodiments, combinations of microbial protein hydrolysates with wheat gluten hydrolysates and enzymes such as glutaminase may result in kokumi flavors which impart a thickness, richness and mouthfulness. In some embodiments, these combinations may generate salty, sweet or umami properties. In other embodiments enzymes such as, amino-terminal exopeptidases or carboxy-terminal exopeptidases or other enzymes such as papain with proteases may produce flavor or flavor precursors from microbial derived protein or protein hydrolysates.

Compounds such as 2-methyl-3-furanthiol, 2-furfurylthiol, methionol, 2,4,5-trimethyl-thiazole, nonanol, 2-trans-nonenal, 2-furanmethanethiol, 3-methylthiopropanal. may be incorporated into or produced upon cooking of a meat analogue product as described herein, thereby imparting a meat like flavor to the product. In some embodiments, reaction of a sulfur containing amino acid such as cysteine generated from microbial protein product and a sugar result in production of 2-methyl-3-furanthiol, which imparts a meat like flavor, such as a chicken flavor

In some embodiments, a protein product as described herein, for example, a protein hydrolysate and/or free amino acids, derived from one or more microorganisms, may be reacted with thiamine and one or more monosaccharide (e.g., ribose, xylose, arabinose, glucose) and/or polysaccharide to produce a flavoring agent that imparts a meat like flavor. In one embodiment, thiamine is reacted with xylose.

In some embodiments, flavoring agents include garlic powder, citric acid, salt, and/or sugar.

For example, flavoring agent(s) may be included in the structured food product at about 0.05% to about 10%, such as any of about 0.05% to about 0.5%, about 0.05% to about 1%, about 0.5% to about 1%, about 1% to about 5%, about 5% to about 10%, about 0.05% to about 0.25%, about 0.05% to about 0.1%, about 0.25% to about 0.5%, about 0.5% to about 2%, about 0.5% to about 5%, about 2% to about 5%, about 3% to about 7%, or about 4% to about 8% by weight.

### Microbial Protein

In some embodiments, the microbial protein (or microbial protein product or protein derived from the microorganism) is included in structured food products, e.g., meat analogue products, as described herein, either as a sole protein source, or in combination with one or more additional protein sources, such as one or more plant protein(s). Microbial protein may be in the form of single cell protein, a cell lysate, a protein isolate, and/or a protein hydrolysate. In some embodiments, the microbial protein source is a chemoautotrophic microorganism, such as a chemoautotrophic bacterial microorganism, i.e., any of the chemoautotrophic microorganisms described herein. In certain nonlimiting embodiments, the chemoautotrophic bacterial microorganism includes one or more of the following genera: Cupriavidus, Rhodococcus, Hydrogenovibrio, Rhodopseudomonas, Hydrogenobacter, Gordonia, Arthrobacter, Streptomycetes, Rhodobacter, and/or Xanthobacter, or a consortium of two of more of these genera and/or two or more species or strains within one of these genera. For example, the microorganism(s) may include a Cupriavidus species, such as Cupriavidus necator (e.g., Cupriavidus necator DSM 531 and/or DSM 541) and/or Cupriavidus metallidurans.

Microbial protein may be included in an amount about 2% (w/w) to about 35% (w/w) of the finished structured food product, e.g., meat analogue product, such as any of about 2% to about 5%, about 5% to about 10%, about 10% to about 15%, about 15% to about 20%, about 20% to about 25%, about 25% to about 30%, about 30% to about 35%, about 10% about 20%, about 15% to about 25%, about 20% to about 30%, about 25% to about 35%, about 10% to about 30%, about 20% to about 35%, about 10% to about 30%, about 20% to about 35%, about 10% to about 35%, or about 15% to about 35% by weight.

### Protein Hydrolysates

In some embodiments, at least a portion or all of the protein product is produced by hydrolyzing protein (e.g., single cell protein, cell lysate, protein isolate, and/or protein concentrate) from at least one microorganism described herein. For example, hydrolysis of cellular protein may produce peptides, oligopeptides, and/or free amino acids.

Hydrolysis of microbial protein may be performed by acidic, basic, and/or enzymatic processes. Some methods for hydrolyzing protein may be known in the art. Nonlimiting examples of microbial protein hydrolysis methods and hydrolysate compositions may be found in U.S. Provisional Application Nos. 62/901,169 and 62/943,754, and PCT Application No. US20/50902, which are incorporated herein by reference in their entireties.

In some embodiments, a hydrolysis method may include raising or lowering the pH of a proteinaceous suspension, e.g., a suspension of microbial biomass, thereby producing an alkaline or acidic suspension, respectively. The starting biomass suspension may include a suitable amount of the biomass in liquid, for example, microbial biomass or the microbial cell mass in a growth medium. In some embodiments, the amount of the biomass, dried weight/reaction volume, is at least about 0.01%, at least about 0.2%, at least about 0.5%, at least about 1%, at least about 2%, or at least about 3%, or about 0.1% to about 8%, e.g., about 0.2% to about 8%, about 0.5% to about 6%, about 1% to about 6%, about 2% to about 6%, including about 3% to about 5%.

In some embodiments, cells within the biomass are subjected to lysis at the beginning of the process, e.g., prior to raising or lowering the pH, to facilitate harvesting the protein from the biomass into a suspension composition.

In certain embodiments, the alkaline or acidic suspension may be subjected to heat for a suitable amount of time, to generate a protein hydrolysate composition. The suspension may be concentrated, dried (e.g., lyophilized), or utilized directly as a liquid suspension. In certain embodiments, the alkaline or acidic suspension is subjected to heat and elevated pressure, e.g., by autoclaving the alkaline or acidic suspension, to generate a protein hydrolysate composition. In some embodiments, the suspension is neutralized with buffer to lower or raise the pH after the heat or heat/pressure treatment. In certain embodiments, the pH is lowered (for an alkaline suspension) or raised (for an acidic suspension) sufficiently to allow subsequent enzymatic treatment of the suspension with a hydrolytic enzyme, such as a protease (e.g., alkaline protease, acid protease, or metalloprotease). After enzymatic hydrolysis, a protein hydrolysate composition is produced. In other embodiments, the biomass suspension is hydrolyzed with a proteolytic enzyme, such as a protease (e.g., alkaline protease, acid protease, or metalloprotease), without prior alkaline or acid treatment.

In certain embodiments, the hydrolyzed protein in the protein hydrolysate is predominantly in the soluble fraction of the suspension. The resulting suspension may be clarified, e.g., by centrifuge, to obtain a supernatant fraction, which contains hydrolyzed protein. In some embodiments, the hydrolytic treatment (e.g., alkaline or acid hydrolysis, optionally including enzymatic (e.g., protease) treatment or enzymatic hydrolysis alone) is followed by clarification of the suspension (hydrolysate) to remove undissolved material in the suspension, e.g., separation of soluble and insoluble fractions. The suspension may be clarified using any suitable method, such as centrifugation, filtration, etc. In some embodiments, after the suspension is clarified, e.g., centrifuged, the supernatant may be separated from the pellet.

In some embodiments, the clarified liquid composition (e.g., soluble fraction, such as supernatant of separated suspension), which contains hydrolyzed protein, is dried, e.g., lyophilized to produce a dry or substantially dry composition. In some embodiments, the lyophilized composition has a water content of about 10% or less, e.g., about 8% or less, about 6% or less, about 5% or less, including about 3% or less. In some embodiments, the lyophilized protein hydrolysate composition has a water content from about 1% to about 10%, e.g., about 1% to about 8%, about 1% to about 6%, including about 2% to about 5%.

In some embodiments, the clarified liquid composition (e.g., soluble fraction, such as supernatant of separated suspension) is dewatered or concentrated to lower the water content. In some embodiments, the concentrated composition has a water content of about 80% or less, e.g., about 75% or less, about 50% or less, about 40% or less, including about 30% or less; and in some embodiments, each of the foregoing water content ranges may be at least about 20%, at least about 25%, at least about 30%, at least about 40%, or at least about 50% (to the extent such foregoing ranges exceed such lower limits). In some embodiments, the dewatered product is dried, e.g., using heat and/or evaporation, employing a method such as, but not limited to, one or more of spray drying; drum drying; oven drying; vacuum drying; vacuum oven drying; drying under an inert gas such as N₂; and solar evaporation. In some embodiments, the clarified product is dewatered initially with a rotary evaporator, e.g., such that about 50% to about 65% of the moisture is removed. In some embodiments, further dewatering is achieved by lyophilization, e.g., such that the lyophilized protein hydrolysate composition has a water content from about 1% to about 10%, e.g., about 1% to about 8%, about 1% to about 6%, including about 2% to about 5%.

In some embodiments, at least a portion or all of the protein from which a protein hydrolysate is produced (e.g., single cell protein, cell lysate, protein isolate, and/or protein concentrate) is from a Cupriavidus microorganism, such as, but not limited to, Cupriavidus necator, e.g., DSM 531 or DSM 541. In some embodiments, a protein hydrolysate composition (e.g., containing peptides, oligopeptides, and/or free amino acids) is derived from protein from a Cupriavidus microorganism, such as, but not limited to, Cupriavidus necator, e.g., DSM 531 or DSM 541.

In some embodiments, at least a portion or all of the protein from which a protein hydrolysate is produced (e.g., single cell protein, cell lysate, protein isolate, and/or protein concentrate) is from a lactic acid bacterium, such as, but not limited to a Lactococcus, Lactobacillus, Enterococcus, Streptococcus, or Pediococcus bacterium. In some embodiments, a protein hydrolysate composition (e.g., containing peptides, oligopeptides, and/or free amino acids) is derived from protein from a lactic acid bacterium, such as, but not limited to, a Lactococcus, Lactobacillus, Enterococcus, Streptococcus, or Pediococcus bacterium. In some embodiments, the lactic acid bacterium is a GRAS bacterium.

In some embodiments, at least a portion or all of the protein from which a protein hydrolysate is produced (e.g., single cell protein, cell lysate, protein isolate, and/or protein concentrate) is from a Fusarium or Rhizopus fungal microorganism, such as but not limited to, Fusarium venenatum, Rhizopus oligosporus, or Rhizopus oryzae. In some embodiments, a protein hydrolysate composition (e.g., containing peptides, oligopeptides, and/or free amino acids) is derived from protein from a Fusarium or Rhizopus fungal microorganism, such as but not limited to, Fusarium venenatum, Rhizopus oligosporus, or Rhizopus oryzae.

In some embodiments, protein hydrolysates herein include peptides that comprise or consist of peptides that are of a size range that is typically non-allergenic, e.g., non-allergenic to humans. In some embodiments, protein hydrolysates that are incorporated into food compositions as described herein include peptides and free amino acids, wherein the peptides are of a size range that is typically non-allergenic. In some embodiments, non-allergenic peptides are of a size range that is about 800 to about 1500 Da average molecular weight distribution. For example, peptides obtained by protein hydrolysis as described herein may be less than any of about 1500, 1400, 1300, 1200, 1100, 1000, 900, or 800 Da average molecular weight.

In some embodiments, salts are removed from protein hydrolysates (for example, where acid or alkaline salts are used for hydrolysis), prior to incorporation of the hydrolysate into a food composition as described herein. For example, the protein hydrolysate may be purified by filtration (e.g., ultrafiltration) or dialysis to remove salts and/or other impurities.

### Microorganisms

Proteinaceous material (protein product) used in the methods and incorporated into the compositions described herein is derived from one or more microorganisms. The microbial organisms from which single cell protein, cell lysate, protein isolate, protein hydrolysate, free amino acids, peptides, oligopeptides, or combinations thereof is derived may be photoautotrophic, heterotrophic, methanotrophic, methylotrophic, carboxydotrophic or chemoautotrophic organisms. In some embodiments, the microbial organisms include oxyhydrogen microorganism. The microbial organisms may be wild-type, or may be genetically modified (e.g., recombinant), or a combination thereof.

The microbial biomass or the microbial cell mass may be collected from a culture of one or more suitable microorganisms, e.g., in a fermenter or bioreactor. Biomass may be collected using any suitable method, such as a centrifuge, to separate the cell mass from the culture medium. In some embodiments, the collected biomass may be used to produce a protein hydrolysate composition. In some embodiments, the collected biomass is spray dried or lyophilized to generate a dry biomass, which then may be used as an ingredient for production of a food composition as described herein or to produce a protein hydrolysate composition. In some embodiments, a protein product (e.g., single cell protein, cell lysate, protein concentrate, protein-containing extract, protein isolate, protein hydrolysate, free amino acids, peptides, oligopeptides, or combinations thereof) is produced from the collected biomass.

In some embodiments, the microorganisms or protein product thereof includes a strain within the genus Cupriavidus or Ralstonia or Hydrogenobacter. In some embodiments, the microorganisms include the species Cupriavidus necator or Cupriavidus metallidurans. In some embodiments, the microorganisms include a strain of the species Cupriavidus necator DSM 531 or DSM 541. In some embodiments, the microorganisms include the species Cupriavidus metallidurans. In some embodiments, the microorganisms include a strain of the species Cupriavidus metallidurans DSM 2839.

In some embodiments, the microorganisms or protein product thereof includes a strain within the genus Xanthobacter. In some embodiments, the microorganisms include the species Xanthobacter autotrophicus. In some embodiments, the microorganisms include a strain of the species Xanthobacter autotrophicus DSM 432.

In some embodiments, the microorganisms or protein product thereof includes a Rhodococcus or Gordonia microorganism. In some embodiments, the microorganisms include Rhodococcus opacus. In some embodiments, the microorganisms include Rhodococcus opacus (DSM 43205) or Rhodococcus sp. (DSM 3346). In some embodiments, the microorganisms include Rhodococcus opacus; Hydrogenovibrio marinus; Rhodopseudomonas capsulata; Hydrogenobacter thermophilus; or Rhodobacter sphaeroides. In some embodiments, the microorganisms include a strain within the family burkholderiaceae.

In some embodiments, the microorganisms or protein product thereof includes a lactic acid bacterium, such as, but not limited to a Lactococcus, Lactobacillus, Enterococcus, Streptococcus, or Pediococcus bacterium. In some embodiments, the lactic acid bacterium is a GRAS bacterium.

In some embodiments, the microorganisms or protein product thereof includes a Fusarium or Rhizopus fungal microorganism, such as but not limited to, Fusarium venenatum, Rhizopus oligosporus, or Rhizopus oryzae. In some embodiments, the fungal microorganism is a GRAS microorganism.

In some embodiments, a consortium of microorganisms (i.e., two or more microorganisms grown together) is used as a source of protein product in the methods and compositions described herein. The consortium may include one or more of any of the microorganism species or strains described herein or one or more microorganisms having one or more microorganism traits described herein. In some embodiments, the consortium includes two or more of any of the microorganism species or strains or microorganisms described herein or two or more microorganisms having one or more microorganism traits described herein.

In some embodiments, a microorganism as described herein can accumulate protein to about 50% or more of the total cell mass by weight. In some embodiments, a microorganism as described herein can accumulate protein to about 60% or more of the total cell mass by weight. In some embodiments, the microorganism can accumulate protein to about 70% or more of the total cell mass by weight. In some embodiments, the microorganism can accumulate protein to about 80% or more of the total cell mass by weight. In some non-limiting embodiments, the microorganism exhibiting these traits is Cupriavidus necator, e.g., Cupriavidus necator DSM 531 or DSM 541.

In some embodiments, a microorganism as described herein can naturally grow on H₂/CO₂ and/or syngas and/or producer gas. In some embodiments, the microorganism can naturally accumulate polyhydroxyalkanoate (PHA) (e.g., polyhydroxybutyrate (PHB)) to about 50% or more of the cell biomass by weight. In some embodiments, the microorganism has a native ability to direct a high flux of carbon through the acetyl-CoA metabolic intermediate, which can lead into fatty acid biosynthesis, along with a number of other synthetic pathways, for example, PHA, e.g., PHB, synthesis, and/or amino acid biosynthesis. In some embodiments, the microorganism exhibiting these traits is Cupriavidus necator, e.g., Cupriavidus necator DSM 531 or DSM 541). In some embodiments, the microorganism does not produce and/or accumulate PHA (e.g., PHB).

In some nonlimiting embodiments, the microorganisms or protein product thereof includes Corynebacterium autotrophicum. In some nonlimiting embodiments, the microorganisms include Corynebacterium autotrophicum and/or Corynebacterium glutamicum. In some embodiments, the microorganisms include Hydrogenovibrio marinus. In some embodiments, the microorganisms include Rhodopseudomonas capsulata, Rhodopseudomonas palustris, or Rhodobacter sphaeroides.

In some embodiments, the microorganisms or protein product thereof includes one or more of the following genera: Cupriavidus, Rhodococcus, Hydrogenovibrio, Rhodopseudomonas, Hydrogenobacter, Gordonia, Arthrobacter, Streptomycetes, Rhodobacter, and/or Xanthobacter.

In some embodiments, the microorganisms or protein product thereof includes a microorganism of the class Actinobacteria. In some embodiments, the microorganisms include a microorganism of the suborder corynebacterineae (corynebacterium, gordoniaceae, mycobacteriaceae and nocardiaceae). In some embodiments, the microorganisms include a microorganism of the family of Nocardiaceae. In some embodiments, the microorganisms include a microorganism drawn from one or more of the following classifications: Corynebacterium, Gordonia, Rhodococcus, Mycobacterium and Tsukamurella. In some embodiments, the microorganisms include a microorganism of the genus Rhodococcus, such as Rhodococcus opacus, Rhodococcus aurantiacus; Rhodococcus baikonurensis; Rhodococcus boritolerans; Rhodococcus equi; Rhodococcus coprophilus; Rhodococcus corynebacterioides; Nocardia corynebacterioides (synonym: Nocardia corynebacterioides); Rhodococcus erythropolis; Rhodococcus fascians; Rhodococcus globerulus; Rhodococcus gordoniae; Rhodococcus jostii; Rhodococcus koreensis; Rhodococcus kroppenstedtii; Rhodococcus maanshanensis; Rhodococcus marinonascens; Rhodococcus opacus; Rhodococcus percolatus; Rhodococcus phenolicus; Rhodococcus polyvorum; Rhodococcus pyridinivorans; Rhodococcus rhodochrous; Rhodococcus rhodnii; (synonym: Nocardia rhodnii); Rhodococcus ruber (synonym: Streptothrix rubra); Rhodococcus sp. RHA1; Rhodococcus triatomae; Rhodococcus tukisamuensis; Rhodococcus wratislaviensis (synonym: Tsukamurella wratislaviensis); Rhodococcus yunnanensis; or Rhodococcus zopfii. In some embodiments, the microorganisms include Rhodococcus opacus strain DSM 43205 or DSM 43206. In some embodiments, the microorganisms include strain Rhodococcus sp. DSM 3346.

In some embodiments, the microorganisms or protein product thereof includes a microorganism (e.g., a microorganism of any of the microorganism genera or species described herein) that can naturally grow on H₂/CO₂ and/or syngas and/or producer gas, and that can naturally accumulate lipid to at least about 10%, 20%, 30%, 40%, 50%, 60%, 70%, 80%, or more of the cell biomass by weight. In some embodiments, the microorganisms include a microorganism (e.g., a microorganism of any of the microorganism genera or species described herein) that has a native ability to send a high flux of carbon down the fatty acid biosynthesis pathway. In some embodiments, the microorganism exhibiting these traits is Rhodococcus opacus (e.g., Rhodococcus opacus DSM 43205 or DSM 43206 or DSM 44193) or Cupriavidus necator (e.g., Cupriavidus necator DSM 531 or DSM 541).

In some embodiments, the microorganisms or protein product thereof include an oxyhydrogen or knallgas strain. In some embodiments, the microorganisms include one or more of the following knallgas microorganisms: Aquifex pyrophilus, Aquifex aeolicus, or other Aquifex sp.; Cupriavidus necator or Cupriavidus metallidurans or other Cupriavidus sp.; Corynebacterium autotrophicum or other Corynebacterium sp.; Gordonia desulfuricans, Gordonia polyisoprenivorans, Gordonia rubripertincta, Gordonia hydrophobica, Gordonia westfalica, or other Gordonia sp.; Nocardia autotrophica, Nocardia opaca, or other Nocardia sp.; purple non-sulfur photosynthetic bacteria, including but not limited to, Rhodobacter sphaeroides, Rhodopseudomonas palustris, Rhodopseudomonas capsulata, Rhodopseudomonas viridis, Rhodopseudomonas sulfoviridis, Rhodopseudomonas blastica, Rhodopseudomonas spheroides, Rhodopseudomonas acidophila, or other Rhodopseudomonas sp.; Rhodobacter sp., Rhodospirillum rubrum, or other Rhodospirillum sp.; Rhodococcus opacus or other Rhodococcus sp.; Rhizobium japonicum or other Rhizobium sp.; Thiocapsa roseopersicina or other Thiocapsa sp.; Pseudomonas facilis, Pseudomonas flava, Pseudomonas putida, Pseudomonas hydrogenovora, Pseudomonas hydrogenothermophila, Pseudomonas palleronii, Pseudomonas pseudoflava, Pseudomonas saccharophila, Pseudomonas thermophile, or other Pseudomonas sp.; Hydrogenomonas pantotropha, Hydrogenomonas eutropha, Hydrogenomonas facilis, or other Hydrogenomonas sp.; Hydrogenobacter thermophiles, Hydrogenobacter halophilus, Hydrogenobacter hydrogenophilus, or other Hydrogenobacter sp.; Hydrogenophilus islandicus or other Hydrogenophilus sp.; Hydrogenovibrio marinus or other Hydrogenovibrio sp.; Hydrogenothermus marinus or other Hydrogenothermus sp.; Helicobacter pylori or other Helicobacter sp.; Xanthobacter autotrophicus, Xanthobacter flavus, or other Xanthobacter sp.; Hydrogenophaga flava, Hydrogenophaga palleronii, Hydrogenophaga pseudoflava, or other Hydrogenophaga sp.; Bradyrhizobium japonicum or other Bradyrhizobium sp.; Ralstonia eutropha or other Ralstonia sp.; Alcaligenes eutrophus, Alcaligenes facilis, Alcaligenes hydrogenophilus, Alcaligenes latus, Alcaligenes paradoxus, Alcaligenes ruhlandii, or other Alcaligenes sp.; Amycolata sp.; Aquaspirillum autotrophicum or other Aquaspirillum sp.; Arthrobacter strain 11/X, Arthrobacter methylotrophus, or other Arthrobacter sp.; Azospirillum lipoferum or other Azospirillum sp.; Variovorax paradoxus or other Variovorax sp.; Acidovorax facilis, or other Acidovorax sp.; Bacillus schlegelii, Bacillus tusciae, other Bacillus sp.; Calderobacterium hydrogenophilum or other Calderobacterium sp.; Derxia gummosa or other Derxia sp.; Flavobacterium autothermophilum or other Flavobacterium sp.; Microcyclus aquaticus or other Microcyclus sp.; Mycobacterium gordoniae or other Mycobacterium sp.; Paracoccus denitrificans or other Paracoccus sp.; Persephonella marina, Persephonella guaymasensis, or other Persephonella sp.; Renobacter vacuolatum or other Renobacter sp.; Seliberia carboxydohydrogena or other Seliberia sp., Streptomycetes coelicoflavus, Streptomycetes griseus, Streptomycetes xanthochromogenes, Streptomycetes thermocarboxydus, and other Streptomycetes sp.; Thermocrinis ruber or other Thermocrinis sp.; Wautersia sp.; cyanobacteria including but not limited to Anabaena oscillarioides, Anabaena spiroides, Anabaena cylindrica, or other Anabaena sp., and Arthrospira platensis, Arthrospira maxima, or other Arthrospira sp.; green algae including but not limited to Scenedesmus obliquus or other Scenedesmus sp., Chlamydomonas reinhardii or other Chlamydomonas sp., Ankistrodesmus sp., and Rhaphidium polymorphium or other Rhaphidium sp. In some embodiments, a consortium of microorganisms that includes an oxyhydrogen microorganism, such as any of the above oxyhydrogen microorganisms, is used for production of protein product as described herein.

In some embodiments, the microorganisms or protein product thereof includes one or more of the following genera: Cupriavidus; Xanthobacter, Dietzia; Gordonia; Mycobacterium; Nocardia; Pseudonocardia; Arthrobacter, Alcanivorax; Rhodococcus; Streptomyces; Rhodopseudomonas; Rhodobacter, and Acinetobacter, or a consortium of microorganisms that includes one or more of these microorganism genera.

In some embodiments, the microorganisms or protein product thereof includes one or more of the following: Arthrobacter methylotrophus DSM 14008; Rhodococcus opacus DSM 44304; Rhodococcus opacus DSM 44311; Xanthobacter autotrophicus DSM 431; Rhodococcus opacus DSM 44236; Rhodococcus ruber DSM 43338; Rhodococcus opacus DSM 44315; Cupriavidus metallidurans DSM 2839; Cupriavidus necator DSM 531; Cupriavidus necator DSM 541; Rhodococcus aetherivorans DSM 44752; Gordonia desulfuricans DSM 44462; Gordonia polyisoprenivorans DSM 44266; Gordonia polyisoprenivorans DSM 44439; Gordonia rubripertincta DSM 46039; Rhodococcus percolatus DSM 44240; Rhodococcus opacus DSM 43206; Gordonia hydrophobica DSM 44015; Rhodococcus zopfii DSM 44189; Gordonia westfalica DSM 44215, Xanthobacter autotrophicus DSM 1618; Xanthobacter autotrophicus DSM 2267; Xanthobacter autotrophicus DSM 3874; Streptomycetes coelicoflavus DSM 41471; Streptomycetes griseus DSM 40236; Streptomycetes sp. DSM 40434; Streptomycetes xanthochromogenes DSM 40111; Streptomycetes thermocarboxydus DSM 44293; Rhodobacter sphaeroides DSM 158. In some embodiments, the microorganisms or protein product thereof includes a consortium of microorganisms that includes one or more of these microorganism strains, or one or more of any of the microorganism genera or species disclosed herein.

A number of different microorganisms have been characterized that are capable of growing on carbon monoxide as an electron donor and/or carbon source (i.e., carboxydotrophic microorganisms). In some cases, carboxydotrophic microorganisms can also use H₂ as an electron donor and/or grow mixotrophically. In some cases, the carboxydotrophic microorganisms are facultative chemolithoautotrophs [Biology of the Prokaryotes, edited by J Lengeler, G. Drews, H. Schlegel, John Wiley & Sons, Jul. 10, 2009, which is incorporated herein by reference in its entirety]. In some embodiments, the microorganisms or protein product thereof includes one or more of the following carboxydotrophic microorganisms: Acinetobacter sp.; Alcaligenes carboxydus or other Alcaligenes sp.; Arthrobacter sp.; Azomonas sp.; Azotobacter sp.; Bacillus schlegelii or other Bacillus sp.; Hydrogenophaga pseudoflava or other Hydrogenophaga sp.; Pseudomonas carboxydohydrogena, Pseudomonas carboxydovorans, Pseudomonas compransoris, Pseudomonas gazotropha, Pseudomonas thermocarboxydovorans, or other Pseudomonas sp.; Rhizobium japonicum or other Rhizobium sp.; and Streptomyces G26, Streptomyces thermoautotrophicus, or other Streptomyces sp. In some embodiments, the microorganisms or protein product thereof includes a consortium of microorganisms that includes carboxydotrophic microorganisms, such as one or more of the above carboxydotrophic microorganisms. In certain embodiments, a carboxydotrophic microorganism that is capable of chemolithoautotrophy is used. In certain embodiments, a carboxydotrophic microorganism that is able to utilize H₂ as an electron donor in respiration and/or biosynthesis is used.

In some embodiments, the microorganisms or protein product thereof includes obligate and/or facultative chemoautotrophic microorganisms, such as one or more of the following: Acetoanaerobium sp.; Acetobacterium sp.; Acetogenium sp.; Achromobacter sp.; Acidianus sp.; Acinetobacter sp.; Actinomadura sp.; Aeromonas sp.; Alcaligenes sp.; Alcaliqenes sp.; Aquaspirillum sp.; Arcobacter sp.; Aureobacterium sp.; Bacillus sp.; Beggiatoa sp.; Butyribacterium sp.; Carboxydothermus sp.; Clostridium sp.; Comamonas sp.; Cupriavidus sp.; Dehalobacter sp.; Dehalococcoide sp.; Dehalospirillum sp.; Desulfobacterium sp.; Desulfomonile sp.; Desulfotomaculum sp.; Desulfovibrio sp.; Desulfurosarcina sp.; Ectothiorhodospira sp.; Enterobacter sp.; Eubacterium sp.; Ferroplasma sp.; Halothibacillus sp.; Hydrogenobacter sp.; Hydrogenomonas sp.; Leptospirillum sp.; Metallosphaera sp.; Methanobacterium sp.; Methanobrevibacter sp.; Methanococcus sp.; Methanococcoides sp.; Methanogenium sp.; Methanolobus sp.; Methanomicrobium sp.; Methanoplanus sp.; Methanosarcina sp.; Methanospirillum sp.; Methanothermus sp.; Methanothrix sp.; Micrococcus sp.; Nitrobacter sp.; Nitrobacteraceae sp., Nitrococcus sp., Nitrosococcus sp.; Nitrospina sp., Nitrospira sp., Nitrosolobus sp.; Nitrosomonas sp.; Nitrosospira sp.; Nitrosovibrio sp.; Nitrospina sp.; Oleomonas sp.; Paracoccus sp.; Peptostreptococcus sp.; Planctomycetes sp.; Pseudomonas sp.; Ralstonia sp.; Rhodobacter sp.; Rhodococcus sp.; Rhodocyclus sp.; Rhodomicrobium sp.; Rhodopseudomonas sp.; Rhodospirillum sp.; Shewanella sp.; Siderococcus sp.; Streptomyces sp.; Sulfobacillus sp.; Sulfolobus sp.; Thermothrix sp., Thiobacillus sp.; Thiomicrospira sp.; Thioploca sp.; Thiosphaera sp.; Thiothrix sp.; Thiovulum sp.; sulfur-oxidizers; hydrogen-oxidizers; iron-oxidizers; acetogens; and methanogens; consortiums of microorganisms that include chemoautotrophs; chemoautotrophs native to at least one of hydrothermal vents, geothermal vents, hot springs, cold seeps, underground aquifers, salt lakes, saline formations, and soils; and extremophiles selected from one or more of thermophiles, hyperthermophiles, acidophiles, halophiles, and psychrophiles. In some embodiments, the microorganisms, or protein product thereof includes a consortium of microorganisms that includes chemoautotrophic microorganisms, such as one or more of the above chemoautotrophic microorganisms.

In some embodiments, the microorganisms or protein product thereof include extremophiles that can withstand extremes in various environmental parameters, such as temperature, radiation, pressure, gravity, vacuum, desiccation, salinity, pH, oxygen tension, and/or chemicals. Such microorganisms include hyperthermophiles, such as Pyrolobus fumarii; thermophiles, such as Synechococcus lividis; mesophiles and psychrophiles, such as Psychrobacter, and/or extremely thermophilic sulfur-metabolizers such as Thermoproteus sp., Pyrodictium sp., Sulfolobus sp., and Acidianus sp.; radiation tolerant organisms such as Deinococcus radiodurans; pressure tolerant microorganisms including piezophiles or barophiles; desiccant tolerant and anhydrobiotic microorganisms including xerophiles, such as Artemia salina; microbes and fungi; salt tolerant microorganisms including halophiles, such as Halobacteriacea and Dunaliella salina; pH tolerant microorganisms including alkaliphiles, such as Natronobacterium, Bacillus firmus OF4, Spirulina spp., and acidophiles such as Cyanidium caldarium and Ferroplasma sp; gas tolerant microorganisms, e.g., tolerant to pure CO₂, including Cyanidium caldarium; and metal tolerant microorganisms (metalotolerants), such as Ferroplasma acidarmanus and Ralstonia sp.

In certain embodiments, the microorganisms, or protein product thereof, include a cell line selected from eukaryotic plants, algae, cyanobacteria, green-sulfur bacteria, green non-sulfur bacteria, purple sulfur bacteria, purple non-sulfur bacteria, extremophiles, yeast, fungi, proteobacteria, engineered organisms thereof, and synthetic organisms. In certain embodiments, Spirulina is utilized.

In certain embodiments, the microorganisms or protein product thereof includes green non-sulfur bacteria, which include but are not limited to the following genera: Chloroflexus, Chloronema, Oscillochloris, Heliothrix, Herpetosiphon, Roseiflexus, and Thermomicrobium.

In certain embodiments, the microorganisms or protein product thereof includes green sulfur bacteria, which include but are not limited to the following genera: Chlorobium, Clathrochloris, and Prosthecochloris.

In certain embodiments, the microorganisms or protein product thereof includes purple sulfur bacteria, which include but are not limited to the following genera: Allochromatium, Chromatium, Halochromatium, Isochromatium, Marichromatium, Rhodovulum, Thermochromatium, Thiocapsa, Thiorhodococcus, and Thiocystis.

In certain embodiments, the microorganisms or protein product thereof includes purple non-sulfur bacteria, which include but are not limited to the following genera: Phaeospirillum, Rhodobaca, Rhodobacter, Rhodomicrobium, Rhodopila, Rhodopseudomonas, Rhodothalassium, Rhodospirillum, Rodovibrio, and Roseospira.

In some embodiments, the microorganisms or protein product thereof include a methanotroph and/or a methylotroph. In some embodiments, the microorganism is in the genus Methylococcus. In some embodiments, the microorganism is Methylococcus capsulatus. In some embodiments, the microorganism is a methylotroph. In some embodiments, the microorganism is in the genus Methylobacterium. In some embodiments, the microorganisms include one or more of the following species: Methylobacterium zatmanii; Methylobacterium extorquens; Methylobacterium chloromethanicum.

In some embodiments, the microorganisms or protein product thereof a hydrogen-oxidizing chemoautotroph and/or a carboxydotroph and/or a methylotroph and/or methanotroph.

In certain embodiments, the microorganisms or protein product thereof includes microorganisms that can grow heterotrophically, utilizing multi-carbon organic molecules as carbon sources, such as, but not limited to sugars, for example, but not limited to, glucose and/or fructose. In some embodiments, the microorganism is capable of growing on untreated crude glycerol and/or glucose and/or methanol and/or acetate as the sole electron donor(s) and carbon source(s). In some embodiments, the microorganism is able to grow mixotrophically, for example, mixotrophic growth on an organic carbon source and an inorganic energy source (e.g., inorganic electron donor).

In certain embodiments, the microorganisms or protein product thereof includes one or more of eukaryotic plants, algae, cyanobacteria, green-sulfur bacteria, green non-sulfur bacteria, purple sulfur bacteria, purple non-sulfur bacteria, extremophiles, archaea, yeast, fungi, proteobacteria, engineered organisms thereof, and synthetic organisms.

In some embodiments, the microorganisms comprise or consist of gram-positive bacteria. In other embodiments, the microorganisms comprise or consist of gram-negative bacteria.

In certain embodiments, the microorganisms or protein product thereof includes naturally occurring and/or non-genetically modified (non-GMO) microorganisms and/or non-pathogenic and/or are grown in specific environmental conditions provided by the bioprocesses that are absent from the natural surrounding environment.

In certain embodiments, the microorganisms or consortium of microorganisms are isolated from environmental samples and enriched with desirable microorganisms using methods known in the art of microbiology, for example, growth in the presence of targeted electron donors, including, but not limited to, one or more of: H₂, CO, syngas and/or methane, and/or electron acceptors including, but not limited to, one or more of O₂, nitrate, ferric iron, and/or CO₂, and/or environmental conditions (e.g., temperature, pH, pressure, dissolved oxygen (DO), salinity, the presence of various impurities and pollutants, etc.).

In certain embodiments, the microorganisms or consortium of microorganisms include probiotic microorganisms. In certain embodiments, the microorganisms or consortium of microorganisms include “generally recognized as safe” (GRAS) microorganisms, e.g., bacterial and/or fungal GRAS microorganisms. In certain embodiments, the microorganisms or consortium of microorganisms include yeast, such as, but not limited to, one or more of the following: Candida humilis; Candida milleri, Debaryomyces hansenii, Kazachstania exigua (Saccharomyces exiguous); Saccharomyces cerevisiae; Saccharomyces florentinus; Torulaspora delbrueckii, Trichosporon beigelli, and/or include fungi, such as, but not limited to, one or more of the following: Aspergillus oryzae; Aspergillus sojae; Fusarium venenatum A3/5; Neurospora intermedia var. oncomensis; Rhizopus oligosporus; Rhizopus oryzae; Aspergillus luchuensis; and/or include bacteria, such as, but not limited to, I one or more of the following: Bacillus amyloliquefaciens; Bacillus subtilis; Bifidobacterium animalis (lactis); Bifidobacterium bifidum; Bifidobacterium breve; Bifidobacterium longum; Lactobacillus acidophilus; Lactobacillus brevis; Lactobacillus casei; Lactobacillus delbrueckii subsp. Bulgaricus; Lactobacillus fermentum; Lactobacillus helveticus; Lactobacillus kefiranofaciens; Lactobacillus lactis; Lactobacillus plantarum; Lactobacillus rhamnosus; Lactobacillus reuteri; Lactobacillus sakei, Lactobacillus sanfranciscensis; Lactococcus lactis(Streptococcus lactis, Streptococcus lactis subsp. Diacetylactis); Leuconostoc; Leuconostoc carnosum; Leuconostoc cremoris; Leuconostoc mesenteroides; Pediococcus; Propionibacterium freudenreichii, Arthrospira (Spirulina) platensis; Streptococcus faecalis; Streptococcus thermophilus.

The protein containing biomass from which the protein product is derived may be produced by a consortium of different species of microorganisms. The consortium may optionally include multi-cellular organisms. In some embodiments, the consortium includes one or more of: an oxyhydrogen microorganism; a carboxydotroph; a methanotroph; a methylotroph; a chemoautotroph; a photoautotroph; and a heterotroph.

In some embodiments, the protein product also includes one or more vitamin produced by the microorganisms from which the protein product was derived. In some non-limiting embodiments, the microorganisms include Cupriavidus necator (e.g., Cupriavidus necator DSM 531 or Cupriavidus necator DSM 541). In some non-limiting embodiments, the vitamin is a B vitamin, including but not limited to, vitamin B1, B2, and/or B12. In a non-limiting example, the B vitamin (e.g., B1, B2, and/or B12) may be produced by Cupriavidus necator (e.g., Cupriavidus necator DSM 531 or Cupriavidus necator DSM 541). In some embodiments, the protein product includes one or more mineral from the mciroorganisms from which the protein product was derived, such as iron.

### Microbial Cultures

Any suitable methods may be used to culture the microorganisms. The microorganism may be grown under any suitable conditions, in an environment that is suitable for growth and production of biomass. In some embodiments, the microorganism may be grown in autotrophic culture conditions, heterotrophic culture conditions, or a combination of autotrophic and heterotrophic culture conditions. A heterotrophic culture may include a suitable source of carbon and energy, such as one or more sugar (e.g., glucose, fructose, etc.). An autotrophic culture may include C1 chemicals such as carbon monoxide, carbon dioxide, methane, methanol, formate, and/or formic acid, and/or mixtures containing C1 chemicals, including, but not limited to various syngas compositions or various producer gas compositions, e.g., generated from low value sources of carbon and energy, such as, but not limited to, lignocellulosic energy crops, crop residues, bagasse, saw dust, forestry residue, or food, through the gasification, partial oxidation, pyrolysis, or steam reforming of said low value carbon sources, that can be used by an oxyhydrogen microorganism or hydrogen-oxidizing microorganism or carbon monoxide oxidizing microorganism as a carbon source and an energy source. Suitable ways of culturing the microorganisms and generating a biomass for use in the present methods are described, e.g., in PCT Application Nos. PCT/US2010/001402, PCT/US2011/034218, PCT/US2013/032362, PCT/US2014/029916, PCT/US2017/023110, PCT/US2018/016779, and U.S. Pat. No. 9,157,058, each of which is hereby incorporated by reference herein in its entirety. In some embodiments, the organism may be grown photosynthetically in a bioreactor, in a hydroponics system, in a greenhouse, or in a cultivated field, or may be collected from waste or natural sources. Nonlimiting examples of bioreactors that may be used to culture microorganisms as described herein are described in PCT/US22/29657, filed on May 17, 2022, which is incorporated by reference herein in its entirety.

The liquid cultures used to grow microorganism cells described herein can be housed in culture vessels known and used in the art. In some embodiments, large scale production in a bioreactor vessel can be used to produce large quantities of a desired molecule and/or biomass.

In certain embodiments, bioreactor vessels are used to contain, isolate, and/or protect the culture environment. The culture vessels include those that are known to those of ordinary skill in the art of large scale microbial culturing. Such culture vessels include but are not limited to one or more of the following: airlift reactors; biological scrubber columns; bubble columns; stirred tank reactors; continuous stirred tank reactors; counter-current, upflow, expanded-bed reactors; digesters and in particular digester systems, for example, such known in the art of bioremediation; filters including but not limited to trickling filters, rotating biological contactor filters, rotating discs, soil filters; fluidized bed reactors; gas lift fermenters; immobilized cell reactors; loop reactors; membrane biofilm reactors; pachuca tanks; packed-bed reactors; plug-flow reactors; static mixers; trickle bed reactors; and/or vertical shaft bioreactors.

Microbial culturing aimed at the commercial production of biomass and/or organic compounds, e.g., protein product as described herein, specifically single cell protein, cell lysate protein concentrate, protein-containing extract, protein isolate, protein hydrolysate, free amino acids, peptides, oligopeptides, or combinations thereof, and/or other nutrients, such as, but not limited to vitamins (e.g., B vitamins, for example, B1, B2, and/or B12) may be performed in bioreactors at large scale (e.g., 500 L, 1,000 L 5,000 L, 10,000 L, 50,000 L, 100,000 L, 1,000,000 L bioreactor volumes and higher). In some embodiments, microbial (e.g., bacterial) cells are grown to high cell density, to facilitate production of a protein product (e.g., protein powder) for incorporation into a structured food product as described herein.

In certain embodiments, chemoautotrophic and/or heterotrophic and/or carboxydotrophic and/or methanotrophic and/or methylotrophic microorganisms are grown in a liquid media inside a bioreactor using methods described herein.

In some embodiments, the bioreactor containing the microorganisms is constructed of opaque materials that keep the culture in near or total darkness. Bioreactors constructed out of opaque materials such as steel and/or other metallic alloys and/or reinforced concrete and/or fiberglass and/or various high strength plastic materials can be designed to have large working volumes. In some embodiments, fermenters constructed of steel or other metallic alloys that are 50,000 liters and greater in volume are utilized. In some embodiments, bioreactors capable of containing positive headspace pressures above ambient pressure are utilized. In some embodiments, egg-shape or cylindrical digesters or vertical shaft bioreactors 3,000,000 liters and greater in volume are utilized. In some embodiments, the bioreactor comprising the microorganism does not allow light to penetrate part or most or all of its contained liquid volume. In certain non-limiting embodiments, the microorganism used in the CO₂-fixation step is not photosynthetic. In certain non-limiting embodiments, the bioreactor design does not confine the culture in thin layers or have transparent walls so as to have light available to all parts, as is generally necessary with photosynthesis. In some embodiments, the microorganism is cultured without significant or any exposure to light. In certain such embodiments, net CO₂ consumption still occurs in the absence of light due to chemoautotrophic metabolism and conditions. In certain embodiments, converting electricity to artificial light is not required in a biological system for CO₂ capture and conversion.

In certain embodiments, the lack of light dependence facilitates continuous CO₂ capture operations, day and night, year-round, in all weather conditions, without the need for any artificial lighting.

In some embodiments, the microorganisms are grown and maintained in a medium containing a gaseous carbon source, such as but not limited to syngas, producer gas, or H₂ and CO₂ gas mixtures, in the absence of light; where such growth is known as chemoautotrophic growth.

In some embodiments, syngas, for example, generated from gasification of organic matter is utilized by the microorganisms for chemoautotrophic growth. The organic matter may be, for example, from an agricultural source (e.g., corn stover, bagasse).

In some embodiments, food grade CO₂ and/or air that goes through a direct air capture unit is utilized by the microorganisms for chemoautotrophic growth. Non-limiting examples of direct air capture may be found in U.S. Publication No. 2017/0106330 and Keith, D., et al. (2018) Joule 2(8): 1573-1594, which are incorporated by reference herein in their entireties. In some embodiments, CO₂ is provided from an industrial source, and optionally may be concentrated via a gas separation procedure, thereby resulting in high concentration food grade CO₂.

In certain embodiments, an increase in system capacity is met by vertical scaling, rather than only scaling horizontally. This is in contrast to phototrophic approaches using algae, cyanobacteria, or higher-plants for CO₂ capture. Although various vertical farming schemes have been proposed for photosynthetic systems, practically and economically speaking, phototrophic systems must expand horizontally, for example in shallow ponds or photobioreactors in the case of algae. This results in large geographic footprints and many negative environmental impacts.

An algal or higher plant system grown with artificial lighting is challenged by inefficient utilization of light energy, and by inefficient conversion of electrical energy to light energy. In certain embodiments, a comparable algal or high-plant culture grown under artificial lighting will require more electrical power than the CO₂ capture and/or biomass production system described herein, in terms of CO₂ capture and/or biomass production. In certain embodiments, a comparable algal or higher-plant culture grown under artificial lighting will require at least ten times more electrical power than the CO₂ capture and/or biomass production system described herein, in terms of power per unit CO₂ capture and/or biomass production. For algae or higher-plants grown on artificial lighting, the heat rejection requirement is almost in direct proportion to the electrical input. In certain embodiments of the methods described herein, the heat rejection requirements are lower than for a comparable algal or higher plant system, in terms of CO₂ capture and/or biomass production when grown on artificial lighting. In certain embodiments, the heat rejection requirements are at least ten times lower than for a comparable algal or higher plant system, in terms of CO₂ capture and/or biomass production when grown on artificial lighting.

In an exemplary but nonlimiting embodiment, a bioreactor containing nutrient medium is inoculated with production cells. Generally, there will follow a lag phase prior to the cells beginning to double. After the lag phase, the cell doubling time decreases and the culture goes into the logarithmic phase. The logarithmic phase is eventually followed by an increase of the doubling time that, while not intending to be limited by theory, is thought to result from either a mass transfer limitation, depletion of nutrients including nitrogen or mineral sources, or a rise in the concentration of inhibitory chemicals, or quorum sensing by the microbes. The growth slows down and then ceases when the culture enters the stationary phase. In certain embodiments, there is an arithmetic growth phase preceding the stationary phase. In order to harvest cell mass, the culture in certain embodiments is harvested in the logarithmic phase and/or in the arithmetic phase and/or in the stationary phase.

The bioreactor or fermenter is used to culture cells through the various phases of their physiological cycle. A bioreactor is utilized for the cultivation of cells, which may be maintained at particular phases in their growth curve. The use of bioreactors is advantageous in many ways for cultivating chemoautotrophic growth. For certain embodiments, protein-rich cell mass, which is used to produce proteins or protein hydrolysates, is grown to high densities in liquid suspension. Generally, the control of growth conditions, including control of dissolved carbon dioxide, oxygen, and other gases such as hydrogen, as well as other dissolved nutrients, trace elements, temperature and pH, is facilitated in a bioreactor. For certain embodiments, protein-rich cell mass, which is used to produce amino acids, peptides, proteins, protein hydrolysates, protein isolates, protein concentrates, or whole cell products, is grown to high densities and/or grown at high productivities, in liquid suspension within a bioreactor.

Nutrient media, as well as gases, can be added to the bioreactor as either a batch addition, or periodically, or in response to a detected depletion or programmed set point, or continuously over the period the culture is grown and/or maintained. For certain embodiments, the bioreactor at inoculation is filled with a starting batch of nutrient media and/or one or more gases at the beginning of growth, and no additional nutrient media and/or one or more gases are added after inoculation. For certain embodiments, nutrient media and/or one or more gases are added periodically after inoculation. For certain embodiments, nutrient media and/or one or more gases are added after inoculation in response to a detected depletion of nutrient and/or gas. For certain embodiments, nutrient media and/or one or more gases are added continuously after inoculation.

For certain embodiments, the added nutrient media does not contain any organic compounds.

In certain embodiments, a small amount of microorganism cells (i.e., an inoculum) is added to a set volume of culture medium; the culture is then incubated; and the cell mass passes through lag, exponential, deceleration, and stationary phases of growth.

In batch culture systems, the conditions (e.g., nutrient concentration, pH, etc.) under which the microorganism is cultivated generally change continuously throughout the period of growth. In certain non-limiting embodiments, to avoid the fluctuating conditions inherent in batch cultures, and to improve the overall productivity of the culture system, the microorganisms that are used for the production of protein and/or vitamins and/or other nutrients are grown in a continuous culture system called a chemostat. In such systems, the culture may be maintained in a perpetual exponential phase of growth by feeding it with fresh medium at a constant rate [F] while at the same time maintaining the volume [V] of the culture constant. In certain embodiments, a continuous culture system ensures that cells are cultivated under environmental conditions that remain roughly constant. In certain embodiments, the cells are maintained in a perpetual exponential phase through the use of a chemostat system. In such a case the dilution rate (D) of the culture equals the growth rate of the microorganism, and is given by: D=F/V. The growth rate of a microorganism in continuous culture may be changed by altering the dilution rate. In certain embodiments, the growth rate of the microorganism is changed by altering the dilution rate. In certain non-limiting embodiments, cells are grown in a chemostat at a dilution rate of around 0.2 h⁻¹.

In certain embodiments, inoculation of the culture into the bioreactor is performed by methods including but not limited to transfer of culture from an existing culture inhabiting another bioreactor, or incubation from a seed stock raised in an incubator. In certain embodiments, the seed stock of the strain may be transported and stored in forms including but not limited to a powder, liquid, frozen, or freeze-dried form as well as any other suitable form, which may be readily recognized by one skilled in the art. In certain non-limiting embodiments, the reserve bacterial cultures are kept in a metabolically inactive, freeze-dried state until required for restart. In certain embodiments, when establishing a culture in a very large reactor, cultures are grown and established in progressively larger intermediate scale vessels prior to inoculation of the full-scale vessel.

For certain embodiments, the bioreactors have mechanisms to enable mixing of the nutrient media that include, but are not limited to, one or more of the following: spinning stir bars, blades, impellers, or turbines; spinning, rocking, or turning vessels; gas lifts, sparging; recirculation of broth from the bottom of the container to the top via a recirculation conduit, flowing the broth through a loop and/or static mixers. The culture media may be mixed continuously or intermittently.

In certain embodiments the microorganism-containing nutrient medium may be removed from the bioreactor partially or completely, periodically or continuously, and in certain embodiments is replaced with fresh cell-free medium to maintain the cell culture in an exponential growth phase, and/or to replenish the depleted nutrients in the growth medium, and/or remove inhibitory waste products.

The ports that are standard in bioreactors may be utilized to deliver, or withdraw, gases, liquids, solids, and/or slurries, into and/or from the bioreactor vessel enclosing the microbes. Many bioreactors have multiple ports for different purposes (e.g., ports for media addition, gas addition, probes for pH and dissolved oxygen (DO), and sampling), and a given port may be used for various purposes during the course of a fermentation run. As an example, a port might be used to add nutrient media to the bioreactor at one point in time, and at another time might be used for sampling. Preferably, the multiple uses of a sampling port can be performed without introducing contamination or invasive species into the growth environment. A valve or other actuator enabling control of the sample flow or continuous sampling can be provided to a sampling port. For certain embodiments, the bioreactors are equipped with at least one port suitable for culture inoculation that can additionally serve other uses including the addition of media or gas. Bioreactor ports enable control of the gas composition and flow rate into the culture environment. For example, the ports can be used as gas inlets into the bioreactor through which gases are pumped.

For some embodiments, gases that may be pumped into a bioreactor include, but not are not limited to, one or more of the following: syngas, producer gas, hydrogen gas, CO, CO₂, O₂, air, air/CO₂ mixtures, natural gas, methane, ammonia, nitrogen, noble gases, such as argon, as well as other gases. In some embodiments the CO₂ pumped into the system may come from sources including, but not limited to: CO₂ from the gasification of organic matter; CO₂ from the calcination of limestone, CaCO₃, to produce quicklime, CaO; CO₂ from methane steam reforming, such as the CO₂ byproduct from ammonia, methanol, or hydrogen production; CO₂ from combustion, incineration, or flaring; CO₂ byproduct of anaerobic or aerobic fermentation of sugar; CO₂ byproduct of a methanotrophic bioprocess; geologically or geothermally produced or emitted CO₂; CO₂ removed from acid gas or natural gas. In certain non-limiting embodiments, the CO₂ has been removed from an industrial flue gas, or intercepted from a geological source that would otherwise naturally emit into the atmosphere. In certain embodiments, the carbon source is CO₂ and/or bicarbonate and/or carbonate dissolved in sea water or other bodies of surface or underground water. In certain such embodiments the inorganic carbon may be introduced to the bioreactor dissolved in liquid water and/or as a solid. In certain embodiments, the carbon source is CO₂ captured from the atmosphere. In certain non-limiting embodiments, the CO₂ has been captured from a closed cabin as part of a closed-loop life support system, using equipment such as but not limited to a CO₂ removal assembly (CDRA), which is utilized, for example, on the International Space Station (ISS).

In certain non-limiting embodiments, geological features such as, but not limited to, geothermal and/or hydrothermal vents that emit high concentrations of energy sources (e.g., H₂, H₂S, CO gases) and/or carbon sources (e.g., CO₂, HCO₃⁻, CO₃²⁻) and/or other dissolved minerals may be utilized as nutrient sources for the microorganisms herein.

In certain embodiments, one or more gases in addition to carbon dioxide, or in place of carbon dioxide as an alternative carbon source, are either dissolved into solution and fed to the culture broth and/or dissolved directly into the culture broth, including but not limited to gaseous electron donors and/or carbon sources (e.g., hydrogen and/or CO and/or methane gas). In certain embodiments, input gases may include other electron donors and/or electron acceptors and/or carbon sources and/or mineral nutrients such as, but not limited to, other gas constituents and impurities of syngas (e.g., hydrocarbons); ammonia; hydrogen sulfide; and/or other sour gases; and/or O₂; and/or mineral containing particulates and ash.

In certain embodiments, one or more gases are dissolved into the culture broth, including but not limited to gaseous electron donors such as, but not limited to, one or more of the following: hydrogen, carbon monoxide, methane, hydrogen sulfide or other sour gases; gaseous carbon sources such as, but not limited to one or more of the following: CO₂, CO, CH₄; and electron acceptors such as, but not limited to, oxygen, either within air (e.g., 20.9% oxygen) or as pure O₂ or as an O₂-enriched gas. In some embodiments, the dissolution of these and other gases into solution is achieved using a system of compressors, flowmeters, and flow valves known to one skilled in the art of fermentation engineering, that feed into one of more of the following widely used systems for dispersing gas into solution: sparging equipment; diffusers including but not limited to dome, tubular, disc, or doughnut geometries; coarse or fine bubble aerators; venturi equipment. In certain embodiments, surface aeration and/or gas mass transfer may also be performed using paddle aerators and the like. In certain embodiments, gas dissolution is enhanced by mechanical mixing with an impeller or turbine, as well as hydraulic shear devices to reduce bubble size. Following passage through the reactor system holding microorganisms which uptake the gases, in certain embodiments the residual gases may either be recirculated back to the bioreactor, or burned for process heat, or flared, or injected underground, or released into the atmosphere. In certain embodiments herein utilizing H₂ as electron donor, H₂ may be fed to the culture vessel either by bubbling it through the culture medium, or by diffusing it through a hydrogen permeable-water impermeable membrane known in the art that interfaces with the liquid culture medium.

In certain embodiments, the microorganisms grow and multiply on H₂ and CO₂ and other dissolved nutrients under microaerobic conditions. In certain embodiments, a C1 chemical such as but not limited to carbon monoxide, methane, methanol, formate, or formic acid, and/or mixtures containing C1 chemicals including but not limited to various syngas compositions generated from various gasified, pyrolyzed, or steam-reformed fixed carbon feedstocks, are biochemically converted into longer chain organic chemicals (i.e., C2 or longer and, in some embodiments, C5 or longer carbon chain molecules) under one or more of the following conditions: aerobic, microaerobic, anoxic, anaerobic, and/or facultative conditions.

A controlled amount of oxygen can also be maintained in the culture broth of some embodiments, and in certain embodiments, oxygen will be actively dissolved into solution fed to the culture broth and/or directly dissolved into the culture broth. In certain aerobic or microaerobic embodiments that require the pumping of air or oxygen into the culture broth in order to maintain targeted DO levels, oxygen bubbles may be injected into the broth at an optimal diameter for mixing and oxygen transfer.

In some embodiments, the microorganisms convert a fuel gas, including but not limited to syngas, producer gas, CO, CO₂, H₂, natural gas, methane, and mixtures thereof. In some embodiments, the heat content of the fuel gas is at least 100 BTU per standard cubic foot (scf). In some embodiments, a bioreactor that is used to contain and grow the microorganisms is equipped with fine-bubble diffusers and/or high-shear impellers for gas delivery.

Introducing and/or raising the gas flow rate into a bioreactor can enhance mixing of the culture and produce turbulence if the gas inlet is positioned beneath the surface of the liquid media such that gas bubbles or sparges up through the media. In certain embodiments, mixing is enhanced through turbulence provided by gas bubbles and/or sparging and/or gas plugging up through the liquid media. In some embodiments, a bioreactor comprises gas outlet ports for gas escape and pressure release. In some embodiments, gas inlets and outlets are preferably equipped with check valves to prevent gas backflow.

In certain embodiments where chemosynthetic reactions occur within the bioreactor, one or more types of electron donor and one or more types of electron acceptor are pumped or otherwise added as either a bolus addition, or periodically, or continuously to the nutrient medium containing chemoautotrophic organisms in the reaction vessel. The chemosynthetic reaction, driven by the transfer of electrons from electron donor to electron acceptor in cellular respiration, fixes inorganic carbon dioxide and/or other dissolved carbonates and/or other carbon oxides into organic compounds and biomass.

In certain embodiments a nutrient media for culture growth and production is used, comprising an aqueous solution containing suitable minerals, salts, vitamins, cofactors, buffers, and other components needed for microbial growth, known to those skilled in the art [Bailey and Ollis, Biochemical Engineering Fundamentals, 2^{nd} ed; pp 383-384 and 620-622; McGraw-Hill: New York (1986)].

In certain embodiments, the chemicals used for maintenance and growth of microbial cultures as known in the art are included in the nutrient media. In certain embodiments, these chemicals may include but are not limited to one or more of the following: nitrogen sources such as ammonia, ammonium (e.g., ammonium chloride (NH₄Cl), ammonium sulfate ((NH₄)₂SO₄)), nitrate (e.g., potassium nitrate (KNO₃)), urea or an organic nitrogen source; phosphate (e.g., disodium phosphate (Na₂HPO₄), potassium phosphate (KH₂PO₄), phosphoric acid (H₃PO₄), potassium dithiophosphate (K₃PS₂O₂), potassium orthophosphate (K₃PO₄), dipotassium phosphate (K₂HPO₄)); sulfate; yeast extract; chelated iron; potassium (e.g., potassium phosphate (KH₂PO₄) , potassium nitrate (KNO₃), potassium iodide (KI), potassium bromide (KBr)); and other inorganic salts, minerals, and trace nutrients (e.g., sodium chloride (NaCl), magnesium sulfate (MgSO₄ 7H₂O) or magnesium chloride (MgCl₂), calcium chloride (CaCl₂) or calcium carbonate (CaCO₃), manganese sulfate (MnSO₄ 7H₂O) or manganese chloride (MnCl₂), ferric chloride (FeCl₃), ferrous sulfate (FeSO₄ 7H₂O) or ferrous chloride (FeCl.sub.2 4H.sub.2O), sodium bicarbonate (NaHCO₃) or sodium carbonate (Na₂CO₃), zinc sulfate (ZnSO₄) or zinc chloride (ZnCl₂), ammonium molybdate (NH₄MoO₄) or sodium molybdate (Na₂MoO₄ 2H₂O), cuprous sulfate (CuSO₄) or copper chloride (CuCl₂ 2H₂O), cobalt chloride (CoCl₂ 6H₂O), aluminum chloride (AlCl₃·6H₂O), lithium chloride (LiCl), boric acid (H₃BO₃), nickel chloride NiCl₂ 6H₂O), tin chloride (SnCl₂ H₂O), barium chloride (BaCl₂ 2H₂O), copper selenate (CuSeO₄ 5H₂O) or sodium selenite (Na₂SeO₃), sodium metavanadate (NaVO₃), chromium salts). In certain embodiments, the mineral salts medium (MSM) formulated by Schlegel et al may be used [“Thermophilic bacteria”, Jakob Kristjansson, Chapter 5, Section III, CRC Press, (₁₉₉₂)].

Microorganisms described herein can be cultured in some embodiments in media of any type (rich or minimal), including fermentation medium, and any composition. As would be understood by one of ordinary skill in the art, routine optimization would allow for use of a variety of types of media. The selected medium can be supplemented with various additional components. Some non-limiting examples of supplemental components include glucose, antibiotics, isopropyl b-^{D}-1-thiogalactopyranoside (IPTG) for gene induction, and ATCC Trace Mineral Supplement. Similarly, other aspects of the medium and growth conditions of the microorganisms described herein may be optimized through routine experimentation. For example, pH and temperature are non-limiting examples of factors which can be optimized. In some embodiments, factors such as choice of media, media supplements, and temperature can influence production levels of a desired molecule. In some embodiments, the concentration and amount of a supplemental component may be optimized. In some embodiments, how often the media is supplemented with one or more supplemental components, and the amount of time that the media is cultured before harvesting the desired molecule is optimized.

In certain embodiments, the concentrations of nutrient chemicals (e.g., electron donors, electron acceptors, carbon sources, and/or various mineral nutrients), are maintained within the bioreactor close to or at their respective optimal levels for optimal carbon uptake and/or fixation and/or conversion and/or production of biomass and/or organic compounds, which varies depending upon the microorganism utilized but may be routinely determined and/or optimized by one of ordinary skill in the art of culturing microorganisms.

In certain embodiments, one or more of the following parameters are monitored and/or controlled in the bioreactor: waste product levels; pH; temperature; salinity; dissolved oxygen; dissolved carbon dioxide gas; liquid flow rates; agitation rate; gas pressure. In certain embodiments, the operating parameters affecting chemoautotrophic growth are monitored with sensors (e.g., dissolved oxygen probe or oxidation-reduction probe to gauge electron donor/acceptor concentrations), and/or are controlled either manually or automatically based upon feedback from sensors through the use of equipment including but not limited to actuating valves, pumps, and agitators. In certain embodiments, the temperature of the incoming broth as well as of incoming gases is regulated by systems such as, but not limited to, coolers, heaters, and/or heat exchangers.

In certain embodiments, the microbial culture and bioreaction is maintained using continuous influx and removal of nutrient medium and/or biomass, in steady state where the cell population and environmental parameters (e.g., cell density, pH, DO, chemical concentrations) are targeted at a constant level over time. In certain embodiments, the constant level is an optimal level for feedstock conversion and/or production of targeted organic compounds. In certain embodiments, cell densities can be monitored by direct sampling, by a correlation of optical density to cell density, and/or with a particle size analyzer. In certain embodiments, the hydraulic and biomass retention times can be decoupled so as to allow independent control of both the broth chemistry and the cell density. In certain embodiments, dilution rates can be kept high enough so that the hydraulic retention time is relatively low compared to the biomass retention time, resulting in a highly replenished broth for cell growth and/or feedstock conversion and/or production of organic compounds. In certain embodiments, dilution rates are set at an optimal technoeconomic trade-off between culture broth and nutrient replenishment and/or waste product removal, and increased process costs from pumping, increased inputs, and other demands that rise with dilution rates.

In certain embodiments, the pH of the microbial culture is controlled. In certain embodiments, pH is controlled within an optimal range for microbial maintenance and/or growth and/or conversion of feedstock and/or production of organic compounds and/or survival. To address a decrease in pH, in certain embodiments a neutralization step can be performed directly in the bioreactor environment or prior to recycling the media back into the culture vessel through a recirculation loop. Neutralization of acid in the broth of certain embodiments can be accomplished by the addition of bases, including but not limited to one or more of the following: limestone, lime, sodium hydroxide, ammonia, ammonium hydroxide, caustic potash, magnesium oxide, iron oxide, alkaline ash.

In certain embodiments, an aqueous suspension of chemoautotrophic microorganisms converts one or more electron donors and CO₂ into protoplasm. In certain embodiments, an aqueous suspension of hydrogen-oxidizing microorganisms can be used to convert hydrogen and carbon dioxide into microbial protoplasm. In certain embodiments, an aqueous suspension of carbon monoxide-oxidizing microorganisms can be used to convert carbon monoxide and hydrogen and/or water into protoplasm. In certain embodiments, an aqueous suspension of methane-oxidizing microorganisms can be used to convert methane into protoplasm. In certain embodiments, the microorganism in suspension is a bacterium or an archaeon. In certain non-limiting embodiments, an aqueous suspension or biofilm of H₂-oxidizing chemoautotrophic microorganisms converts H₂ and CO₂, along with some other dissolved mineral nutrients, into biochemicals and protoplasm. In certain embodiments, the other dissolved mineral nutrients include, but are not limited to, a nitrogen source, a phosphorous source, and a potassium source. In certain embodiments, the protoplasm produced is of food value to humans and/or other animals and/or other heterotrophs. In certain embodiments, certain biochemicals may be extracted from the protoplasm and/or extracellular broth, which have nutrient value, and/or value in a variety of organic chemistry or fuel applications. In certain embodiments, the intracellular energy to drive this production of protoplasm is derived from the oxidation of an electron donor by an electron acceptor. In certain non-limiting embodiments, the electron donor includes, but is not limited to, one or more of the following: H₂; CO; CH₄. In certain non-limiting embodiments, the electron acceptor includes but is not limited to O₂ and/or CO₂. In certain non-limiting embodiments, the product of the energy generating reaction, or respiration, includes but is not limited to water. In certain embodiments, the intracellular energy derived from respiration used to drive this synthesis of biochemicals and protoplasm from CO₂ is stored and carried in biochemical molecules including, but not limited to, ATP. For the knallgas microbes used in certain embodiments herein, the electron acceptor is O₂ and the product of respiration is water.

In some embodiments the protein production and/or distribution of amino acid molecules produced is optimized through one or more of the following: control of bioreactor conditions, control of nutrient levels, and/or genetic modifications of the cells. In certain embodiments, pathways to amino acids, or proteins, or other nutrients, or whole cell products are controlled and optimized for the production of chemical products by maintaining specific growth conditions (e.g., levels of nitrogen, oxygen, phosphorous, sulfur, trace micronutrients such as inorganic ions, and if present any regulatory molecules that might not generally be considered a nutrient or energy source). In certain embodiments, dissolved oxygen (DO) may be optimized by maintaining the broth in aerobic, microaerobic, anoxic, anaerobic, or facultative conditions, depending upon the requirements of the microorganisms. A facultative environment is considered to be one having aerobic upper layers and anaerobic lower layers caused by stratification of the water column. The biosynthesis of amino acids, or proteins, or other nutrients, or whole cell products by the microbes disclosed herein can happen during the logarithmic phase or afterwards during the stationary phase when cell doubling has stopped, provided there is sufficient supply of carbon and energy and other nutrient sources.

In some embodiments, the growth medium for a microorganism described herein includes a protein and/or nutrient source from another microorganism (e.g., cell lysate, protein hydrolysate, peptides, oligopeptides, and/or amino acids, and/or organic molecules and/or other nutrients from a different microorganism). In some embodiments, the microorganism in the growth medium is a GRAS microorganism. In one embodiment, the growth medium for a lactic acid bacterium, such as, but not limited to, a Lactococcus, Lactobacillus, Enterococcus, Streptococcus, or Pediococcus bacterium (for example, a GRAS lactic acid bacterium, such as a GRAS Lactococcus, Lactobacillus, Enterococcus, Streptococcus, or Pediococcus bacterium), includes cell lysate, protein hydrolysate, peptides, oligopeptides, and/or amino acids, and/or organic molecules and/or other nutrients from a different microorganism, such as any of the microorganisms described herein, including but not limited to, a Cupriavidus microorganism, such as, but not limited to Cupriavidus necator, for example, Cupriavidus necator DSM 531 or DSM 541. In another embodiment, growth medium for a fungal microorganism, such as a Fusarium or Rhizopus fungal microorganism (for example, a GRAS fungal microorganism, such as a GRAS Fusarium or Rhozopus fungal microorganism), such as any of the microorganisms described herein, including but not limited to, Fusarium venenatum, Rhizopus oligosporus, or Rhizopus oryzae, includes cell lysate, protein hydrolysate, peptides, oligopeptides, and/or amino acids, and/or organic molecules and/or other nutrients from a different microorganism, such as, but not limited to, a Cupriavidus microorganism, such as, but not limited to Cupriavidus necator, for example, Cupriavidus necator DSM 531 or DSM 541.

In some embodiments, a fungal microorganism that is capable of lysing bacterial cells and/or hydrolyzing bacterial protein is cultured in the presence of such bacterial cells. For example, bacterial biomass may be isolated and optionally dewatered, and then fungal microorganisms inoculated onto the bacterial biomass, or fungal microorganisms may be cultured in a growth medium as described herein, in the presence of bacterial biomass. In certain nonlimiting embodiments, the fungal microorganisms include Fusarium or Rhozopus microorganisms, such as but not limited to, Fusarium venenatum, Rhizopus oligosporus, or Rhizopus oryzae.

The specific examples of bioreactors, culture conditions, heterotrophic and chemotrophic growth, maintenance, and amino acids, or proteins, or other nutrients, or whole cell product production methods described herein can be combined in any suitable manner to improve efficiencies of microbial growth and amino acid, or protein, or other nutrient, or whole cell production.

Microbial (e.g., bacterial) cells that are cultured as described herein may be subjected to one or more downstream processing operations (e.g., physiological, chemical, and/or mechanical operations or conditions) to provide a protein product for incorporation into a structured food product as described herein. For example, downstream processing may include separating the liquid phase (e.g., culture medium) from the solid phase (e.g., microbial (e.g., bacterial) biomass), and concentrating the biomass by removing the liquid. For example, the separation may be performed by centrifugation and/or filtration. Filtration may be performed, for example, through a semi-permeable membrane.

In some embodiments, downstream processing of microbial (e.g., bacterial) biomass includes heat treatment, such as incubation of the biomass at a temperature of about 55° C. to about 75° C. for about 15 minutes to about 40 minutes. In some embodiments, the heat treatment serves to disrupt cell walls and to release endotoxins. In certain embodiments, the heat treatment is performed prior to separation of the liquid phase from the microbial biomass.

In some embodiments, downstream processing of microbial (e.g., bacterial) biomass includes homogenization of the biomass. Homogenization may serve to at least partially disrupt cell walls, thereby increasing soluble protein content. In some embodiments, a high-pressure homogenization or milling technique is used. After homogenization, the homogenate (e.g., slurry of homogenized microbial (e.g., bacterial) cells) may be filtered, for example, via ultrafiltration and/or nanofiltration, to remove cell walls and other solid cell debris, and/or to concentrate the protein in the homogenate. In some embodiments, a milling technique is deployed for homogenization to reduce the size of particles, such as bead milling or ball milling, and/or sonication. In some embodiments, homogenization releases endotoxins from the microbial cells.

In some embodiments, downstream processing of microbial (e.g., bacterial) biomass includes adjustment of pH, for example, from about 7.4 to about 8.5, such as any of about 7.4, 7.5, 7.6, 7.7, 7.8, 7.9, 8.0, 8.1, 8.2, 8.3, 8.4, or 8.5. For example, a base, such as, but not limited to, KOH and/or Ca(OH)₂ may be used for pH adjustment.

### Electron Donors and Acceptors

In certain non-limiting embodiments, microorganisms described herein are grown chemoautotrophically. For example, the microorganism growth may utilize biosynthetic reduction of CO₂, utilizing O₂ electron acceptor and/or H₂ electron donor. In certain embodiments, O₂ and H₂ are generated by the electrolysis of water. In certain non-limiting embodiments, part of the O₂ generated by electrolysis of water, and all of the H₂, is fed to an aqueous suspension of microorganisms as described herein. In certain non-limiting embodiments, the molar ratio of H₂ fed to an aqueous suspension of microorganisms to the moles of O₂ is greater than 2:1. In certain non-limiting embodiments where O₂ electron acceptor and H₂ electron donor are generated by the electrolysis of water, there is a surplus of O₂ remaining after all of the metabolic requirements of the microorganisms for H₂ and O₂ have been met. In certain such embodiments the surplus O₂ may be supplied to humans and/or other aerobic lifeforms and/or to hydroponic systems for root aeration and/or is used in a gasification or partial oxidation or combustion process and/or is stored and sold as a chemical co-product.

In certain embodiments that utilize molecular hydrogen as an electron donor, there can be a chemical co-product formed in the generation of molecular hydrogen using a renewable and/or CO₂ emission-free energy input. In certain embodiments, the oxyhydrogen reaction used in respiration is enzymatically linked to oxidative phosphorylation. In certain embodiments, the ATP and/or other intracellular energy carriers thus formed are utilized in the anabolic synthesis of amino acids and/or proteins. In certain embodiments, the oxygen produced by water-splitting in excess of what is required for respiration in order to maintain optimal conditions for carbon fixation and organic compound production by the knallgas microorganisms, may be processed into a form suitable for sale through process steps known in the art and science of commercial oxygen gas production.

Certain embodiments apply hydrogen-oxidizing and/or CO-oxidizing and/or CH₄ oxidizing microorganisms that use more electronegative electron acceptors than CO₂ in energy conserving reactions for ATP production (e.g., respiration), such as but not limited to O₂. For example, hydrogenotrophic oxyhydrogen or knallgas microbes that couple the oxyhydrogen reaction, 2 H₂+O₂->2 H₂O, to ATP production, can produce more ATP per H₂ and/or other electron donor consumed for respiration, than acetogens or methanogens that use CO₂ as an electron acceptor in respiration. For example, knallgas microorganisms can produce at least two ATP per H₂ consumed in respiration [L. Bongers (1970) “Energy generation and utilization in hydrogen bacteria” Journal of bacteriology 104(1): 145-151, which is incorporated herein by reference in its entirety], which is eight times more ATP produced per H₂ consumed in respiration than what can be produced in microorganisms undergoing methanogenesis or acetogenesis, using H₂ as electron donor and CO₂ as electron acceptor in respiration. For this reason, using microorganisms that can utilize more electronegative electron acceptors in respiration and in the production of ATP, such as but not limited to knallgas microbes, for anabolic biosynthesis such as but not limited to amino acid or protein or fatty acid biosynthesis from syngas or H₂, can be more efficient than using acetogens or methanogens, such as those which are currently used in biological GTC technologies for the production of short chain acids or alcohols (e.g., acetic acid or ethanol). In certain embodiments, the oxyhydrogen reaction used in respiration is enzymatically linked to oxidative phosphorylation. In certain embodiments, aerobic respiration is utilized by the microorganism cells described herein for the production of ATP. In certain embodiments, the ATP and/or other intracellular energy carriers thus formed are utilized in the anabolic biosynthesis of amino acids and/or proteins. In some embodiments, a knallgas and/or carboxydotrophic and/or methanotrophic and/or heterotrophic microorganism or a compositions comprising these microorganisms is utilized, wherein the microorganism expresses one or more enzymes that enables biosynthesis of useful carbon-based products of interest including but not limited to chemicals, monomers, polymers, proteins, polysaccharides, vitamins, nutraceuticals, antibiotics, or pharmaceutical products or intermediates thereof from a carbon-containing gas feedstock, including but not limited to syngas or producer gas or natural gas or biogas or CO₂ combined with renewable H₂ or CO or methane containing gases. In some embodiments, these said carbon-based products of interest can be biosynthesized heterotrophically from an organic multi-carbon feedstock, such as, but not limited to glucose, fructose, and other sugars. In some non-limiting embodiments, a microorganism, or a composition comprising a microorganism is utilized, wherein the microorganism requires less than 4H₂ or NADH to produce one ATP through respiration. In other non-limiting embodiments, a microorganism is utilized that produces more than one ATP per H₂ or NADH consumed through respiration. In other non-limiting embodiments a microorganism is utilized that produces at least two ATP per H₂ or NADH consumed through respiration, or at least 2.5 ATP per H₂ or NADH consumed through respiration.

An additional feature of certain non-limiting embodiments regards the source, production, or recycling of the electron donors used by chemoautotrophic microorganisms to fix carbon dioxide and/or other C1 feedstocks into organic compounds. The electron donors used for carbon dioxide capture and carbon fixation can be produced or recycled in certain embodiments electrochemically or thermochemically using power from a number of different renewable and/or low carbon emission energy technologies including but not limited to: photovoltaics, solar thermal, wind power, hydroelectric, nuclear, geothermal, enhanced geothermal, ocean thermal, ocean wave power, tidal power. Many of the reduced inorganic chemicals upon which chemoautotrophs can grow (e.g., H₂, CO, H₂S, ferrous iron, ammonium, Mn²⁺) can be readily produced using electrochemical and/or thermochemical processes well known in the art and science of chemical engineering that can be powered by a variety carbon dioxide emission-free or low-carbon emission and/or renewable sources of power including but not limited to photovoltaics, solar thermal, wind power, hydroelectric, nuclear, geothermal, enhanced geothermal, ocean thermal, ocean wave power, or tidal power.

The production of hydrogen from renewable energy sources is gradually replacing the generation from fossil feedstock systems, and the technical advances in the energy sector are expected to lower the prices of green hydrogen production in the near future. For instance, electrical energy efficiencies up to 73% are already achieved by commercial and industrial grade electrolyzers, and researches on new materials and electrolyzer configurations have shown possible efficiencies as high as 96%. Certain embodiments utilize a commercially available electrolysis technology with electrical energy efficiency of over 70% for the generation of H₂ electron donor and/or O₂ electron acceptor. Certain embodiments use electrolysis technologies with 73% or higher energy efficiency, and/or up to 96% energy efficiency, or higher.

In certain embodiments that use molecular hydrogen as electron donor, the H₂ is generated by methods well known to art and science of chemical and process engineering, including but not limited to one or more of the following: through electrolysis of water including but not limited to approaches using Proton Exchange Membranes (PEM), liquid electrolytes such as KOH, alkaline electrolysis, Solid Polymer Electrolyte electrolysis, high-pressure electrolysis, high temperature electrolysis of steam (HTES); and/or through the thermochemical splitting of water through methods including but not limited to the iron oxide cycle, cerium(IV) oxide-cerium(III) oxide cycle, zinc zinc-oxide cycle, sulfur-iodine cycle, copper-chlorine cycle, calcium-bromine-iron cycle, hybrid sulfur cycle; and/or electrolysis of hydrogen sulfide; and/or thermochemical splitting of hydrogen sulfide; and/or other electrochemical or thermochemical processes known to produce hydrogen with low- or no-carbon dioxide emissions including but not limited to: carbon capture and sequestration (CCS) enabled methane reforming. In certain embodiments, the approach to generating H₂ includes but is not limited to electrolysis powered by renewable electrical energy and/or electricity from a low-greenhouse gas (GHG) source. In certain embodiments, electrolysis is powered by one or more of the following: solar, including but not limited to, photovoltaics and/or solar thermal; wind power, hydroelectric; nuclear; geothermal; enhanced geothermal; ocean thermal; ocean wave power; tidal power.

Worldwide there are enormous wind energy resources, of which only a tiny percentage is utilized. The low current utilization is mainly attributed to the intermittent nature of wind resources, resulting in varying electricity generation over time, and underutilization of capacity to meet energy demand at most hours. The common mismatch between wind power supply and grid demand is manifested in examples from around the world, such as in Scotland where wind farms have been paid to shut down turbines due to oversupply [http://www.mnn.com/earth-matters/energy/blogs/blown-away-wind-turbines-generate-enough-energy-to-power-every-home-in], and in parts of Texas where electricity has been provided for free at night when wind power is high and grid demand is low [http://www.nytimes.com/2015/11/09/business/energy-environment/a-texas-utility-offers-a-nighttime-special-free-electricity.html?_r=2]. This challenge may be resolvable by utilizing wind power produced during off-peak demand hours to produce H₂ feedstock for the process in certain embodiments herein.

Currently, hydrogen is increasingly regarded as a possible energy storage system in the so-called “power-to-gas” approach. The inherent instability of renewable energy production (particularly solar and wind energy), and excess grid electricity (off-peak energy) may be mitigated by the production of hydrogen through water electrolysis. According to most current schemes, the produced hydrogen gas may then be converted back to electricity, by fuel cells and/or gas turbines, during periods of peak demand. Or alternatively the H₂ may be fed into the gas grid, or converted to methane via methanation. Furthermore, the hydrogen may be used as a raw material in the chemical, petrochemical, metallurgy and food industries. Certain embodiments provide new options within the power-to-gas framework, by enabling the H₂ to be used in a wider range of products, including biochemicals and in particular proteins, amino acids, fertilizers, and biostimulants. In certain embodiments, hydrogen produced using excess grid electricity and/or off-peak energy is used as an electron donor for one or more metabolic pathways occurring in hydrogen-utilizing microorganisms. In certain embodiments, the hydrogen and/or the oxygen needed for the microbial biosynthesis by hydrogen-oxidizing bacteria and/or aerobic bacteria is generated by water electrolysis using renewable energy, and in particular off-peak electricity, i.e., electrical power available when the energy supply exceeds demand, and which, in the current situation, is often wasted.

In certain embodiments, onsite storage of H₂ and CO₂ gases enables diversion of power from the grid only during periods when renewable generation exceeds electrical demand. In certain embodiments, power is allowed to flow as usual into the grid during periods of higher demand. In certain embodiments, the process does not disrupt renewable power supply, but rather enables more complete utilization of renewable generation capacity such as, but not limited to, wind and solar. Certain embodiments allow continued renewable operation and generation even during periods when electrical generation exceeds grid demand (e.g., off-peak wind or solar generation).

In certain embodiments, hydrogen electron donors are not necessarily generated with low-or no-carbon dioxide emissions. However, in certain such embodiments the hydrogen is generated from sustainable or low value sources of energy and/or carbon using methods known in the art of chemical and process engineering. Such methods include but are not limited to gasification, pyrolysis, steam-reforming, or autothermal reforming of feedstock such as but not limited to one or more of the following: agricultural materials, wood, methane hydrates, straw, sea weed and kelp, and low value, highly lignocellulosic biomass in general. In certain embodiments, a synthesis gas or producer gas containing H₂ and/or CO and/or CO₂ is utilized as an electron donor and/or as a carbon source. In certain embodiments, the H₂ and/or CO and/or CO₂ contained in a syngas or producer gas is supplemented by H₂ generated using a renewable and/or low-GHG energy source and conversion process such as one or more of those described herein.

In certain non-limiting embodiments, reduction of CO₂ occurs and/or synthesis of cellular material that can be utilized as a food or nutrition source. In certain embodiments, the ratio of hydrogen to carbon monoxide in syngas or producer gas may be adjusted through the water gas shift reaction and/or carbon capture, prior to the gas being delivered to the microbial culture. In certain embodiments, C1 compounds are generated through methane steam reforming of methane or natural gas, and particularly stranded natural gas, or natural gas that would be otherwise flared or released to the atmosphere, or biogas, or landfill gas, and provided as a syngas and/or producer gas or liquid stream of C1 compounds to the culture of microorganisms, where in certain embodiments the ratio of hydrogen to carbon monoxide in the syngas or producer gas may be adjusted through the water gas shift reaction and/or carbon capture, prior to the gas being delivered to the microbial culture.

The following examples are intended to illustrate, but not limit, the invention.

### EXAMPLES

### Example 1

Bacterial protein product was produced via a closed chemoautotrophic bioprocess. Chemoautotrophic bacterial cells, such as oxyhydrogen microorganism, e.g., Cupriavidus or Xanthobacter cells were grown in a culture medium, with the addition of hydrogen, carbon dioxide, and oxygen gases.

After fermentation, the culture broth containing whole cell biomass (WCB) was processed into a protein concentrate by heat treatment (resulting in the microbial biomass comprising microorganism cell mass, such as e.g., oxyhydrogen microorganism cell mass and protein from the microorganism or resulting in the protein from the microorganism). After heat treatment, the spent culture media was removed via a dewatering step, such as centrifugation or filtration, and was discarded. The resulting protein concentrate was dried to a powder, packaged, and used to formulate food products. In other instances, solvent extraction was used to further purify the protein stream and subsequently, the purified stream was used in formulation of food products.

In other instances, the bacterial cells were lysed to release cytoplasmic contents, after which the protein was manipulated using various processing techniques, including flocculation, adsorption, resin exchange, and/or filtration (micro, ultra, and other filtration methods), to purify wet WCB into a protein isolate, which as used in formulation of food products.

In other instances, the wet WCB was subjected to the action of chemicals (acids or bases), thermal, or enzymatic processes, or combinations thereof, to produce protein hydrolysates, which were used in formulation of food products.

### Example 2

A non-meat protein product was produced using extruded and laminated sheets, which resembled a whole muscle chicken breast, an example of the process is illustrated in the schematic diagram of FIG. 3

A mixture of proteins from bacteria, chickpea, and wheat gluten was blended with vegetable oil (sunflower oil). Oils may be selected to achieve fat composition and fatty acid profile similar to the animal of which the finished product is a non-meat analogue, i.e., to achieve fatty acid profile, mouthfeel, nutritional profile and taste properties similar to natural animal fats. The protein-oil mixture was blended in a mixer. Water or steam was added to create a homogeneous dough mixture suitable for further processing.

The dough was mixed under vacuum (25-30 in. Hg) making the dough tighter and more functional for downstream processing. This was achieved in a V-mag mixer, which also removes air to reduce sticking on belts and rollers. Various amounts of air may be incorporated to lighten the color and alter the texture of the dough, to mimic animal proteins. The dough was allowed to rest for a period of 30-60 min to achieve a desirable consistency for sheeting. Examples of other mixers that may be used include Hobart Mixer, KitchenAid, Ribbon Mixer, and Paddle Blender.

The dough was made into sheets with a thickness between 0.5-10 mm, with an ideal thickness of 2 mm of less. The sheeting process was achieved with a Univex Dough Sheeter at ambient temperature. The sheeter rollers may alternatively be heated or cooled to achieve desired product attributes. For example, the rollers are at 1-20° C., ideally kept below 10° C., depending on the dough rheology and properties. The sheeting can be alternatively accomplished using pasta rollers and extrusion die or similar processes.

After sheeting, the dough sheets were treated with hot water to set the dough structure (proteins). In this example the water was at 60-100° C., ideally around 80° C. The retention time was 30 sec-2 min. The excess water was removed using an air knife. The sheets were cooled in a cooling chamber or continuous cooler to a temperature of 4-20° C.

Dry wheat gluten and/or maltodextrin was used as an adhesive binder. Powder was sprinkled between dough sheets in a thin layer.

Dough used as “skin” was laid into a mold with individual strands laid in a unidirectional pattern, mimicking meat fibers.

The product was vacuum sealed in a mold and was cooked to 165° F. internal temperature. The product was stored frozen for microbial control.

The selection of the equipment used for the process may vary depending on the volume of materials or scale of the production process.

### Example 3

A non-meat protein product was produced according to a cold extrusion processes described herein, which contained: a mixture of proteins, including bacterial, fungal, and/or plant protein; gums, including konjac, kappa-carrageenan, sodium alginate, and/or xanthan gum; starches, including tapioca, pea, and/or potato starch; flavoring, including dry, oil-, and water-based flavorings; and oils, including oils derived from plants, bacteria, and/or algae.

The protein was hydrated by high-shear mixing at 450-1100 rpm and heated to 80° C. to 100° C., in a device such as Thermomix T6. The oil was then added with flavoring into the protein mixture while still maintaining the high shear mixing at 450-1100 rpm and high temperature at 80° C. to 100° C. A dry mixture of the gums and starches was then added while still maintaining the high shear mixing at 450-1100 rpm and high temperature at 80° C. to 100° C.

After the dry mixture of the gums and starches was added, the high shear mixing and heating were performed for at least 30 minutes to let the composition set. After the protein, gums, starches, oils, and flavoring were mixed, a buffer solution such as calcium hydroxide was incorporated to further set the gelation.

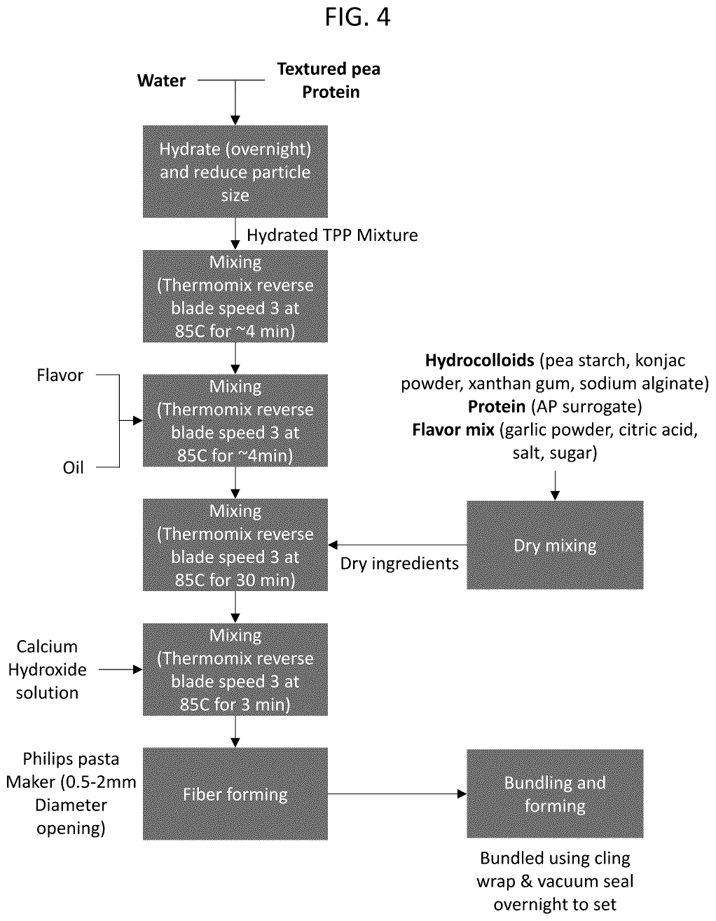

After the composition set, the composition was extruded a temperature of about 10° C. to about 85° C. and atmospheric pressure to produce thin strands with a diameter of 0.5 mm-1.5 mm, in a device such as Philips Compact Pasta and Noodle Maker, HR2370/05. A schematic diagram illustrating some embodiments of this process is as shown in FIG. 4.

The strands were then formed into a desired shape, vacuum sealed, set for at least 2 hours in a refrigerated condition at about 2° C.-4° C., and then cut to resemble a shellfish, e.g., a scallop.

In other examples, the composition includes blends of vegetable starches, blends of oils, animal-based products, cultured products, gelling agents, fungal protein ingredients hydrocolloids, fructooligosaccharides (FOS), minerals, coloring, and/or flavoring agents, all of which can be used to improve the nutritional, textural or flavor properties of the composition.

A mixture of dry and textured proteins sourced from either bacteria, fungus, and/or plant was hydrated with high-shear mixing at 450-1100 rpm to reduce particle size.

Gelling agents may include konjac, kappa carrageenan, gellan gum, xanthan gum, sodium alginate, agar, and/or curdlan.

The composition may be emulsified with fat/shortening sourced from plants, algae, and bacteria to improve the textural and flavor properties of the composition.

In an alternate example, the high-shear mixing of the proteins, fats, flavoring, gums, starches, and gelling agents can be done before the heating step or vice versa.

Oils and oil-based flavoring may be brushed, sprayed, and/or used to coat the strands to improve flavor and textural properties.

### Example 4

A non-meat protein-containing high moisture extrudate composition was produced, which contained: a mixture of proteins (70-98% by weight), including bacterial protein, pea protein, soy protein and/or chickpea protein; fiber (0.5-5% by weight), including pea fiber; fructooligosaccharides (FOS) (0-4% by weight); starch (0-4% by weight), including potato starch; oil (0-2% by weight), including sunflower oil, canola oil, and/or extra virgin olive oil. These materials were blended in a mixer. Examples of mixers that may be used include a JSM drum mixer, paddle mixer, ribbon mixer, vertical mixer, and cone shape mixer.

The materials were fed into the barrel of a twin-screw extruder using a volumetric feeder with a feed rate ranging from 5 kg/hr to 15 kg/hr. This extruder was outfitted with a breaker plate with 1 mm-5 mm circular openings. Water was also pumped into the extruder at a rate between 5 kg/hr and 15 kg/hr to achieve a composition with a moisture content of 40-65%.

In this example, the composition was mixed and conveyed through six heating zones with temperatures ranging from 25° C.-160° C. in zones 1-3 and 140° C.-175° C. in zones 4-6, at a pressure of 2 bar-20 bar and a torque of 1-5. The composition was passed through cooling die zones with a temperature of 60° C.-115° C., and exited the extruder through a modular cooling die with an internal temperature of 40° F.-80° F.. The temperature within the cooling zones was controlled using a recirculating cooler.

The composition had a moisture of 50%-65% after being submerged in a water bath with the purpose of retaining moisture. The composition was cut and then sized with cutters including a Biro SIR STEAK tenderizer fitted with a cutting blade, or a Urschel Comitrol with blade sizes ranging from ¼ in.-2 in. All extrudate samples were vacuum sealed and frozen for microbial control. A schematic diagram illustrating some embodiments of this process is as shown in FIG. 5.

Different ingredients ratios were used in a variety of extrusion parameters as following: 87-99% pea protein isolate, 1-4% pea fiber, 0.5-1.5% potassium phosphate, 1-5% fructooligosaccharides, 1-4% ramon flour (Brosimum alicastrum) incorporation as a gelling agent.

### Alternate Embodiments

1. Oil was added at 1-5% to the composition in the extruder using a pump, including positive displacement pumps and centrifugal pumps.
2. Materials were fed into a twin-screw extruder using a gravimetric feeder.
3. Breaker plates have different opening shapes, numbers, sizes and positioning along the plate.
4. Extrudate was soaked in a water bath containing potassium phosphate dibasic in the range of 0.1%-2% in an effort to optimize fibrosity of the resulting extrusion product.
5. Potassium phosphate dibasic (0.1%-1.5%) was added directly into the mixer with the rest of the dry materials contained in the composition to optimize fibrosity of the extrudate, as well as to balance pH within the extruder.
6. Materials making up the composition were preconditioned prior to being fed into the extruder, as illustrated in FIG. 5. Oil was introduced into the dry material mix in a spray form, while in other examples, the material is heated slightly from 30° C.-60° C. Water was used in other instances.
7. The composition was conveyed through nine heating zones with temperatures in the range of 25° C.-175° C. in addition to two cooling zones with temperatures ranging from 50° C.-100° C.
8. Additional cooling zones were added to optimize fibrosity within the composition exiting the extruder.
9. The composition exited the extruder through a flat head die.
10. The composition exited the extruder through a hollow die head with nozzles having openings in the range of 1 mm-10 mm.
11. The composition exited the extruder through a noodle die head with nozzles having openings in the range of 1 mm-10 mm.
12. The composition included blends of vegetable starches, blends of oils, animal-based products, cultured products (e.g., cultured meat), gelling agents, fungal protein ingredients, hydrocolloids, FOS, minerals, and/or coloring and flavoring agents, all of which may be used to improve the nutritional, textural, or flavor properties of the extrudate.
13. Fungal protein was included in the mixture fed to the extruder, in powdered or liquid form.
14. The extrudate was treated with a tenderizer (e.g., Biro SIR STEAK) fitted with a cutting blade and/or a cutting machine (e.g., Urschel Comitrol). In addition, the extrudate may be further sized using equipment including, but not limited to, a deli slicer, a dicer (e.g., Treif & Piccolo; Urschel RA-A), or a meat grinder (e.g., Kilia & AW) meat grinder.
15. Ingredients used for color, texture and flavor optimization were added following the extrusion process. Equipment used for this purpose included, but not limited to, an injector (e.g., Fomaco & FGM2652), a tumbler (e.g., Biro Vacuum Tumbler), a mixing tank, and a steam kettle.
16. Material exiting the extruder was soaked in a cold-water bath.
17. The extruded composition was heated under high moisture (95%-100%), pressure (10 psi-20 psi) and temperature (200° F.-270° F.) conditions with flavor, color and oil. The composition was broken down with a low shear mixer, resulting in 50 mm-100 mm pieces. The cut composition was then flavored and served as a fish or chicken substitute.
18. The extruded composition was placed in a sous vide system (vacuum sealed and submerged in a water bath and cooked to a specific set temperature (60° C.-110° C. for 5 min-20 min) to enhance texture and fibrosity in a formed composition (e.g., resembling salmon steak substitute) or disassembled composition (e.g., resembling beef shreds).
19. The extruded composition of alternative examples 18 or 19 was treated with a binding system to form a whole muscle alternative to animal meat, such as chicken, salmon, steak, tuna, or pork.
20. The extruded composition was sliced with a meat slicer at a variety of thicknesses, from 0.2 mm-10 mm.
21. A variety of extrudates were made using moisture 45-62%, and temperature profiles: 40° C.-160° C. in zones 1-3 and 140° C.-175° C. in zones 4-7, at a pressure of 2 bar-20 bar. The composition was passed through cooling die zones with a temperature of 60° C.-115° C., and exited the extruder through a modular cooling die with an internal temperature of 40° F.-80° F.. The composition contained pea protein isolate (80%) at 80-98% w/w, pea fiber at 1-5% w/w, sunflower oil at 0.5%-2% w/w, and fructooligosaccharides (FOS) (0-4% w/w).

### Example 5

A non-meat protein product which resembles meat was produced according to the shredding and grinding processes described herein.

The product resembles meat, such as whole muscle poultry, pork, fish, or beef.

Vegetable oils were blended into a protein composition to achieve a fat composition and fatty acid profile that is similar to a particular animal species. Examples of proteins include bacterial protein, chickpea, legume, zein, corn gluten, wheat gluten, rice protein, and/or canola protein. Examples of vegetable oils include sunflower, canola, palm, soy, and/or coconut oil. Oils were selected for fatty acid profile, mouthfeel, nutritional profile, and taste properties similar to natural animal fats.

Oil and protein were blended in a mixer. Examples of mixers include a Hobart Mixer, KitchenAid, Ribbon Mixer, and Paddle Blender. Water or steam was added to create a homogeneous dough for further processing.

The dough was mixed under vacuum (30 in. Hg), making the dough tighter and more functional for downstream processing. A V-mag mixer may be used, which may remove air, reducing sticking on belts and rollers. Various amounts of air may be incorporated to lighten the color of the dough and/or to alter the texture to mimic animal proteins. After mixing, the dough was allowed to rest for 30-60 minutes, to achieve a desired consistency for forming.

The dough was formed into a log with a thickness of 1-100 mm, with an ideal thickness of 20 mm or less (e.g., 1-20 mm). The log forming process was achieved by depositing the dough in molds to achieve desired product dimensions or extruded to desired product dimensions. The dough was formed into 2 in.×2 in.×8 in. logs, which were subjected to grinding. Ideally, the material was kept below 10° C., depending on dough rheology and other properties. Forming may alternatively be accomplished using packaging technology, meat forming equipment, or similar processes.

After forming, the logs were heated to set the dough structure (e.g., proteins), in an oven at 200-400° F., ideally about 325° F. The cook time was 10-100 minutes. In one example, the logs were cooled in a cooling chamber or continuous cooler to a temperature of 4-20° C. In another example, the logs were shredded and ground hot (90° F.-300° F.).

Dough used as thin “skin,” ideally 0.5 mm-2 mm thickness, was produced in a separate process using rollers and laid into an empty mold.

### Example 6

Logs produced as described in Example 5 are fed into an industrial meat grinder, such as a Hobart grinder. A die plate with 3 mm opening is used. Ground material is stored in a stainless-steel lugger.

Logs produced as described in Example 5 are fed into an industrial shredder, such as a Fusion Tech shredder (rotating arms affixed with extended pins that shred material using gravity and a circular motion). Alternatively, logs are fed into an Urschel comitrol micro cut apparatus for production of shredded material. Alternatively, a Carrouthers shredder is used. Alternatively, a Comil Mill Quadro Engineering grater is used, which is capable of producing slices, ribbons, powder, etc. Shredded material is stored in a stainless-steel lugger.

Material from the grinding process (20-30% of formulation by volume) is added to a 2000 pound paddle blender equipped with vacuum and CO₂ chilling capabilities. Material from the shredding process (50-60% of formulation by volume) is added to the ground material in the blender. A functional ingredient mixture that includes, but is not limited to, vegetable protein, microbial (e.g., bacterial) protein, vegetable starch, gums, hydrocolloids, gelatin, vegetable fats, insoluble fiber, soluble fiber, water, and/or enzymes, is added to the blender (10-30% of the formulation by volume).

In one example, the material is blended in the 2000 lb. paddle mixer using the following schedule:
Forward mix 1-10 minutes
Reverse mix 1-10 minutes
Vacuum forward mix 1-20 minutes
Vacuum reverse mix 1-10 minutes
CO₂ 1-5 min, forward mix
CO₂ 1-10 min, reverse mix
Discharge into stainless steel luggers and set aside

Stainless steel luggers filled with a chilled mixture of ground logs, shredded logs, and functional ingredient mixture and are loaded using a hydraulic lift into a forming device, such as Formax, Revo Portioner, Vermag Extruder, or low pressure high moisture extruder, into a shape resembling, but not limited to, a poultry meat component (e.g., skin on/skin off, bone in/bone out, thigh breast, tender, wing, drumstick, drumette wing tip, breast wing quarter, thigh leg quarter, slab), a pork meat component (e.g., tenderloin chop, loin steak, rib, shoulder roast, slab), a beef meat component (e.g., tenderloin whole, tenderloin cut, ribeye, New York strip, flat iron, skirt, flap steak, sirloin, chuck roast, back rib, slab), or fish (e.g., filet, chunks, shreds).

The product is conveyed and inspected for quality. The product is kept at or below 34° F. to maintain freshness and microbial stability.

The product is heat treated to 165° F. internal temperature by apparatus and methods including, but not limited to, smoke house (e.g., Alkar, Enviropak), spiral steam oven, steam deck oven, convection oven, direct flame broiling (e.g., DD Broiler), searing (e.g., Prosear or industrial searing belt press), frying, pressure cooking, or boiling. Optionally, the product is vacuum sealed in a mold prior to the heat treatment.

The product is conveyed from the heat treatment process through a chilling process to prepare for packaging. The environment is maintained at or below 34° F. The product passes through a nitrogen tunnel, spiral freezer, blast chiller, walk-in refrigerator, or walk-in freezer, and chilled to an internal temperature of 10-32° F.

Optionally, dough for “skin” is diluted with water to 10-90%, and rolled, sheeted, or sprayed onto hot rollers to a thickness of 0.1 mm-3mm. In one example, dough is placed into a mold and filled mechanically (depositor) or manually into an industrial molding machine, such as a die cutter used in the baking industry.

The product is packaged using a polyblend packaging material and uses either vacuum seal, gas flushed modified atmosphere packaging (MAP), form seal, or preform top seal industrial packaging equipment to seal the product in a food safe environment. The product is crated and stored for shipment.

### Example 7

Ingredients such as fiber, carbohydrates, and flavoring and seasoning agents, are mixed to combine, in a KitchenAid mixer. Oil is added and mixed for 2 minutes on speed 2 with a paddle. Protein (microbial and/or plant protein) is added and mixed for an additional 2 minutes to form a paste. Wheat gluten is added slowly (over a 10 second period of time) while mixing on speed 2 with the paddle. The bowl is scraped after 15 seconds, then as needed util the dough starts to form into a single mass (5-8 minutes). Once incorporated, the dough is kneaded with a dough hook on speed 3 for 7 minutes. The dough is vacuum sealed on high setting (25 seconds) to help hydrate the dough, and then the dough is rested for 60 minutes to improve extensibility. The dough is deposited into a mold to produce dough logs and covered in an extremely thin layer of oil to prevent sticking. The dough is baked in a conventional oven at 325° F. for 25 minutes. A dough sheet “skin” is added separately to the mold first, with light oil on the mold before adding.

A portion of the cooked and cooled dough logs is ground through a 3 mm grinding plate using a conventional meat grinder. A portion of the cooked and cooled dough logs is shredded using a conventional meat shredder.

A binder is produced that includes protein (e.g., plant protein), starch (e.g., plant starch), simple sugars, flavors, hydrocolloids, emulsifiers, and/or fats. The binder material is mixed.

Shredded material, ground material, and binder are combined in a vacuum mixer and mixed for 5-10 minutes under vacuum at 30 in. Hg. The mixture is deposited into a “skin” lined mold and excess skin trimmed. The product is vacuum treated for 20 seconds to compress, the vacuum is released, and then vacuum treated again for 10 seconds. The product is cooked in a 98° C. steam oven for 60 minutes, and then cooled for at least 4 hours.

Although the foregoing disclosure has been described in some detail by way of illustration and examples for purposes of clarity of understanding, it will be apparent to those skilled in the art that certain changes and modifications may be practiced without departing from the spirit and scope of the disclosure. Therefore, the description should not be construed as limiting the scope of the disclosure.

All publications, patents, and patent applications cited herein are hereby incorporated by reference in their entireties for all purposes and to the same extent as if each individual publication, patent, or patent application were specifically and individually indicated to be so incorporated by reference.

We claim:

1. A structured food product, comprising: two or more layers of rolled dough composition comprising protein composition; and an adhesive composition comprising protein, gluten, or combination thereof, wherein the adhesive composition is between the two or more layers of the rolled dough composition and adheres the layers together to form the structured food product, and wherein the protein in the protein composition and/or the adhesive composition is from microorganism, plant, alga, fungus, insect, or combination of any two or more thereof.

2. The structured food product of claim 1, wherein the protein composition comprises protein from oxyhydrogen microorganism.

3. The structured food product of claim 1, wherein the protein composition comprises microbial biomass comprising oxyhydrogen microorganism cell mass and protein from oxyhydrogen microorganism.

4. The structured food product of claim 3, wherein the protein composition comprises between about 0.5-25% by weight oxyhydrogen microorganism cell mass.

5. The structured food product of claim 1, wherein the protein composition comprises microbial biomass comprising oxyhydrogen microorganism cell mass and protein from oxyhydrogen microorganism; and pea protein.

6. The structured food product of claim 1, wherein the protein from the microorganism comprises single cell protein, cell lysate, protein isolate, protein concentrate, protein hydrolysate, free amino acids, peptides, oligopeptides, or combination of any two or more thereof.

7. The structured food product of claim 1, wherein the protein composition comprises microbial biomass comprising between about 0.5-25% by weight oxyhydrogen microorganism cell mass and between about 60%-99.5% by weight protein from the oxyhydrogen microorganism.

8. The structured food product of claim 1, wherein the adhesive composition comprises protein from oxyhydrogen microorganism.

9. The structured food product of claim 1, wherein the structured food product is a meat analogue.

10. The structured food product of claim 1, wherein the structured food product is a chicken breast analogue.

11. The structured food product of claim 1, wherein each of the layers is between about 0.1 mm to about 5 mm in thickness.

12. The structured food product of claim 1, wherein the microorganism comprises Cupriavidus, Rhodococcus, Hydrogenovibrio, Rhodopseudomonas, Hydrogenobacter, Gordonia, Arthrobacter, Streptomycetes, Rhodobacter, Xanthobacter microorganism, or a consortium of two or more thereof.

13. A method to form structured food product, comprising: deriving a protein composition from microorganism, plant, algae, fungus, insect, or combination of any two or more thereof; forming a dough composition from the protein composition; producing two or more sheets by rolling the dough composition; layering the two or more sheets on top of each other; laminating the two or more sheets using an adhesive composition comprising protein from microorganism, plant, algae, fungus, insect, or combination of any two or more thereof, and forming the structured food product.

14. The method of claim 13, wherein the protein composition comprises protein from oxyhydrogen microorganism.

15. The method of claim 13, wherein the protein composition comprises microbial biomass comprising oxyhydrogen microorganism cell mass and protein from oxyhydrogen microorganism.

16. The method of claim 13, wherein the protein from the microorganism comprises single cell protein, cell lysate, protein isolate, protein concentrate, protein hydrolysate, free amino acids, peptides, oligopeptides, or combination of any two or more thereof.

17. The method of claim 13, wherein the protein composition comprises between about 0.5-25% by weight oxyhydrogen microorganism cell mass.

18. The method of claim 13, wherein the protein composition comprises microbial biomass comprising between about 0.5-25% by weight oxyhydrogen microorganism cell mass and between about 60%-99.5% by weight protein from the microorganism, and between about 20-60% by weight pea protein.

19. The method of claim 13, wherein the adhesive composition comprises protein from oxyhydrogen microorganism.

20. The method of claim 13, wherein the structured food product is a meat analogue.

21. The method of claim 13, wherein the microorganism comprises Cupriavidus, Rhodococcus, Hydrogenovibrio, Rhodopseudomonas, Hydrogenobacter, Gordonia, Arthrobacter, Streptomycetes, Rhodobacter, Xanthobacter microorganism, or a consortium of two or more thereof.
